(19) United States
(12) Patent Application Publication
(10) Pub. No.: US 2024/0385846 A1
(43) Pub. Date: Nov. 21, 2024

(54) DATA CENTER ORCHESTRATORS

(71) Applicant: Oracle International Corporation, Redwood Shores, CA (US)

(72) Inventors: Kenneth Richard Fox, Redwood City, CA (US); Benjamin Todd Willey, Lexington, KY (US); Syed Dilawar Ali Rizvi, Kirkland, WA (US); Robert Charles Hartshorn Black, Normandy Park, WA (US); Owen Christopher Cliffe, Bath (GB); William Thomas Price, Weston-Super-Mare (GB)

(73) Assignee: Oracle International Corporation, Redwood Shores, CA (US)

(21) Appl. No.: 18/667,935

(22) Filed: May 17, 2024

Related U.S. Application Data
(60) Provisional application No. 63/503,147, filed on May 18, 2023.

(51) Int. Cl. G06F 9/4401; G06F 9/455; G06F 9/50; G06F 11/32

(52) U.S. Cl. CPC G06F 9/4401; G06F 9/45558; G06F 9/5072; G06F 11/328; G06F 2009/4557; G06F 2009/45595

(57) ABSTRACT

A cloud infrastructure orchestration service (CIOS) may track build progress made by any suitable number of regional orchestrators. The cloud infrastructure orchestration system may include any suitable number of regional orchestrators, each regional orchestrator executing in an isolated hosting environment (e.g., a service cell isolated from other service cells). An orchestrator control plane may be configured to generate a build plan for bootstrapping a plurality of services within a data center, the build plan may be generated based at least in part on a service build definition of a plurality of service build definitions, the service build definition specifying a deterministic process for bootstrapping a service of the plurality of services. The orchestrator control plane may instruct a regional orchestrator to perform bootstrapping operations according to the build plan and may track the progress of the bootstrapping operations on an ongoing basis.

### CROSS-REFERENCE TO RELATED APPLICATIONS

This non-provisional application claims priority to U.S. Provisional Patent Application No. 63/503,147, filed on May 18, 2023, entitled “Skills Based Region Build Orchestration,” the disclosure of which is herein incorporated by reference in its entirety for all purposes.

### BACKGROUND

Today, cloud infrastructure services utilize many individual services to build a data center (e.g., to bootstrap various resources in a data center of a particular geographic region). A region is a logical abstraction corresponding to a localized geographical area in which one or more data centers are (or are to be) located. Building a data center (also referred to performing a “region build”) may include provisioning and configuring infrastructure resources and deploying code to those resources (e.g., to implement a variety of services). Any suitable number of data centers may be included in a region and therefore a region build may include operations for building multiple data centers. Bootstrapping operations for one service may depend on the availability of other functionality and/or services of the region. As the number of service teams and regions grows, the tasks performed for orchestrating provisioning and deployment drastically increase. Conventional tools for building a region require significant manual effort or automated techniques present drawbacks with respect to overhead, accuracy, and case of use. Improvements can be made.

### BRIEF SUMMARY

Embodiments of the present disclosure relate to orchestrating a data center build. Previous implementations had no centralized description from which to derive the operations needed to build a service. Instead, service build information was distributed across a myriad of configuration files. Current implementations lack a specification for how a service is built and include implementation details only. This leads to a lack of understanding of service builds and greatly increases the efforts required to unblock issues during a data center build. The present disclosure is directed to a region build orchestrator that is configured to manage and track data center builds across multiple geographic regions.

At least one embodiment is directed to a computer-implemented method (the “method,” for brevity). The method may comprise providing, by a cloud infrastructure orchestration system of a cloud-computing environment, a plurality of regional orchestrators, each regional orchestrator of the plurality of regional orchestrators executing in an isolated hosting environment. The method may comprise generating, by an orchestrator control plane of the cloud infrastructure orchestration system, a build plan for bootstrapping a plurality of services within a data center. In some embodiments, the build plan may be generated based at least in part on a service build definition of a plurality of service build definitions. In some embodiments, the service build definition specifies a deterministic process for bootstrapping a service of the plurality of services. The method may comprise instructing, by the orchestrator control plane, a regional orchestrator of the cloud infrastructure orchestration system to initiate bootstrapping the plurality of service according to the build plan. The method may comprise tracking, by the orchestrator control plane, a state associated with the bootstrapping of the plurality of services by the regional orchestrator of the cloud infrastructure orchestration system.

In some embodiments, the isolated hosting environment is a service cell of a plurality of service cells.

In some embodiments, the build plan is generated based at least in part on parsing a service build definition, the service build definition comprising a service plan and manifest. In some embodiments, the service plan identifies one or more build milestones and an execution unit corresponding to a transition between two build milestones. In some embodiments, the manifest specifies one or more artifacts to be utilized while building a service corresponding to the service build definition. An execution unit may be associated with one or more infrastructure releases or application releases.

In some embodiments, the method may comprise presenting, by the orchestration control plane, one or more user interfaces presenting the state associated with bootstrapping the plurality of services by the regional orchestrator of the cloud infrastructure orchestration system.

In some embodiments, at least one of the one or more user interfaces presents a directed acyclic graph generated based at least in part on the service plan definition. In some cases, each node of the directed acyclic graph corresponds to a build milestone or to an execution unit associated with building the service.

In some embodiments, the method may further comprise receiving, from one of the one or more user interfaces, data indicating an intervention has been initiated and instructing the regional orchestrator to modify execution of the build plan based at least in part on the intervention being initiated.

Another embodiment is directed to a cloud-computing service comprising one or more processors and memory storing instructions that, when executed by the one or more processors, cause the cloud-computing service to perform the method(s) disclosed herein.

Still another embodiment is directed to a non-transitory computer-readable medium storing computer-executable instructions that, when executed by one or more processors of a cloud-computing service, cause the cloud-computing service to perform the method(s) disclosed herein.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an environment in which a Cloud Infrastructure Orchestration System (CIOS may operate to dynamically bootstrap services in a region), in accordance with at least one embodiment.

FIG. 2 is a block diagram for illustrating an environment and method for building a virtual bootstrap environment (ViBE), in accordance with at least one embodiment.

FIG. 3 is a block diagram for illustrating an environment and method for bootstrapping services to a target region utilizing the ViBE, in accordance with at least one embodiment.

FIG. 4 is a block diagram depicting a data model representing various metadata associated with a Service Build Definition, in accordance with at least one embodiment.

FIG. 5 is a block diagram depicting relationships between portions of a service plan and manifest, in accordance with at least one embodiment.

FIG. 6 is a block diagram depicting a build milestone entity of an example service plan, in accordance with at least one embodiment.

FIG. 7 depicts an example execution unit entity of an example service plan, in accordance with at least one embodiment.

FIG. 8 depicts an example flock config entity of an example service plan, in accordance with at least one embodiment.

FIG. 9 is a block diagram depicting a data model representing various metadata related to a skill, in accordance with at least one embodiment.

FIG. 10 is a flow diagram depicting an example method for managing skill states during a data center/region build, in accordance with at least one embodiment.

FIG. 11 is a block diagram depicting a data model representing various metadata related to a region build plan, in accordance with at least one embodiment.

FIG. 12 is a block diagram depicting a data model representing various metadata related to maintaining an orchestration state corresponding to building a data center (e.g., a data center of a region, also referred to as a “region build”), in accordance with at least one embodiment.

FIG. 13 is a block diagram depicting an example computer architecture including components that are configured to build a data center in an automated fashion, in accordance with at least one embodiment.

FIG. 14 is a schematic of an example user interface for viewing region details, in accordance with at least one embodiment.

FIG. 15 is a schematic of an example user interface corresponding to building a data center from a template, in accordance with at least one embodiment.

FIG. 16 is a schematic of an example user interface configured to present build status corresponding to one or more regions, in accordance with at least one embodiment.

FIG. 17 is a schematic of an example user interface configured to present region build details corresponding to a single region, in accordance with at least one embodiment.

FIG. 18 is a schematic of an example user interface configured to present details related to execution of a service build, in accordance with at least one embodiment.

FIG. 19 is a flow diagram depicting an example method tracking regional orchestrator operations associated with performing a region build, according to at least one embodiment.

FIG. 20 is a block diagram illustrating an example IaaS architecture for region build orchestration service, according to at least one embodiment.

FIG. 21 is a block diagram illustrating one pattern for implementing a cloud infrastructure as a service system, according to at least one embodiment.

FIG. 22 is a block diagram illustrating another pattern for implementing a cloud infrastructure as a service system, according to at least one embodiment.

FIG. 23 is a block diagram illustrating another pattern for implementing a cloud infrastructure as a service system, according to at least one embodiment.

FIG. 24 is a block diagram illustrating another pattern for implementing a cloud infrastructure as a service system, according to at least one embodiment.

FIG. 25 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Example Automated Data Center Build (Region Build) Infrastructure

The adoption of cloud services has seen a rapid uptick in recent times. Various types of cloud services are now provided by various cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

Data centers provided by a CSP may be hosted in different regions. A region is a localized geographic area and may be identified by a region name. Regions are generally independent of each other and can be separated by vast distances, such as across countries or even continents. Regions are grouped into realms. Examples of regions for a CSP may include US West, US East, Australia East, Australia Southeast, and the like.

A region can include one or more data centers, where the data centers are located within a certain geographic area corresponding to the region. As an example, the data centers in a region may be located in a city within that region. For example, for a particular CSP, data centers in the US West region may be located in San Jose, California; data centers in the US East region may be located in Ashburn, Virginia; data centers in the Australia East region may be located in Sydney, Australia; data centers in the Australia Southeast region may be located in Melbourne, Australia; and the like.

Data centers within a region may be organized into one or more availability domains, which are used for high availability and disaster recovery purposes. An availability domain can include one or more data centers within a region. Availability domains within a region are isolated from each other, fault tolerant, and are architected in such a way that data centers in multiple availability domains are very unlikely to fail simultaneously. For example, the availability domains within a region may be structured in a manner such that a failure at one availability domain within the region is unlikely to impact the availability of data centers in other availability domains within the same region.

When a customer or subscriber subscribes to or signs up for one or more services provided by a CSP, the CSP creates a tenancy for the customer. The tenancy is like an account that is created for the customer. In certain implementations, a tenancy for a customer exists in a single realm and can access all regions that belong to that realm. The customer's users can then access the services subscribed to by the customer under this tenancy.

As indicated above, a CSP builds or deploys data centers to provide cloud services to its customers. As a CSP's customer base grows, the CSP typically builds new data centers in new regions or increases the capacity of existing data centers to service the customers' growing demands and to better serve the customers. Preferably, a data center is built in close geographical proximity to the location of customers serviced by that data center. Geographical proximity between a data center and customers serviced by that data center lends to more efficient use of resources and faster and more reliable services being provided to the customers. Accordingly, a CSP typically builds new data centers in new regions in geographical areas that are geographically proximal to the customers serviced by the data centers. For example, for a growing customer base in Germany, a CSP may build one or more data centers in a new region in Germany.

Building a data center (or multiple data centers) in a region is sometimes also referred to as building a region. The term “region build” is used to refer to building one or more data centers within a region. Building a data center in a region involves provisioning or creating a set of new resources that are needed or used for providing a set of services that the data center is configured to provide. The end result of the region build process is the creation of a data center in a region, where the data center is capable of providing a set of services intended for that data enter and includes a set of resources that are used to provide the set of services.

Building a new data center in a region is a very complex activity requiring coordination between various service teams. At a high level, this involves the performance and coordination of various tasks such as: identifying the set of services to be provided by the data center, identifying various resources that are needed for providing the set of services, creating, provisioning, and deploying the identified resources, wiring the resources properly so that they can be used in an intended manner, and the like. Each of these tasks further have subtasks that need to be coordinated, further adding to the complexity. Due to this complexity, presently, the building of a data center in a region involves several manually initiated or manually controlled tasks that require careful manual coordination. As a result, the task of building a new region (i.e., building one or more data centers in a region) is very time consuming. It can take time, for example, many months to build a data center. Additionally, the process is very error prone, sometimes requiring several iterations before a desired configuration of the data center is achieved, which further adds to the time taken to build a data center. These limitations and problems severely limit a CSP's ability to grow in a timely manner responsive to increasing customer needs.

Bootstrapping operations have been coordinated and orchestrated by an orchestrator (e.g., a Multi-Flock Orchestrator, an orchestration service, etc.). In previous implementations, the orchestrator attempted to automatically detect dependencies between operations through a static analysis of various configuration files and/or software artifacts. This analysis performed by the system attempted to intelligently and automatically identify the artifacts and manner in which a data center build was performed. As a data center was built, the orchestrator utilized published capabilities (e.g., tags/labels that could be toggled on or off to indicate availability of a resource or functionality) to drive these operations. However, both the automatic detection techniques and the use of capabilities included drawbacks.

Previous implementations of an orchestrator also lacked an exact plan of the work that may be needed (or is needed) to build a data center ahead of the actual build. The orchestrator utilized service build definitions that were spread across multiple flock configuration files (“flock configs”) and interpreted by the orchestrator at runtime. This caused the orchestrator to execute a undeterminable number of releases, in an order which could not be known in advance of run time, each release publishing a number of capabilities that also could not be known in advance of run time. To compensate for this indeterministic behavior, manually curated micro-schedules were generated and used to track the work and order of operations necessary to build the data center. These micro-schedules were not machine executable, nor derived from code. Service teams were not prevented from changing their build automation which could cause the existing micro-schedules to be invalidated. Additionally, it was not possible to determine exact behavior of a service build when configuration files for that service rely on external data.

In previous implementations, tasks were triggered by publishing capabilities. Capability availability was not held constant over a release leading to non-determinism in the planned activity if any optional capabilities were published mid-release. The use of optional capabilities made it difficult to determine when a release was expected to publish a certain capability of if a resource was ever going to be created. Service teams could also introduce changes that created unsatisfiable cyclic dependencies between services causing the build to deadlock or to depend upon a capability that would never be published. For at least these reasons, it was impossible to determine when dependent releases would ever be unblocked. Heterogeneity in different regions also meant that there was no single plan for how a service should be bootstrapped. Rather, a different plan existed for each region furthering compounding the difficulty in understanding how the service is built, as capabilities might be depended upon or published in certain types of regions and not others.

Embodiments of the present disclosure may utilize a service plan and manifest (SPAMs) that serves as a deterministic specification for the bootstrapping process of a single service. A service plan and manifest (SPAM) provides a complete service build description that specifies the releases and the deterministic/explicit order of those releases that may be necessary (or are necessary) to build a service. The SPAM may include clear expectations for the progress expected by each transition (e.g., each release execution corresponding to a particular flock/phase/execution target). One or more services (e.g., all services to be bootstrapped within the region) may be associated with a corresponding SPAM. Information provided by these SPAMs may be utilized to eliminate various errors that can occur in a data center build by identifying issues early in the build lifecycle (e.g., upon SPAM submission) rather than during the build execution. SPAMs may be composed together by an orchestrator (e.g., a “region orchestrator”) and used to form a directed acyclic graph (DAG) of work (e.g., releases) that identifies the expected order of release executions that may be needed (or in some instances, is needed) to build the data center and capability dependencies between those releases.

Capabilities may be replaced with skills as a mechanism with which build progress may be tracked. A “skill” may represent a functional unit that a service exposes and offers to consumers (e.g., other services). This functional unit (also referred to as “service functionality”) can include all or a subset of the total functionality associated with a service. In some embodiments, skills may be scoped where access is controlled based on access and/or authorization policies and/or based on an association with a particular namespace. A skill may be provided in multiple versions in which one or more aspects of the skill differs from other versions, where each skill version represents a specific implementation of the skill. Each skill version may be identifiable using a unique skill identifier. Skills may enable enhanced and more accurate progress tracking of a region build over the tracking previously provided with capabilities, as well as improved root cause analysis functionality when errors or unexpected events occur in the build.

Service plans used by the region orchestrator to drive orchestration tasks may specify any suitable number of preconditions (e.g., required skill dependencies) and post-conditions (e.g., skill publications) that are expected to be met upon reaching different points (referred to as “execution target (ET) checkpoints”). The order of release execution may be identified in the service plan and expressed using ET checkpoint transitions. Each ET checkpoint transition (e.g., a transition from one ET checkpoint to another ET checkpoint) may be mapped to a corresponding infrastructure release or application release of the build. ET checkpoints may be associated with corresponding build flags that may be used to identify progress of the build. Executing a release may transition the ET from one ET checkpoint to another. Upon successful transition, one or more build flags that are associated with the release being executed at the ET may be set to indicate that the release was successfully executed (e.g., the corresponding infrastructure or application change corresponding to the release was successfully performed). The current ET checkpoint and build flags may be associated with a resource (e.g., an execution target resource) that is managed by the system. Using the SPAM enables an improved and deterministic plan to be generated for the build. Tracking the ET checkpoints defined within the SPAM enables the region orchestrator to identify, at any suitable time, the progress already achieved and/or the amount and order of remaining work to be performed in an ongoing service and/or region/data center build.

Unlike past implementations, a single region orchestrator may be executed for each region under build (e.g., each data center being built). In some embodiments, each instance of the region orchestrator may execute within a service cell. A “service cell” refers to an isolated hosting environment that is hosted on infrastructure that is dedicated to the service cell. A service cell may be isolated in that it does not share hosts or virtual machines with other service cells. In previous orchestrator implementations, data plane resources (e.g., instances in a computing cluster, etc.) were managed by a regional control plane. Any suitable orchestration tasks (e.g., provisioning, removing, modifying a node of the cluster, etc.) across for any given region were performed by the same regional control plane. The present disclosure relates to utilizing a service cell that is specific to the region, the data center, or the build. This enables multiple builds to be performed concurrently with separate instances of the region orchestrator managing each build.

The techniques discussed herein provide for improved orchestration techniques over conventional techniques. Tracking of region builds is improved with skills. The build process is improved by enforcing a deterministic approach, reducing, if not eliminating the risk of indeterministic behavior. This enables the system to more accurately assess a time remaining and/or a number of remaining tasks (e.g., releases) left in a given region build. By utilizing service cells for region builds, a blast radius of a catastrophic failure may be limited to the service cell as a fault boundary onto itself. This decreases, or substantially eliminates, a risk that a failure in one data center affects any other service cell. This also enables multiple region builds to be executed in parallel, or at least during overlapping times. Additionally, unlike previous implementations, the components that are configured to build a region may be controlled through an orchestrator that is external to the system, enabling a wider variety of orchestrators to be utilized to drive orchestration tasks.

### Certain Definitions

A “region” is a logical abstraction corresponding to a geographical location. A region can include any suitable number of one or more execution targets.

A “phase” refers to a group of execution targets that can be executed at the same time.

An “execution target” refers to a unit (e.g., a set of devices, a tenancy, etc.) against which a release may be executed. In some embodiments, an execution target may be the smallest granular unit against which CIOS can execute a release. An execution target may be specific to a region and a tenancy. Execution targets may be aggregated into one or more phases. For some services, an execution target represents an “instance” of a service. A single service can be bootstrapped to each of one or more execution targets. An execution target may be associated with a set of devices (e.g., a data center).

A “release” refers to a representation of an intent to orchestrate a specific change to a service (e.g., deploy version 8, “add an internal DNS record,” etc.). In some embodiments, a release corresponds to a change type that indicates the release is an infrastructure change (e.g., provisioning) or an application change (e.g., a deployment). A release may target one or more phases or execution targets.

“Bootstrapping” is intended to refer to the collective tasks associated with provisioning and deployment of any suitable number of resources (e.g., infrastructure components, artifacts, etc.) corresponding to a single service.

A “service” refers to functionality provided by a set of resources. A set of resources for a service includes any suitable combination of infrastructure, platform, or software (e.g., an application) hosted by a cloud provider that can be configured to provide the functionality of a service. A service can be made available to users through the Internet.

An “artifact” refers to code being deployed to an infrastructure component (e.g., a physical or virtual host) or a Kubernetes engine cluster, this may include, but is not limited to, software (e.g., an application), configuration information (e.g., a configuration file) for an infrastructure component, or the like.

A “flock configuration file” or “flock config,” for brevity refers to a configuration file that describes a set of resources (e.g., infrastructure components and artifacts, also referred to as a “flock”) associated with a single service. A flock config may correspond to a single release (e.g., provisioning and/or deployment tasks that are to be performed as a unit). A flock config may correspond to an infrastructure release or an application release. A service may be built using any suitable number of releases and corresponding flock configs. A flock config may include declarative statements that specify one or more aspects corresponding to a desired state of the resources of the service for that release.

A “flock” refers to a set of CIOS managed resources or a set of execution targets that can be deployed as a unit. A flock may exist within an organizational unit referred to as a “project.”

A “service cell” may refer to an isolated hosting environment that is hosted on infrastructure that is dedicated to the service cell. A service cell may be isolated in that it does not share hosts or virtual machines with other service cells. A service cell may be a kind of logical data center (e.g., a logical grouping of performance isolation and fault isolation) within a single availability domain, region, or data center.

“Service state” refers to a point-in-time snapshot of every resource (e.g., infrastructure resources, artifacts, etc.) associated with the service. The service state indicates status corresponding to provisioning and/or deployment tasks associated with service resources.

IaaS provisioning (or “provisioning,” for brevity) refers to acquiring computers or virtual hosts for use, and even installing needed libraries or services on them. The phrase “provisioning a device” refers to evolving a device to a state in which it can be utilized by an end-user for their specific use. A device that has undergone the provisioning process may be referred to as a “provisioned infrastructure device” or a “provisioned device,” for brevity. Preparing the provisioned device (installing libraries and daemons) may be part of provisioning; this preparation is different from deploying new applications or new versions of an application onto the prepared device. In most cases, deployment does not include provisioning, and the provisioning may need to be performed first. Once prepared, the device may be referred to as “an infrastructure component.”

IaaS deployment (or “deployment,” for brevity) refers to the process of providing and/or installing a new application, or a new version of an application, onto a provisioned infrastructure component. Once the infrastructure component has been provisioned (e.g., acquired, assigned, prepared, etc.), additional software may be deployed (e.g., provided to and installed on the infrastructure component). The infrastructure component can be referred to as a “resource” after provisioning and deployment has concluded. Examples of resources may include, but are not limited to, virtual machines, databases, object storage, block storage, load balancers, and the like.

A “virtual bootstrap environment” (ViBE) refers to a virtual cloud network that is provisioned in the overlay of an existing region (e.g., a “host region”). Once provisioned, a ViBE is connected to a new region using a communication channel (e.g., an IPsec Tunnel VPN). Certain essential core services (or “seed” services) like a deployment orchestrator, a public key infrastructure (PKI) service, and the like can be provisioned in a ViBE. These services can provide the capabilities required to bring the hardware online, establish a chain of trust to the new region, and deploy the remaining services in the new region. Utilizing the virtual bootstrap environment can prevent circular dependencies between bootstrapping resources by utilizing resources of the host region. Services can be staged and tested in the ViBE prior to the physical region (e.g., the target region) being available.

A “Cloud Infrastructure Orchestration Service” (CIOS) may refer to a system configured to manage provisioning and deployment operations for any suitable number of services as part of a region build.

A “host region” refers to a region that hosts a virtual bootstrap environment (ViBE). A host region may be used to bootstrap a ViBE.

A “target region” refers to a region under build.

A “capability” identifies is a legacy resource previously used during region build that signaled that another resource, service, or feature was available, or that an event had occurred. By way of example, a capability could be published indicating that a resource is available for authorization/authentication processing (e.g., a subset of the functionality to be provided by a service). As another example, a capability could be published indicating the full functionality of the service is available. Capabilities were used to identify functionality on which a resource or service depended and/or functionality of a resource or service that was available for use. A capability was associated with an alphanumeric identifier and was used to indicate the capability is available or unavailable.

“Publishing a capability” refers to “publishing” as used in a “publisher-subscriber” computing design or otherwise providing an indication that a particular capability is available (or unavailable). In capabilities based orchestration implementations, capabilities were “published” (e.g., collected by a Capabilities Service, provided to a Capabilities Service, pushed, pulled, etc.) to provide an indication that functionality of a resource/service was available or that an event had occurred. In some embodiments, capabilities may have been published/transmitted via an event, a notification, a data transmission, a function call, an API call, or the like. An event (or other notification/data transmission/etc.) indicating availability of a particular capability could be broadcasted/addressed (e.g., published) to a Capabilities Service.

A “Capabilities Service” refers to a previously implemented service configured to monitor and maintain capabilities data that indicates which capabilities are current available in a region. A Capabilities Service was previously provided within a Cloud Infrastructure Orchestration System and was used to identify what capabilities, services, features were made available in a region, or which events had occurred within the region. The described Capabilities Service served a central repository/authority of all capabilities that have been published in the region (e.g., during a region build).

An “Region Orchestrator” is intended to refer to a service or system that initiates tasks involved in bootstrapping one or more services during a region build. A region orchestrator may be specific to a particular region or data center and may be configured to manage all bootstrapping operations within that region/data center. A region orchestrator may be a computing component (e.g., a cloud-computing service) configured to coordinate events between components of the CIOS to provision and deploy services to a target region (e.g., a new region). A region orchestrator may track relevant events (e.g., indicated through skills as described herein) for each service of the region build and takes actions in response to those events (e.g., based on determining upstream dependencies have been met for a given release/skill, etc.).

A “Real-time Regional Data Distributor” (RRDD) may be a service or system configured to manage region data. This region data can be injected into flock configs to dynamically create execution targets for new regions.

A “Telemetry Service” may be a service or system that is configured to manage/monitor time series data associated with one or more services/resources and trigger (e.g., publish, store, etc.) various alarms and/or corresponding alarm states based at least in part on analyzing the time series data.

A “Skills Service” (also referred to as “Puffin”) may be a service or system that is configured to store planned and/or actual dependency relationships between services, resources, or units of functionality (also referred to as “service functionality”). Puffin may be configured as a central registry with which service teams may register their services/microservices. It should be appreciated that the unit of functionality may relate to functionality provided by a computing component other than a service.

A “skill” may represent a functional unit that a service exposes and offers to consumers (e.g., other services). This functional unit (also referred to as “service functionality” or “functionalities”) can include all or a subset of the total functionality associated with a service. In some embodiments, skills may be scoped where access is controlled based on access and/or authorization policies and/or based on an association with a particular namespace. A skill may be provided in multiple versions in which one or more aspects of the skill differs from other versions, where each skill version represents a specific implementation of the skill. Each skill version may be identifiable using a unique skill identifier. Skills are intended to replace the capabilities of previous implementations (e.g., labels/tags that could be toggled on and off) and to enable enhanced and more accurate progress tracking of a region build as well as improved root cause analysis functionality when errors or unexpected events occur in the build. A skill may be monitored for health and may be configured to maintain health data. A “skill” may collectively refer to any suitable number of data structures in which data defining the skill may be maintained. Skills may be associated with an identifier (e.g., a phonebookID) that identifies one or more entities or contacts. Services may specify a skill's run-time dependencies using one or more user interfaces provided by Puffin, while build-time skill dependencies may be declared within a SPAM and reflected in one or more user interfaces hosted by Puffin.

A “fleet” refers to a logical environment (e.g., preproduction, production, etc.) to which a skill can be scoped. By way of example, a skill associated with a production fleet may be separate from a skill of the same name utilized with a preproduction fleet. A “project” may be similarly utilized to scope skills. In some embodiments, a skill may be scoped/applied to a particular environment based at least in part on any suitable combination of attributes such as skillID, skillversionID, compartmentID, namespaceID, producerServiceID, skillName, fleet, project, or the like, that collectively identify a particular application of a skill.

A “service plan specification” or “service plan,” for brevity, refers to any suitable document or data that specifies a build implementation of a given service. A service plan may include any suitable combination of build milestones, execution units, and flock configurations. In some embodiments, service plans describe preconditions (e.g., via skill dependencies) and post-conditions (e.g., skills published/installed) for each step along of path of installing a service. A service plan may detail specific releases that may be needed (or that are needed) to build a service and the order by which the releases are to be performed to build the service. A service plan may separate inter-service coordination and intra-service coordination and/or may specify the expected state of a service at any suitable point of a region build.

A “service manifest” or “manifest,” for brevity, identifies the versions for flock configs and artifacts that are to be used to build a service. A service manifest may include a collection of service manifest items, each service manifest item identifying a particular flock config or artifact that may be needed (or is needed) to build a service. In some embodiments, a service manifest item may be associated with a git commit hash of the flock and all version declarations for any artifact that is required in application releases for that service's build.

A “SPAM” refers to a combination of a service plan and a manifest that collectively provide a deterministic specification of the process for building a service and, in some cases, uninstalling the service to revert to an earlier working state. In some embodiments, a SPAM details a combination and order of releases that may be needed (or is needed) to build the service. A manifest of the SPAM may define all resources to be used for the releases, while the service plan specifies an order of release execution based on capability dependencies. A SPAM may be used to track compliance of a region build. A SPAM details the releases that may be necessary (or are necessary) to build a service where each release may be associated with pre-conditions and post-conditions. The preconditions may refer to skills that may (or in some instances, must) be present such that a release can be created that will result in the postconditions being satisfied. The post-conditions may be skills that should (or in some cases, must) be published as a consequence of the release succeeding. SPAMs may be created by service teams and are derived from YAML files they author. The SPAM may be delineated into discrete sections, including execution units which define transitions between well-defined points in the service's build, known as “build milestones.” A service may transition from one build milestone to the next by performing the releases defined by an execution unit. Execution units may specify the external dependencies (capabilities) that may be (or are) required to perform the releases defined within the unit. Build milestones may specify the capabilities published by the service that should (or in some cases, must) be made available once the service has reached that milestone. In some embodiments, the capabilities specified by a build milestone include capabilities that are intended for consumption by other services.

A “SPAM set” refers to a collection on SPAMs that are mutually compatible and/or that are previously associated with one another. A SPAM set may be used to derive a version set with which a directed acyclic graph may be generated and used to drive operations for building a data center. In some embodiments, a SPAM set may be associated with a scope and/or a regional context.

A “build strategy” may include cross-SPAM rules that may be enforced by a Region Orchestrator to ensure specific orderings of particular build steps. Build strategies, which may be defined globally, may be used to describe and validate complex laddering that occurs to bring up mutually dependent services at runtime as well as broader rules around the ordering of services during region build. Build strategies may act as guardrails on dependencies between tightly coupled skills/services and enable the system to catch violations of contracts earlier than region build. In some embodiments, build strategies may be developed and updated by architects from affected service teams. A build strategy may include a set of rules with each rule having pre-conditions, post-conditions, and a name or other suitable identifier. Pre and/or post conditions of a rule may be declared as being implemented by a SPAM (e.g., an execution unit of a SPAM) or by another build strategy. A build strategy may be versioned (e.g., using major/minor/patch designations). A minor version changes may add new rules, patch version changes may include updates to non-functional portions of the build strategy.

A “build milestone” (also referred to as a “stage”) refers to an entity defined in a service plan that identifies a synchronization point between the service build (e.g., the process for building a particular service) and the rest of the data center build. Build milestones refer to stages involved in the deployment of a service in a region under build (e.g., a data center being built within a region). Build milestones may be defined coarsely to limit their number and provide a high-level overview of the process for building a service. As a non-limiting example, a set of build milestones for a service may include “absent” (e.g., a default starting milestone), “service functionality X available,” “service available,” and “service build complete.”

An “execution unit” refers to another entity of a service plan. One or more execution units may describe the process for transitioning from one build milestone to the next via a directed acyclic graph of CIOS releases (e.g., infrastructure and/or application releases). Execution units may represent a series of infrastructure and application installations/changes (e.g., bring up a load-balancer) to transition from one build milestone to the nest, or to un-install infrastructure or applications (e.g., tear down the load-balancer). An execution unit may define releases across one or more execution targets. In some embodiments, build dependencies (expressed as skills that depend on another skill) may be met (and in some cases, must be met) before an execution unit can be invoked. Execution unit definitions may be used to describe the workflow to transition a service from one build milestone to another along with the required preconditions (e.g., installed and available skills) and postconditions (e.g., skills that will be installed and made available through execution the releases of the execution unit). In some embodiments, an execution unit can declare that it implements one or more build strategy rules.

“Execution context” refers to one or more inputs of a region build planner that may be used to override execution of specific steps within one or more SPAMs of a SPAM set. The execution context (e.g., input data to the region build planner) may define specific milestones to reach for one or more SPAMs and may specify plan concurrency (e.g., SPAMs which may be concurrently executed).

A “region build plan” refers to a materialized plan executed by a Region Orchestrator. A region build plan may be represented by a graph of tracks and steps that define exact execution and execution order that is to be followed to build a data center within a region.

A “track” refers to a single thread of execution within a region build plan. One step may be executing within a track. A “track step,” or “step,” for brevity, refers to a node within a region build plan. A step may be one element of build plan execution and may include, but is not limited to asserts regarding state (e.g., an assertion regarding the installation of or health of a skill), execution of an infrastructure or application release, flow control for handling concurrency between steps and/or tracks, etc. A step may be an atomic unit of execution of a region build plan.

An “execution target checkpoint” or “ET checkpoint,” for brevity, refers to a defined point in the data center build of a given execution target (e.g., a set of devices, a tenancy, etc.). An ET checkpoint may be associated with certain preconditions (e.g., required capability dependencies) and postconditions (capability publications) that are expected to have been met upon reaching that ET checkpoint. In some embodiments, steps identified within an execution unit may reference ET checkpoint transitions that may map logically to expected CIOS releases (e.g., infrastructure releases or application releases).

A “region archetype” or “region type” may represent an overall structure of a region (e.g., an ONSR region, a single-availability-domain-region, a first region in a realm) that could be used to impact a service's installation. In some embodiments, a service plan may reference dimensions of a region archetype to conditionally change the service plan definition.

“Static analysis” refers to an execution of a static analysis of code (e.g., that identifies data center infrastructure components as objects using a declarative configuration language) to infer publications and/or dependencies (e.g., skill and/or publications and/or dependencies). In some embodiments, a static flock analysis may be performed utilizing an infrastructure-as-code software tool (e.g., Terraform®). In some embodiments, this software tool may generate one or more data structures (e.g., directed acyclic graphs) that represent these dependencies/publications. Each node in the graph may correspond to a flock config and/or a release, with edges identifying capability publications and/or dependencies between releases.

In some examples, techniques for implementing a Cloud Infrastructure Orchestration Service (CIOS) are described herein. Such techniques, as described briefly above, can be configured to manage bootstrapping (e.g., provisioning and deploying software to) infrastructure components within a cloud environment (e.g., a region). In some instances, the CIOS can include computing components (e.g., a CIOS Central and a CIOS Regional) that may be configured to manage bootstrapping tasks (provisioning and deployment) for a given service and an Orchestrator (e.g., a multi-flock orchestrator) configured to initiate/manage region builds (e.g., bootstrapping operations corresponding to multiple services in a region/data center).

CIOS enables region/data center building and world-wide infrastructure provisioning and code deployment with minimal manual run-time effort from service teams (e.g., beyond an initial approval and/or physical transportation of hardware, in some instances). The high-level responsibilities of CIOS include, but are not limited to, coordinating region builds in an automated fashion with minimal human intervention, providing users with a view of the current state of resources managed by the CIOS (e.g., of a region, across regions, world-wide, etc.), and managing bootstrapping operations for bootstrapping resources within a region.

The CIOS may provide view reconciliation, where a view of a desired state (e.g., a desired configuration) of resources may be reconciled with a current/actual state (e.g., a current configuration) of the resources. In some instances, view reconciliation may include obtaining state data to identify what resources are actually running and their current configuration and/or state. Reconciliation can be performed at a variety of granularities, such as at a service level.

CIOS can perform plan generation, where differences between the desired and current state of the resources are identified. Part of plan generation can include identifying the operations that would need to be executed to bring the resources from the current state to the desired state. Once the user is satisfied with a plan, the plan can then be marked as approved or rejected. Thus, users can spend less time reasoning about the plan and the plans are more accurate because they are machine generated. Plans are almost too detailed for human consumption; however, CIOS can provide this data via a sophisticated user interface (UI).

In some examples, CIOS can handle execution of change management by automatically executing the approved plan. Once an execution plan has been created and approved, engineers may no longer need to participate in change management unless CIOS initiates roll-back. CIOS can handle rolling back to a previous service version by automatically generating a plan that returns the service to a previous (e.g., pre-release) state (e.g., when CIOS detects service health degradation while executing).

CIOS can measure service health by monitoring alarms and executing integration tests. CIOS can help teams quickly define roll-back behavior in the event of service degradation, which it can later execute automatically. CIOS can automatically generate and display plans and can track approval. CIOS can combine the functionality of provisioning and deployment in a single system that coordinates these tasks across a region build. CIOS can discover dependencies between execution tasks at every level (e.g., resource level, execution target level, phase level, service level, etc.) through a static analysis (e.g., including parsing and processing content) of one or more configuration files. Using these dependencies, CIOS can generate various data structures from these dependencies that can be used to drive task execution (e.g., tasks regarding provisioning of infrastructure resources and deployment of artifacts across the region).

Today, during Large Scale Events (LSEs) (e.g., events in which a substantial error, blockage, or delay is experienced in a region build), incident management and region build operators frequently incur wide-spread overhead and sometimes delays, e.g., in collecting status, attribution of the issue, assessment of impacts, and the recovery of services, due to the heavily human-based and non-systemic approach of conventional approaches. Due to the complexity of the various dependencies between services, it can be extremely difficult and time intensive for operators to identify the contributing cause of the event. This causes delays in remediation as well as the ability to assess when an event has concluded. Similarly, building a region includes challenges in which human involvement may be utilized to troubleshoot and/or detect of failures or blocking situations. Conventionally, it is difficult for service teams to determine what dependencies exist for their service. Both the dependencies the service may have on other services, and vice versa. Additionally, service teams have incomplete indicators ahead of an actual region build as to whether their region build design will have critical issues (such as cyclic dependencies) that prevent or delay the build of their service.

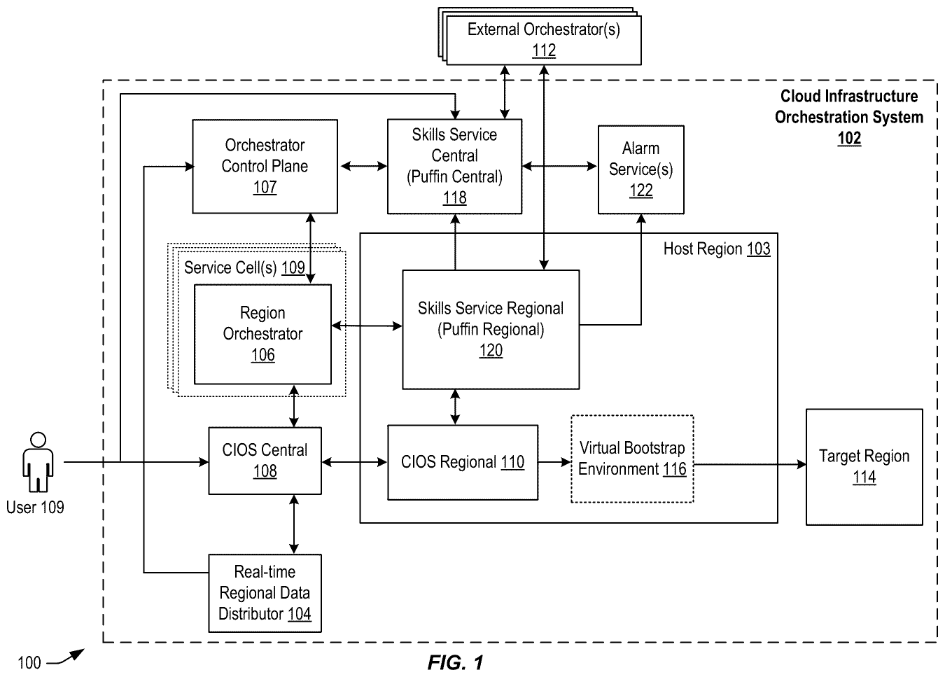

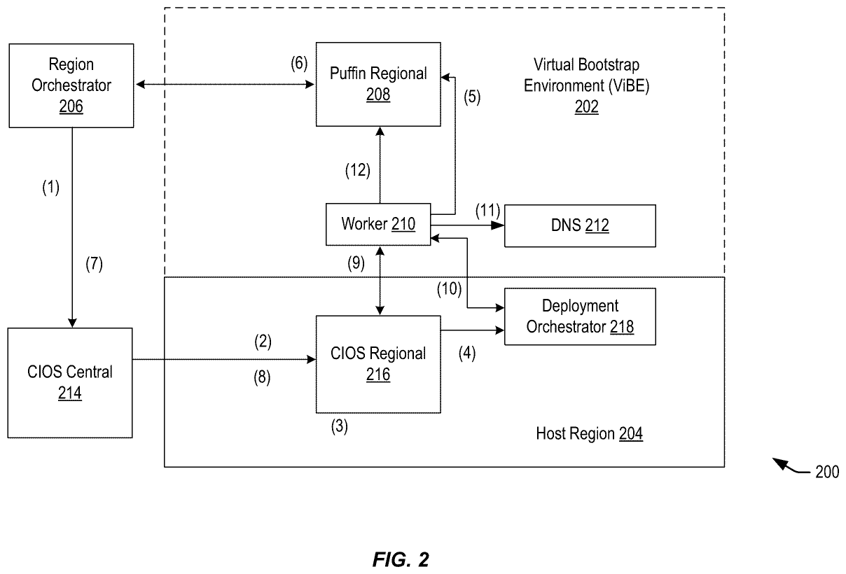

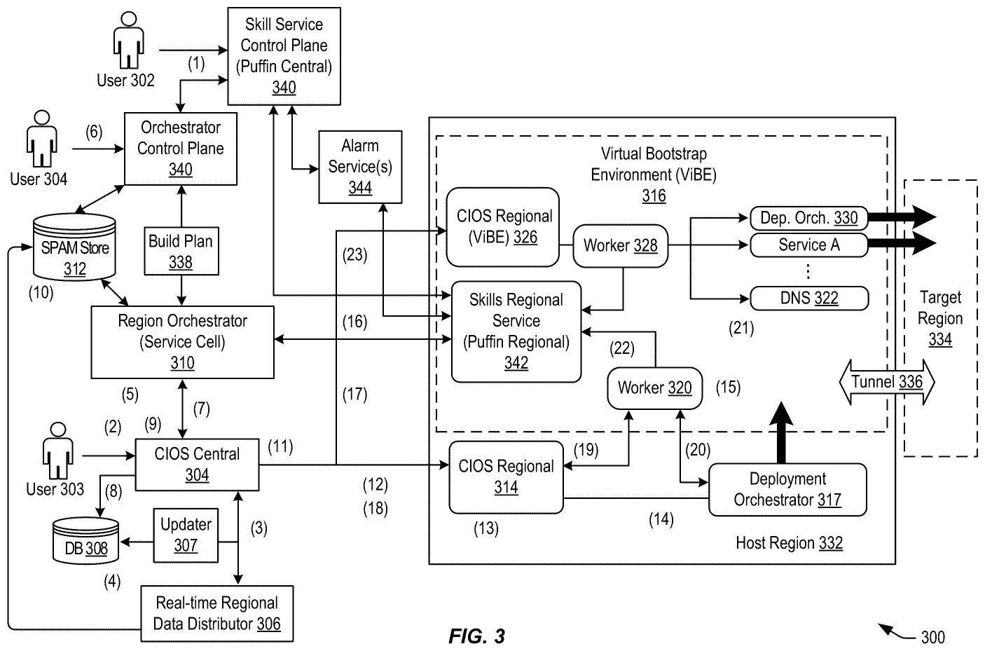

FIG. 1 is a block diagram of an environment 100 in which a Cloud Infrastructure Orchestration System (CIOS) 102 in which a Cloud Infrastructure Orchestration System (CIOS may operate to dynamically bootstrap services in a region/data center, according to at least one embodiment. CIOS 102 can include, but is not limited to, the following components: Real-time Regional Data Distributor (RRDD) 104, Region Orchestrator 106 (operating in a corresponding service cell of service cell(s) 109), Orchestrator Control Plane 107, CIOS Central 108, CIOS Regional 110, Virtual Bootstrap Environment 116, Puffin Central 118, Puffin Regional 120, and Alarm Service(s) 122. In some embodiments, any suitable combination of the components of CIOS 102 may be provided as a service. In some embodiments, some portion of CIOS 102 may be deployed to a region (e.g., a data center represented by host region 103). In some embodiments, CIOS 102 may include any suitable number of cloud services (not depicted in FIG. 1) discussed in further detail below with respect to FIGS. 2 and 3.

Real-time Regional Data Distributor (RRDD) 104 may be configured to maintain and provide region data that identifies realms (which may include one or more regions), regions (which may include one or more availability domains), execution targets, and availability domains. In some cases, the region data may be in any suitable form (e.g., JSON format, data objects/containers, XML, etc.). Region data maintained by RRDD 104 may include any suitable number of subsets of data which can individually be referenceable by a corresponding identifier. By way of example, an identifier “all_regions” can be associated with a data structure (e.g., a list, a structure, an object, etc.) that includes a metadata for all defined regions. As another example, an identifier such as “realms” can be associated with a data structure that identifies metadata for a number of realms and a set of regions corresponding to each realm. In general, the region data may maintain any suitable attribute of one or more realm(s), region(s), availability domains (ADs), execution target(s) (ETs), and the like, such as identifiers, DNS suffixes, states (e.g., a state of a region), and the like. The RRDD 104 may be configured to manage region state as part of the region data. A region state may include any suitable information indicating a state of bootstrapping within a region. By way of example, some example region states can include “initial,” “building,” “production,” “paused,” or “deprecated.” The “initial” state may indicate a region that has not yet been bootstrapped. A “building” state may indicate that bootstrapping of one or more flocks within the region has commenced. A “production” state may indicate that bootstrapping has been completed and the region is ready for validation. A “paused” state may indicate that CIOS Central 108 or CIOS Regional 110 has paused internal interactions with the regional stack, likely due to an operational issue. A “deprecated” state may indicate the region has been deprecated and is likely unavailable and/or will not be contacted again.

CIOS Central 108 may be configured to provide any suitable number of user interfaces with which users (e.g., user 109) may interact with CIOS 102 or view data associated with one or more region builds. By way of example, users can make changes to region data via a user interface provided by CIOS Central 108. CIOS Central 108 may additionally provide a variety of interfaces that enable users to: view changes made to flock configs and/or artifacts, generate and view plans, approve/reject plans, view status on plan execution (e.g., corresponding to tasks involving infrastructure provisioning, deployment, region build, and/or desired state of any suitable number of resources managed by CIOS 102. CIOS Central 108 may implement a control plane configured to manage any suitable number of CIOS Regional 110 instances. CIOS Central 108 can provide one or more user interfaces for presenting region data, enabling the user 109 to view and/or change region data. CIOS Central 108 can be configured to invoke the functionality of RRDD 104 via any suitable number of interfaces. Generally, CIOS Central 108 (also referred to as a “provisioning and deployment manager”) may be configured to manage region data, either directly or indirectly (e.g., via RRDD 104). CIOS Central 108 may be configured to compile SPAMs to inject region data as variables within the SPAMs. CIOS Central 108 may be instructed (e.g., by region orchestrator 106) to perform one or more releases (e.g., infrastructure or application releases) according to a given SPAM.

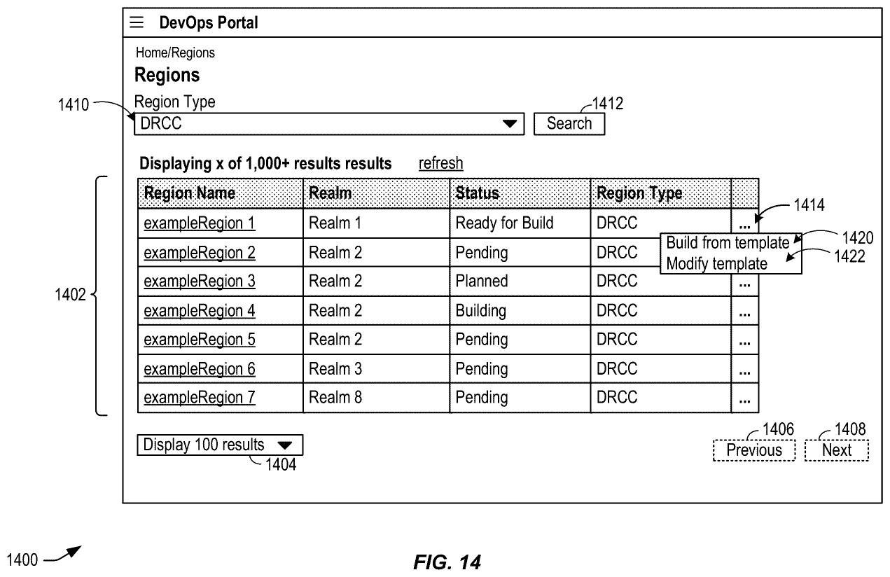

Orchestrator Control Plane 107 may be configured to provide any suitable number of user interfaces with which users (e.g., user 109) may interact with CIOS 102 or view data associated with one or more region builds. By way of example, Orchestrator Control Plane 107 may manage the user interfaces discussed below in connection with FIGS. 14-19. Orchestrator Control Plane 107 may include a build planning module that may be configured to generate a region build plan. Additional details of region build plans and their generation are provided in more detail with the following figures. In some embodiments, Orchestrator Control Plane 107 may be configured to provide and/or instruct any suitable number of region orchestrators (e.g., Region Orchestrator 108) operating in any suitable service cell (e.g., service cell(s) 109).

In some embodiments, an external orchestrator may be used in lieu of Region Orchestrator 108. In these instances, an external orchestrator (e.g., one of external orchestrator(s) 112) may communicate with the Region Orchestrator 106 via Puffin (e.g., Puffin Central 118 and/or Puffin Regional 120) by consuming the signals they wait for and signaling completion of their work via installation of Skills. When the region build plan reaches an external execution unit, the Region Orchestrator 106 may wait for an external orchestrator to signal completion via publishing the relevant skills

Each instance of CIOS Regional 110 may correspond to a module configured to execute bootstrapping tasks that are associated with a service of a region (e.g., a data center such as host region 103). CIOS Regional 110 can receive desired state data from CIOS Central 108. In some embodiments, desired state data may correspond to an infrastructure or software release. In some embodiments, the desired state data may be expressed as part of a flock config that declares (e.g., via declarative statements) a desired state of resources associated with a service. CIOS Central 108 can maintain current state data indicating any suitable aspect of the current state of the resources associated with a service. In some embodiments, CIOS Regional 110 can identify, through a comparison of the desired state data and the current state data, that changes that may be (or are) needed to one or more resources. For example, CIOS Regional 110 can determine that one or more infrastructure components need to be provisioned, one or more artifacts deployed, or any suitable change that may be (or is) needed to the resources of the service to bring the state of those resources in line with the desired state. As CIOS Regional 110 performs bootstrapping operations, it may publish data indicating a transition of a skill from one state to another. A skill state may identify a unit of functionality associated with a service is, or is not, available. The unit could be a portion, or all of the functionality to be provided by the service. By way of example, data may be transmitted from CIOS Regional 110 to Puffin Regional 120 indicating that the state of a skill corresponding to a resource has transitioned to “installed,” indicating the resource is available for authorization/authentication processing (e.g., a subset of the functionality to be provided by the resource). Skills can be used to identify functionality on which a resource or service depends and/or functionality of a resource or service that is available for use. By way of example, in some embodiments, CIOS Regional 110 performs bootstrapping operations which result in publishing a skill (e.g., transmitting skill metadata including a skill state value). The skill metadata may be transmitted to Puffin (e.g., Puffin Regional 120) and used to update the skill state of the corresponding skill.

In some embodiments, Puffin Central 118 may provide a number of user interfaces with which one or more skills can be defined. A skill may be used in lieu of capabilities and enables improvements over previous capabilities-based implementations. Unlike capabilities, skills may be scoped (e.g., controllable through access and authorization policies), versioned, and attributed to a particular service and/or contact. Skills may be associated with a lifecycle and may be monitored for health and are designed to be more highly visible/accessible than capabilities. Puffin Central 118 may provide an authoritative registry for skills. Various user interfaces managed by Puffin Central 118 may be utilized to define, maintain, and manage skills that each service offers, as well as their dependency relationships with other services. Puffin Central 118 may be utilized to declare and persist strongly defined metadata of services in a versioned manner. This metadata may be used to generate a blueprint for build-time and run-time dependencies. These blueprints can be used to validate build plans, to drive orchestration decisions during region build, and to improve time-to-engage and time-to-diagnose measures during region build and/or Large-Scale Events (LSEs).

Puffin Central 118 may be configured to serve as a source of truth for services and may maintain metadata including each service's upstream and downstream dependencies and service team contact information and methods for each service across regions and realms (e.g., a set of regions). Each skill may represent a function unit that a service exposes and offers to consumers (e.g., other services). In some embodiments, skills may be scoped where access is controlled based on access and/or authorization policies and/or based on an association with a particular namespace. A skill may be associated with multiple versions in which one or more aspects of the skill differs from previous versions, where each skill version represents a specific implementation of the skill. Each skill version may be identifiable using a unique skill identifier.

In some embodiments, any suitable computing component of the Puffin Service (e.g., Puffin Central 118 and/or Puffin Regional 120) may be configured to monitor the health and/or lifecycle of a skill according to a predefined skill lifecycle. Health monitoring may be performed using one or more alarms that are associated with a given skill. In some embodiments, a telemetry service (e.g., an example of alarm service(s) 122) may utilize an application programming interface provided by the Puffin Service (including Puffin Central 118 and/or Puffin Regional 120) when an alarm is triggered. As another example, the Puffin Service (e.g., Puffin Regional 120) may request alarm data from the alarm service(s) 122 and/or from storage locations at which the alarm service(s) 122 store the alarm data. The Puffin Service may present, via one or more user interfaces, information related to the health of a skill based on the alarms corresponding to the alarm data obtained and their corresponding association to a given skill.

In some embodiments, the Puffin Service (e.g., Puffin Central 118 and/or Puffin Regional 120) may expose one or more application programming interfaces (APIs) with which validation operations may be performed. By way of example, a SPAM describing the build process with respect to one or more services may be provided via a given API (e.g., by the Region Orchestrator 106). The Puffin Service (e.g., Puffin Central 118) may execute any suitable operations for validating that all services and skills identified in the SPAM have been previously registered with the Puffin Service and that the build process defined in the SPAM does not violate previously defined dependency relationships maintained by the Puffin Service. Additionally, or alternatively, Region Orchestrator 106 may perform any suitable validation check such as determining whether each flock config and/or artifact identified in a given service's manifest is referenced within the service's corresponding service plan and/or that no flock config and/or artifact is referenced within the service plan that is not referenced within the manifest. Region Orchestrator 106 may perform validation operations (e.g., a static analysis including parsing the service plan) to determine that a service plan lacks circular dependencies. If a circular dependency is found within a service plan, Region Orchestrator 106 may provide a notification and/or restrict the service plan and corresponding manifest from being utilized. In some embodiments, such restrictions may include restricting the service plan and manifest from being added to a SPAM set (e.g., a set of SPAMs to be used to perform a region build). In some embodiments, the Region Orchestrator 106 may perform any suitable validation operations to ensure that SPAMs of a SPAM set and/or a SPAM that is being considered as an addition to a preexisting SPAM set are mutually compatible. This may include analyzing the SPAM set (alone or with a SPAM that is being considered for addition) to ensure that the SPAMs of the SPAM set do not include circular dependencies.

In some embodiments, each regional component such as Region Orchestrator 106, CIOS Regional 110, Puffin Regional 120, and/or Virtual Bootstrap Environment 116 may be one of many regional components. Each regional component may be specific to a given region (e.g., as depicted in FIG. 1, Host Region 103). Therefore, another region may include similar, but separate, components that are specific to that region. In some embodiments, central components (e.g., Region Orchestrator 106, CIOS Central 108, RRDD 104, and Puffin Central 118) may include one or more components that are configured to manage build operations corresponding to one or more regions. By way of example only, a single orchestrator (Region Orchestrator 106) may be utilized to manage bootstrapping operations for building any suitable number of data centers, or multiple instances of Region Orchestrator 106 may be utilized, each driving the bootstrapping operations for a subset of those data centers or a single data center. In some embodiments, each Region Orchestrator 106 may operate within one of service cell(s) 109 and isolated from other instances of the Region Orchestrator 106.

In some embodiments, Region Orchestrator 106 (e.g., an orchestration service) may be configured to drive region build efforts. In some embodiments, Region Orchestrator 106 may manage information that describes which flock config versions and/or artifact versions are to be utilized to bootstrap a given service within a region (or to make a unit of change to a target region). In some embodiments, Region Orchestrator 106 may manage any suitable combination of flock configs and/or service plans. In some embodiments, Region Orchestrator 106 may be configured to monitor (or be otherwise notified of) changes to the region data managed by Real-time Regional Data Distributor 104. In some embodiments, receiving an indication that region data has been changed may cause a region build to be triggered by Region Orchestrator 106. In some embodiments, Region Orchestrator 106 may identify SPAMs to be used for a region build. Some, or all, of the SPAMs may be configured to be region agnostic. That is, the SPAMs may not explicitly identify what region(s) to which the flock is to be bootstrapped. In some embodiments, Region Orchestrator 106 may trigger a data injection process through which the collected flock configs and/or SPAMs are recompiled (e.g., by CIOS Central 108). During recompilation, operations may be executed (e.g., by CIOS Central 108) to cause the region data maintained by Real-time Regional Data Distributor 104 to be injected into the config files and/or SPAMs. SPAMs can reference region data through variables/parameters without requiring hard-coded identification of region data. Any suitable portion of the SPAMs can be dynamically modified at run time using this data injection rather than having the region data be hardcoded, and therefore, more difficult to change.

In some embodiments, Region Orchestrator 106 can perform a static analysis in which the identified service plans are parsed to identify execution targets, execution target checkpoints, phases, and flocks, and/or to identify circular dependencies between resources that need to be removed. In some embodiments static analysis data corresponding to this analysis may be stored (e.g., via SPAM store 312 of FIG. 3) for subsequent use. In some embodiments, Region Orchestrator 106 can generate any suitable number of data structures based on the dependencies identified. These data structures (e.g., directed acyclic graph(s), linked lists, etc.) may be utilized by CIOS 102 to drive operations for performing a region build. By way of example, these data structures may collectively define an order by which services are bootstrapped within a region. An example of such a data structure is discussed further below with respect to Build Plan 338 of FIG. 3. If circular dependencies (e.g., a service A skill requires a service B skill and vice versa) exist and are identified through the static analysis and/or graph, Region Orchestrator 106 may be configured to notify any suitable service teams that changes are required to the corresponding SPAM to correct these circular dependencies. Region Orchestrator 106 can be configured to traverse one or more data structures to manage an order by which services are bootstrapped to a region. Region Orchestrator 106 can identify (e.g., using data obtained from Puffin Regional 120) the status of each skill within a given region at any suitable time. Region Orchestrator 106 may utilize this data to identify when it can bootstrap a service, when bootstrapping is blocked, and/or when bootstrapping operations associated with a previously blocked service can resume. Based on this traversal, Region Orchestrator 106 can perform a variety of releases in which instructions are transmitted by Orchestrator 106 to CIOS Central 108 to perform bootstrapping operations corresponding to any suitable number of flock configs.

In some embodiments, the service plans and manifests (SPAMs) utilized by Region Orchestrator 106 may provide a deterministic specification of a build description for a service than previously provided by one or more flock configs. While flock configs specify aspects of a single release associated with a single service, a service plan may provide a single specification of the order and conditional requirements for executing all of the releases that may be needed (or are needed) to build a given service. Previous implementations of flock configs included optional dependencies which allowed for a degree of indeterministic behavior with respect to the order of operations performed during a region build. The inclusion of optional dependencies required an orchestrator to perform multiple passes of the build dependency graph, resulting in wasteful processing. These types of dependencies make it difficult, if not impossible, for the system to track region build progress, identify remaining operations yet to be performed, and/or identify build completion. Service plans and manifests (SPAMs) may be utilized to eliminate at least some of the drawbacks to previous indeterministic approaches.

SPAMs (one SPAM corresponding to one service to be bootstrapped in the region) allow service teams to describe the corresponding operations that may be needed (or are needed) to build their service and may allow for separation between internal coordination (e.g., coordination of operations internal to the service) and external coordination (e.g., coordination of operations between components of different services). A number of visualizations may be provided (e.g., via Region Orchestrator 106 or any suitable component of CIOS 102) via one or more user interfaces. One visualization may depict a directed acyclic graph describing the build operations internal to a given service, and a separate visualization may depict a directed acyclic graph describing the order of build operations corresponding to multiple services (e.g., all services of the region/data center). As a specific example, one or more visualizations can present a region-level directed acyclic graph (DAG) including only external coordination (e.g., an order of operations corresponding to coordination between services) while omitting operations that are internal with respect to each service. This DAG, for example, may depict nodes corresponding to one service's skills on which other services depend, while excluding nodes corresponding to skill dependencies between service components/functional units of the same service.

A SPAM may include an external interaction interface that includes a service build definition that includes a number of build milestones. Each build milestone may be associated with a set of capabilities (and/or skills) that the service is expected to publish upon reaching a given milestone. To transition between build milestones, the SPAM may include execution units that encapsulate a directed acyclic graph (DAG) of one or more releases, each release being equivalent to operations previously defined with a single flock config. Each execution unit may define a set of build time dependencies that identify one or more capabilities (and/or skills) that are required by at least one of the releases of the execution unit.

A SPAM may include a service build implementation. An execution unit of the SPAM may describe one or more releases that may be needed (or are needed) to build a service, with potentially multiple execution units being defined. Each execution unit may be associated with one or more execution target checkpoint transitions, each of which may be used to specify the expected capabilities that should be available before the time of the release and the capabilities that should be published as the result of performing the release.

In some embodiments, the Region Orchestrator 106 may be configured to aggregate SPAMs corresponding to each service to be deployed in a region to generate a larger directed acyclic graph (e.g., the Build Plan 338 of FIG. 3) which may capture all of the operations necessary to build a region/data center. The collection of SPAMs identified from this aggregation may be referred to as a “SPAM set.” In some embodiments, the Region Orchestrator 106 may utilize the DAG generated from a SPAM set to validate a DAG and/or operations performed using flock configs, while the DAG generated from flock configs is used to drive build operations/release execution. Alternatively, the Region Orchestrator 106 may utilize the DAG generated from the SPAM set to drive build operations/release execution. The utilization of a SPAM/SPAM set may be utilized by the system to generate a deterministic execution plan with which the region build may be executed.

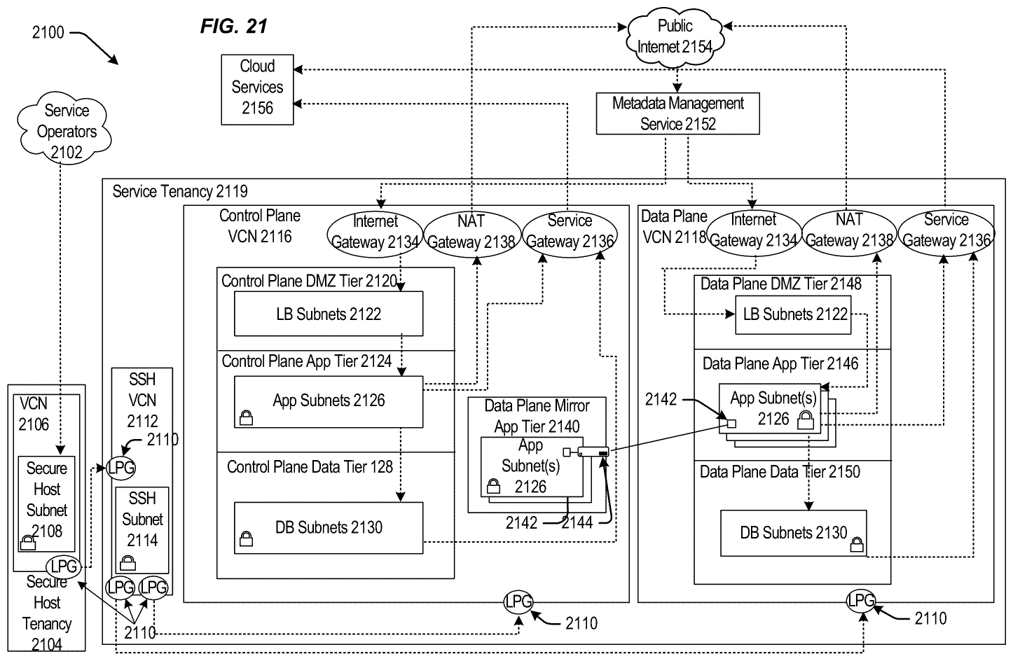

In some embodiments, a user can request that a new region (e.g., target region 114) be built. This can involve bootstrapping resources corresponding to a variety of services. In some embodiments, target region 114 may not be communicatively available (and/or secure) at a time at which the region build request is initiated. Rather than delay bootstrapping until such time as target region 114 is available and configured to perform bootstrapping operations, CIOS 102 may initiate the region build using a virtual bootstrap environment (e.g., Virtual Bootstrap Environment (ViBE) 116. ViBE 116 may be an overlay network that is hosted by host region 103 (a preexisting region that has previously been configured with a core set of services and which is communicatively available and secure). Region Orchestrator 106 may leverage resources of the host region 103 to bootstrap resources to the ViBE 116 (generally referred to as “building the ViBE”). By way of example, Region Orchestrator 106 may provide instructions through CIOS Central 108 that cause an instance of CIOS Regional 110 within a host region (e.g., host region 103) to bootstrap another instance of CIOS Regional within the ViBE 116. Once the CIOS Regional within the ViBE is available for processing, bootstrapping the services for the target region 114 can continue within the ViBE 116. When target region 114 is available to perform bootstrapping operations, the previously bootstrapped services within ViBE 116 may be migrated to target region 114. Utilizing these techniques, CIOS 102 can greatly improve the speed at which a region is built by drastically reducing the need for any manual input and/or configuration to be provided. In some embodiments, any suitable combination of the components depicted as part of CIOS 102 may individually be examples of the cloud services of FIGS. 21-26 (e.g., 2156 of FIG. 21) and may be configured to operate in any suitable infrastructure pattern such as the examples described below in connection with FIGS. 21-26.

FIG. 2 is a block diagram for illustrating an environment and method 200 for building a virtual bootstrap environment (ViBE) 202 (an example of ViBE 116 of FIG. 1), according to at least one embodiment. ViBE 202 represents a virtual cloud network that is provisioned in the overlay of an existing region (e.g., host region 204, an example of the host region 103 of FIG. 1 and in an embodiment is a Host Region Service Enclave). ViBE 202 represents an environment in which services can be staged for a target region (e.g., a region under build such as target region 114 of FIG. 1) before the target region becomes available.

In order to bootstrap a new region (e.g., target region 114 of FIG. 1), a core set of services may be bootstrapped. While those core set of services exist in the host region 204, they do not yet exist in the ViBE (nor the target region). These essential core services provide the functionality needed to provision devices, establish a chain of trust to the new region, and deploy remaining services into a region. The ViBE 202 may be a tenancy that is deployed in a host region 204 and used as a virtual region.

When the target region is available to provide bootstrapping operations, the ViBE 202 can be connected to the target region so that services in the ViBE can interact with the services and/or infrastructure components of the target region. This will enable deployment of production level services, instead of self-contained seed services as in previous systems, and may be connected over the internet to the target region. Conventionally, a seed service was deployed as part of a container collection and used to bootstrap dependencies necessary to build out the region. Using infrastructure/tooling of an existing region, resources may be bootstrapped (e.g., provisioned and deployed) into the ViBE 202 and connected to the service enclave of a region (e.g., host region 204) in order to provision (reserve and/or configure) hardware and deploy services until the target region is self-sufficient and can be communicated with directly. Utilizing the ViBE 202 allows for meeting the dependencies and providing the services needed to be able to provision/prepare infrastructure and deploy software while making use of the host region's resources in order to break circular dependencies of core services.

Region Orchestrator 206 (an example of Region Orchestrator 106 of FIG. 1) may be configured to perform operations to build (e.g., configure) ViBE 202. Region Orchestrator 206 can obtain applicable SPAMs corresponding to various resources to be bootstrapped to the new region (in this case, a ViBE region, ViBE 202). By way of example, Region Orchestrator 206 may obtain a SPAM for building any suitable portion of DNS 212, Worker 210, and/or Puffin Regional 208. In some embodiments, Region Orchestrator 206 may obtain a SPAM identifying aspects of bootstrapping any or all resources of the ViBE 202.

The method 200 may begin at step 1, where Region Orchestrator 206 may instruct CIOS Central 214 (e.g., an example of CIOS Central 108 and CIOS Central 214 of FIGS. 1 and 2, respectively) to build a service of the ViBE 202 or building the ViBE 202 in whole or in part. For example, Region Orchestrator 206 may transmit a request (e.g., including the flock config identified within a SPAM corresponding to building Puffin Regional 208 and a flock config corresponding to building worker 210 identified within the same or a different SPAM) to request bootstrapping of the Puffin Regional 208 and worker 210 that, at this time do not yet exist in the ViBE 202. In some embodiments, CIOS Central 214 may have access to all SPAMs. Therefore, in some examples, Region Orchestrator 206 may transmit one or more identifiers for one or more SPAMs and CIOS Central 214 may independently obtain the corresponding flock config(s) (e.g., flock configs identified by each manifest and/or service plan) from storage (e.g., from database (DB) 308 or SPAM store 312 of FIG. 3).

At step 2, CIOS Central 214 may provide the flock config(s) via a corresponding request to CIOS Regional 216. CIOS Regional 216 may parse the flock config(s) to identify and execute specific infrastructure provisioning and deployment operations at step 3.

In some embodiments, the CIOS Regional 216 may utilize additional corresponding services for provisioning and deployment. For example, at step 4, CIOS Regional 216 CIOS Regional may instruct deployment orchestrator 218 (e.g., an example of a core service, or other write, build, and deploy applications software, of the host region 204) to execute instructions that in turn cause Puffin Regional 208 and Worker 210, to be bootstrapped within ViBE 202.

At step 5, skills data may be transmitted to the Puffin Service 208 (from the CIOS Regional 216, Deployment Orchestrator 218 via the Worker 210 or otherwise) indicating that Puffin Regional and/or Worker 210 are available. Puffin Service 208 may persist this data. In some embodiments, the Puffin Regional 208 receives state transition data (e.g., from CIOS Regional 216) that indicates a particular skill has a particular status. By way of example, the skill provided to Puffin Regional 208 at step 5 may indicate the Puffin Regional 208 and Worker 210 are available for processing.

At step 6, Puffin Service 208 may identify that the Puffin Service 208 and/or Worker 210 are available based on receiving or obtaining data (an identifier corresponding to a skill) from Puffin Regional 208.

At step 7, as a result of receiving/obtaining the data at step 6 from Puffin Regional 208, Region Orchestrator 206 may instruct CIOS Central 214 to bootstrap a DNS service (e.g., DNS 212) to the ViBE 202.

At step 8, the CIOS Central 214 may instruct the CIOS Regional 216 to deploy DNS 212 to the ViBE 202. In some embodiments, the DNS SPAM for the DNS 212 may be provided by the CIOS Central 214 or one or more corresponding flock configs for bootstrapping the DNS 212 may be identified by CIOS Central 214.

At step 9, Worker 210, now that it is deployed in the ViBE 202, may be assigned by CIOS Regional 216 to the task of deploying DNS 212. Worker may execute a declarative infrastructure provisioner in the manner described above in connection with FIG. 3 to identify a set of operations that are needed to deploy DNS 212. These operations may be identified based at least in part on from comparing the flock config (the desired state), a corresponding portion of a SPAM, to a current state of the (currently non-existing) resources associated with DNS 212.

At step 10, the Deployment Orchestrator 218 may instruct Worker 210 to deploy DNS 212 in accordance with the operations identified at step 9. As depicted, Worker 210 proceeds with executing operations to deploy DNS 212 to ViBE 202 at step 11. At step 12, Worker 210 may notify Puffin Regional 208 (e.g., via a skills state transition) that DNS 212 is available in ViBE 202. Region Orchestrator 206 may subsequently identify that the resources associated with the flock configs corresponding to Puffin Regional 208, Worker 210, and DNS 212 are available any may proceed to bootstrapping any suitable number of additional resources to the ViBE 202.

After steps 1-12 are concluded, the process for building the ViBE 202 may be considered complete and the ViBE 202 may be considered built and ready for additional bootstrapping (e.g., the bootstrapping of various cloud services such as cloud services 2156 of FIG. 21). At any suitable time during steps 1-12, Puffin Regional 208 may receive and/or obtain alarm data from one or more alarm services (e.g., the alarm service(s) 122 of FIG. 1). In some embodiments, the alarm data may be processed by Puffin Regional 208. At any suitable time, Puffin Regional 208 may communicate the alarm data or data derived from the alarm data to Puffin Central 118 of FIG. 1. In some embodiments, Puffin Regional 208 (and/or Puffin Central 118) may communicate skill health information to Region Orchestrator 206 indicating corresponding health states associated with one or more skills. In some embodiments, Puffin Regional 208, Puffin Central 118, and/or Region Orchestrator 206 may be configured to execute operations that may pause (partially or fully) any suitable portion of the operations discussed above in connection with the method 200. In some embodiments, this may cause a regions state associated with the region within which method 200 is executed, to be updated to a state that indicates the build of the region is paused. In some embodiments, Puffin Regional 208, Puffin Central 118, and/or Region Orchestrator 206 may be configured to resume the operations of method 200 (and update the region state accordingly) based at least in part on user input, on subsequent alarm data indicating an update to a health state of one or more skills, on a skill health override value, or the like.

FIG. 3 is a block diagram for illustrating an environment and method 300 for bootstrapping services to a target region utilizing the ViBE, according to at least one embodiment.

The method 300 may begin at step 1, where user 302 (e.g., a service team member) may interact with any suitable number of user interfaces managed by Puffin Central 340 (e.g., Puffin Central 118 of FIG. 1). Puffin Central 340 may be configured to read service and/or skill metadata from predefined files or the user 302 may enter service metadata and/or skill metadata at one or more of the provided user interfaces. In some embodiments, Puffin Central 340 may store all service and skill metadata and serve as a centralized authority for the same. At any suitable time, any suitable user may view the service and/or skill metadata such as prior to and/or during performance of the region build.

At step 2, user 303 (the same or different user as user 302) may utilize any suitable user interface provided by CIOS Central 304 (an example of CIOS Central 108 and CIOS Central 214 of FIGS. 1 and 2, respectively) to modify region data. By way of example, user 303 may create a new region to which a number of services are to be bootstrapped.

At step 3, CIOS Central 304 may execute operations to send the change to RRDD 306 (e.g., an example of RRDD 104 of FIG. 1). At step 4, RRDD 306 may store the received region data in database 308, a data store configured to store region data including any suitable identifier, attribute, state, etc. of a region, AD, realm, ET, or the like. In some embodiments, updater 307 may be utilized to store region data in database 308 or any suitable data store from which such updates may be accessible (e.g., to service teams). In some embodiments, updater 307 may be configured to notify (e.g., via any suitable electronic notification) of updates made to database 308.

At step 5, Region Orchestrator 310 (an example of the Region Orchestrator 106 and/or 206 of FIGS. 1 and 2, respectively), operating in a given service cell (e.g., one of service cell(s) 109 of FIG. 1), may detect the change in region data. In some embodiments, Region Orchestrator 310 may be configured to poll RRDD 306 for changes in region data. In some embodiments, RRDD 306 may be configured to publish or otherwise notify Region Orchestrator 310 of region data changes.

At step 6, user 309 (the same or a different user as users 302 and/or 303) may utilize any suitable user interface to select a SPAM set (also referred to as a “template” herein) to identify a set of one or more SPAMs. The SPAMs corresponding to the selected SPAM set may be obtained from DB 312. In some embodiments, Orchestrator Control Plane 340 may identify any suitable number of SPAMs of the SPAM set corresponding to the infrastructure to be provisioned and artifacts to be deployed as part of a region build according to the SPAMs of the SPAM set. In some embodiments, each SPAM may identify versions corresponding to one or more flock configs and/or one or more artifacts that may be needed (or are needed) to build a single service. In embodiments in which one or more SPAMs are utilized, the SPAM(s) (or any suitable portion of the SPAM(s)) may be stored within SPAM store 312 and utilized to identify the particular flock config and/or artifact versions to be utilized for building the region. In some embodiments, the flock configs and/or artifact versions of a SPAM set may be included in the corresponding SPAM(s) and stored within SPAM store 312.

In some embodiments, any suitable manifest items may be derived from any suitable number of SPAMs and the Orchestrator Control Plane 340 may be configured to verify compliance of a flock's behavior (e.g., the build/orchestration operations identified within a flock config) complies with the process defined by a corresponding SPAM. The Orchestrator Control Plane 340 may be configured to ingest SPAMs which provide the information that may be required (or in some cases, that is required) to build an up-front plan of work and to introduce better guardrails than those available in previous implementations. By way of example, the Orchestrator Control Plane 340 generate build plan 338 based at least in part on the SPAM(s) of the SPAM set and may enforce the invariant that all SPAMs within the set are mutually compatible and composable together to form a viable build plan of releases required to build the service(s) of a region to be built. In some embodiments, a SPAM set may be used within a given regional context to improve service build progress tracking. operations composed from a SPAM set may be validated before they are applied and rejected if they are invalid. This provides an improvement over previous implementations which utilize version set item operations which were unconditionally applied. The utilization of SPAMs may enable the Orchestrator Control Plane 340 to build a deterministic plan of work prior to building a region, to block updates that would jeopardize or break an ongoing or future build, to improve the tracking of process of a service build, to detect deviations of flock behavior from the SPAM's specification, and to alert operators of deviations and status. Orchestrator Control Plane 340 may provide Build Plan 338 to Region Orchestrator 310 or Region Orchestrator 310 may otherwise obtain Build Plan 338 (e.g., from a storage location accessible to the Region Orchestrator 310).

At step 7, Region Orchestrator 310 may request CIOS Central 304 to recompile each of the flock configs associated with the SPAM set) with the current region data. In some embodiments, the request may indicate a version for each flock config and/or artifact.

At step 8, CIOS Central 304 may obtain current region data from the DB 308 (e.g., directly, or via Real-time Regional Data Distributor 306) and retrieve any suitable flock config and artifact in accordance with the versions requested by Region Orchestrator 310.

At step 9, CIOS Central 304 may recompile the obtained flock configs with the region data obtained at step 8 to inject those flock configs of the SPAM set with current region data. CIOS Central 304 may return the recompiled flock configs to Region Orchestrator 310 or the recompiled flock configs may be stored within SPAM store 312. In some embodiments, CIOS Central 304 may simply indicate compilation is done, and Region Orchestrator 310 may access the recompiled flock configs via RRDD 306.

In some embodiments, Build Plan 338 may be a region-level plan that includes every release that may be needed (or that is needed) for every service associated with a SPAM of the SPAM set to be bootstrapped within the region/data center. In some embodiments, the region build plan may be represented by a graph (e.g., a directed acyclic graph) that includes “tracks” and “steps.” A “track” refers to a single thread of execution of the Build Plan 338 that may include any suitable number of steps. In some embodiments, multiple tracks may execute concurrently. A “track step” or “step,” for brevity, refers to a node of the Build Plan 338 and may correspond to a single track. In some embodiments, a step may include an assertions about state (e.g., an installation of or health of a skill), an execution of an infrastructure or application release, a control flow operation for handling concurrency, or the like. In some embodiments, a track step is an atomic unit of execution of the Build Plan 338. Any suitable portion of Build Plan 338 may be presented via one or more user interfaces (e.g., one or more interfaces provided by any suitable component of CIOS 102 of FIG. 1, including Orchestrator Control Plane, CIOS Central 304, or the like).

One or more “steps” of the Build Plan 338 may correspond to building the ViBE 316 (or individual services within the ViBE such as Puffin Regional 342 and/or worker 320), another node may correspond to bootstrapping DNS 322. The steps 11-16 may correspond to deploying (via deployment orchestrator 317, an example of the deployment orchestrator 218 of FIG. 2) the resources and/or artifacts identified from a SPAM corresponding to building the ViBE 316 (e.g., an example of ViBE 116 and 202 of FIGS. 1, and 2, respectively). That is, steps 11-16 of FIG. 3 generally correspond to steps 1-6 of FIG. 2. Once notified a skill has been installed (e.g., indicating that Worker 320 and/or Puffin Regional 342, corresponding to Worker 210 and Puffin Regional 209 of FIG. 2, respectively, are deployed/available) the Region Orchestrator 310 may recommence traversal of the Build Plan 338 to identify which operations/releases to be executed next.

Region Orchestrator 310 may continue traversing the Build Plan 338 to identify that one or more releases corresponding to deploying DNS 322 are to be executed. Steps 17-22 may be executed to deploy DNS 322 (an example of the DNS 212 of FIG. 2). These operations may generally correspond to steps 7-12 of FIG. 2.

At step 22, a skill state may be updated to indicate that DNS 322 is available. In some embodiments, CIOS Regional 314 and/or Deployment Orchestrator 317 may initially communicate the installation of the skill (e.g., to Puffin Regional 342). Upon detecting the updated skill state (e.g., via data provided by Puffin Regional 342), Region Orchestrator 310 may recommence traversal of the Build Plan 338. The Region Orchestrator 310 may identify that any suitable portion of an instance of CIOS Regional (e.g., an example of CIOS Regional 314) is to be deployed to the ViBE 316. In some embodiments, steps 17-22 may be substantially repeated with respect to deploying CIOS Regional (ViBE) 326 (an instance of CIOS Regional 314, CIOS Regional 110 of FIG. 1) and Worker 328 to the ViBE 316. One or more skill states may be updated to indicate that that CIOS Regional (ViBE) 326 and worker 328 are available.

Upon detecting the CIOS Regional (ViBE) 326 is available, Region Orchestrator 310 may recommence traversal of the Build Plan 338. On this traversal, the Region Orchestrator 310 may identify that a deployment orchestrator (e.g., Deployment Orchestrator 330, an example of the Deployment Orchestrator 317) is to be deployed to the ViBE 316. In some embodiments, steps 17-22 may be substantially repeated with respect to deploying Deployment Orchestrator 330. A skill state indicating the deployment of the Deployment Orchestrator 330 is complete may be transmitted to the Puffin Regional 342, indicating that Deployment Orchestrator 330 is available.

After Deployment Orchestrator 330 is deployed, ViBE 316 may be considered available for processing subsequent requests. Upon detecting Deployment Orchestrator 330 is available, Region Orchestrator 310 may instruct subsequent bootstrapping requests to be routed to ViBE components rather than utilizing host region components (components of host region 332). Thus, Region Orchestrator 310 can continue traversing the Build Plan 338, at each node instructing release execution to the ViBE 316 via CIOS Central 304. CIOS Central 304 may transmit release requests CIOS Regional (ViBE) 326 to effectuate release execution as instructed by Region Orchestrator 310.

At any suitable point during this process, Target Region 334 may become available. Indication that the Target Region is available may be identifiable from region data for the Target Region 334 being provided by the user 303 (e.g., as an update to the region data). The availability of Target Region 334 may depend on establishing a network connection between the Target Region 334 and external networks (e.g., the Internet). The network connection may be supported over a public network (e.g., the Internet), but use software security tools (e.g., IPSec) to provide one or more encrypted tunnels (e.g., IPSec tunnels such as tunnel 336) from the ViBE 316 to Target Region 334. As used herein, “IPSec” refers to a protocol suite for authenticating and encrypting network traffic over a network that uses Internet Protocol (IP) and can include one or more available implementations of the protocol suite (e.g., Openswan, Libreswan, strongSwan, etc.). The network may connect the ViBE 316 to the service enclave of the Target Region 334.

Prior to establishing the IPSec tunnels, the initial network connection to the Target Region 334 may be on a connection (e.g., an out-of-band VPN tunnel) sufficient to allow bootstrapping of networking services until an IPSec gateway may be deployed on an asset (e.g., bare-metal asset) in the Target Region 334. To bootstrap the Target Region's network resources, Deployment Orchestrator 330 can deploy the IPSec gateway at the asset within Target Region 334. The Deployment Orchestrator 330 may then deploy VPN hosts at the Target Region 334 configured to terminate IPSec tunnels from the ViBE 316. Once services (e.g., Deployment Orchestrator 330, Service A, etc.) in the ViBE 316 can establish an IPSec connection with the VPN hosts in the Target Region 334, bootstrapping operations from the ViBE 316 to the Target Region 334 may begin.

In some embodiments, the bootstrapping operations may begin with services in the ViBE 316 provisioning resources in the Target Region 334 to support hosting instances of core services as they are deployed from the ViBE 316. For example, a host provisioning service may provision hypervisors on infrastructure (e.g., bare-metal hosts) in the Target Region 334 to allocate computing resources for VMs. When the host provisioning service completes allocation of physical resources in the Target Region 334, the host provisioning service may transit data (e.g., a skills update) that indicates that the physical resources in the Target Region 334 have been allocated. The data may be transmitted to Puffin Regional 342 via CIOS Regional (ViBE) 326 (e.g., by Worker 328).

With the hardware allocation of the Target Region 334 established and corresponding skills are updated with Puffin Regional 342, CIOS Regional (ViBE) 326 can orchestrate the deployment of instances of core services from the ViBE 316 to the Target Region 334. This deployment may be similar to the processes described above for building the ViBE 316, but using components of the ViBE (e.g., CIOS Regional (ViBE) 326, Worker 328, Deployment Orchestrator 330) instead of components of the Host Region 332 service enclave (e.g., CIOS Regional 314 and Deployment Orchestrator 317). The deployment operations may generally correspond to steps 17-22 described above.

As a service is deployed from the ViBE 316 to the Target Region 334, the DNS record associated with that service may correspond to the instance of the service in the ViBE 316. The DNS record associated with the service may be updated at any suitable time to complete deployment of the service to the Target Region 334. Said another way, the instance of the service in the ViBE 316 may continue to receive traffic (e.g., requests) until the DNS record is updated. A service may deploy partially into the Target Region 334 and publish information indicating the availability of a skill (e.g., to Puffin Regional 342) indicating that the service is at least partially deployed. For example, a service running in the ViBE 316 may be deployed into the Target Region 334 with a corresponding compute instance, load balancer, and associated applications and other software, but may wait for database data to migrate to the Target Region 334 before being completely deployed. The DNS record (e.g., managed by DNS 322) may still be associated with the service in the ViBE 316. Once data migration for the service is complete, the DNS record may be updated to point to the operational service deployed in the Target Region 334. The deployed service in the Target Region 334 may then receive traffic (e.g., requests) for the service, while the instance of the service in the ViBE 316 may no longer receive traffic for the service.

At any suitable time during method 300, Puffin Regional 342 may receive and/or obtain alarm data from one or more alarm services (e.g., the alarm service(s) 344, an example of the alarm service(s) 122 of FIG. 1). In some embodiments, the alarm data may be processed by Puffin Regional 342 (or Puffin Regional 342 may communicate the alarm data or data derived from the alarm data to Puffin Central 340). In some embodiments, Puffin Regional 342 and/or Puffin Central 340 may communicate skill health information to Region Orchestrator 310 indicating corresponding health states associated with one or more skills. In some embodiments, Puffin Regional 342, Puffin Central 340, and/or Region Orchestrator 310 may be configured to execute operations that pause or otherwise halt any suitable portion of the operations discussed above in connection with the method 300. In some embodiments, Puffin Regional 342, Puffin Central 340, and/or Region Orchestrator 310 may be configured to resume and/or execute any suitable portion of the operations of method 300 (e.g., based at least in part on user input, subsequent alarm data indicating an update to a health state associated with one or more skills, based at least in part on a skill health override value, or the like).

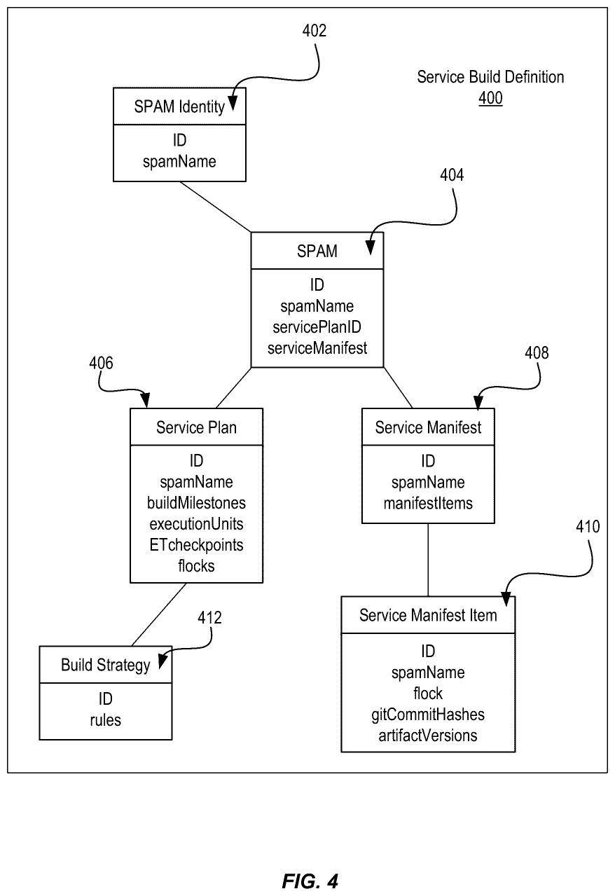

FIG. 4 is a block diagram depicting a data model representing various metadata associated with Service Build Definition 400, in accordance with at least one embodiment. Service Build Definition 400 may include any suitable portion of a service plan and manifest (SPAM). The data structures 402-410 may include any suitable number of attributes (pictured) with corresponding values and may collectively represent a single SPAM. These data structures may be identified within a common file or any suitable number of files. A SPAM may be maintained within the data structures 402-410 as depicted in FIG. 4 or with different data structures. The data structures 410-412 of FIG. 4 may be combined or separated in any suitable manner to maintain metadata corresponding to the SPAM.

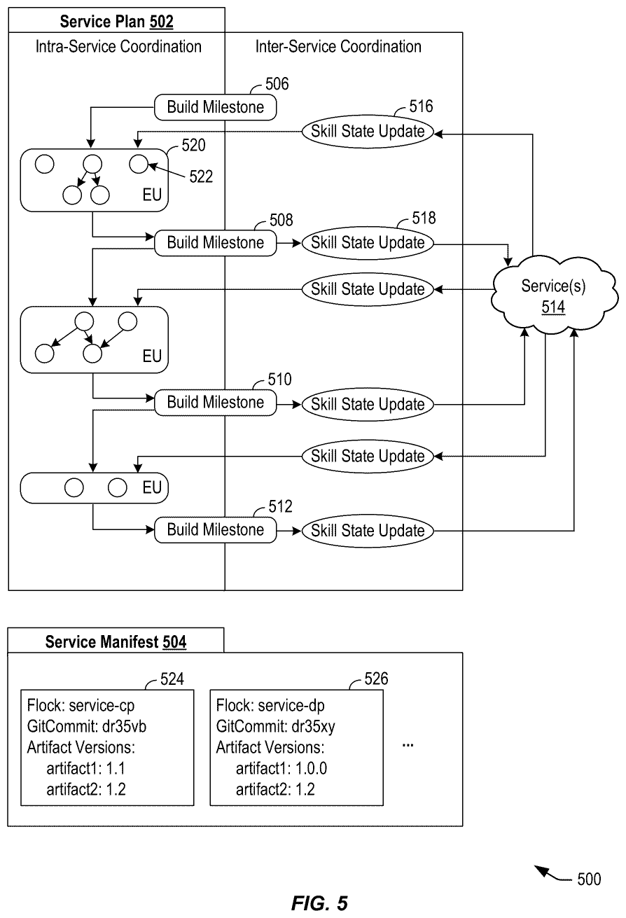

As depicted in FIG. 4, a SPAM may be represented by a combination of the data structures (e.g., data structures 402-410) depicted in FIG. 5. Each of those data structures may include an ID (e.g., an identifier) with a corresponding value that uniquely identifies that data structure. This ID may be used to refer to a particular instance of a particular data structure. Each of the data structures v may include an attribute corresponding to a “spamName” (or another suitable identifier) that may be used to maintain an association between the data structures 402-410 (e.g., to indicate each of the data structures 402-410 correspond to the same SPAM).

In some embodiments, SPAM data structure 404 may include any suitable data corresponding to a SPAM. Any suitable portion of SPAM data structure 404 may be included in service plan data structure 406 and/or service manifest 408. SPAM data structure 502 may include corresponding IDs identifying particular instances of a service plan data structure (e.g., service plan data structure 406) and a service manifest (e.g., service manifest data structure 408) via attributes “servicePlanID” and “serviceManifest,” respectively. Thus, in some embodiments, SPAM data structure 404 maintains a mapping between a service plan (represented by service plan data structure 406) and a manifest (represented by service manifest data structure 406).

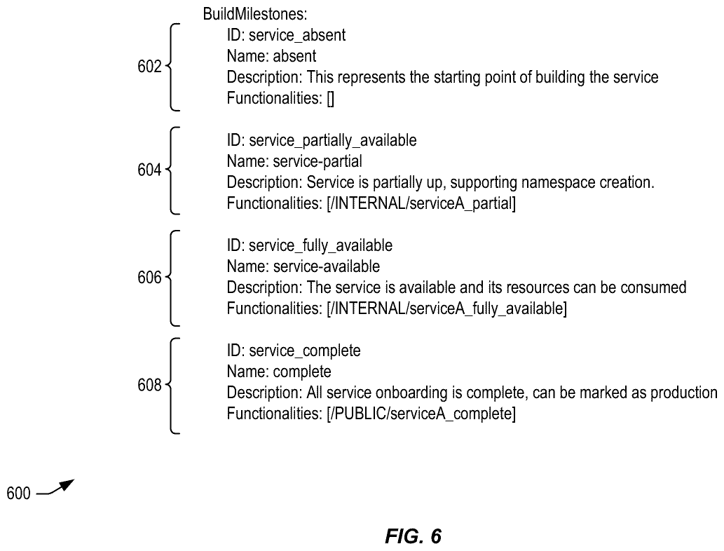

The service plan data structure 406 may represent a service plan and the entities included in a service plan. Service plan data structure 406 may identify one or more build milestones via the attribute “buildMilestones” that may be associated with one or more values that indicate an ordered list of build milestone identifiers (e.g., names, alphanumeric strings, etc.). The “buildMilestones” attribute value may identify, include, and/or otherwise correspond to the build milestones entity 600 of FIG. 6.

In some embodiments, Service Build Definition 400 may include one or more build strategies identified within build strategy data structure 412. As depicted, build strategy data structure 412 may include an attribute “rules,” the value of which may identify any suitable number of build strategies. A “build strategy” refers to an enforced description of how builds occur. A build strategy may include one or more agreements among/between teams for how their services co-operate during cycle-breaking in build, or by the Architects and Region Build managers to ensure an overall strategy is achieved. For example, a build strategy can be used to gate which services build in host region vibe, or for how two services progress through co-dependent steps (each reaching a Milestone in their own SPAM before returning control to the other). These build strategies may be reviewed by Architects before being implemented in the system and may be used in validation checks to ensure changes do not introduce regressions.

In some embodiments, a build strategy may specify pre-conditions which may have functionalities/skills required and post-conditions to ensure/validate that those functionalities were implemented. Each rule in a build strategy may represent a desired/required unit of execution which may be expected (or required) to either be implemented by a SPAM's execution unit or may be (or in some cases must be) a nested build strategy with further details of execution. Each rule in a build strategy may specify a name or other suitable identifier (e.g., a name corresponding to a build stage or specified state) and a description, along with pre- and post-conditions. Rules may be represented by a directed graph. A build strategy may specify both rules and an expected execution order and (if applicable) parallelism. The implementation of a rule may result in changes to a set of installed functionalities/skills. “Internal steps,” which refers to steps which produce no changes, may be modeled as part of a workflow implementing a rule.

A build strategy may be used to describe pre- and post-conditions that specify the conditions for a given node to be executed in terms of functionalities/skills that must be installed (and healthy, if applicable) ahead of the node and what is expected to be true after the node is executed (in terms of functionalities/skills installed or uninstalled, and their associated runtime dependencies). Build strategies may be specified at multiple levels of abstraction—a node in a build strategy may be implemented by a nested build strategy or by an execution unit directly.

FIG. 5 is a block diagram 500 depicting relationships between portions of a service plan (e.g., service plan 502, an example service plan corresponding to service plan data structure 406 of FIG. 4) and manifest (e.g., manifest 504, an example of service manifest corresponding to service manifest data structure 408 of FIG. 4), in accordance with at least one embodiment.

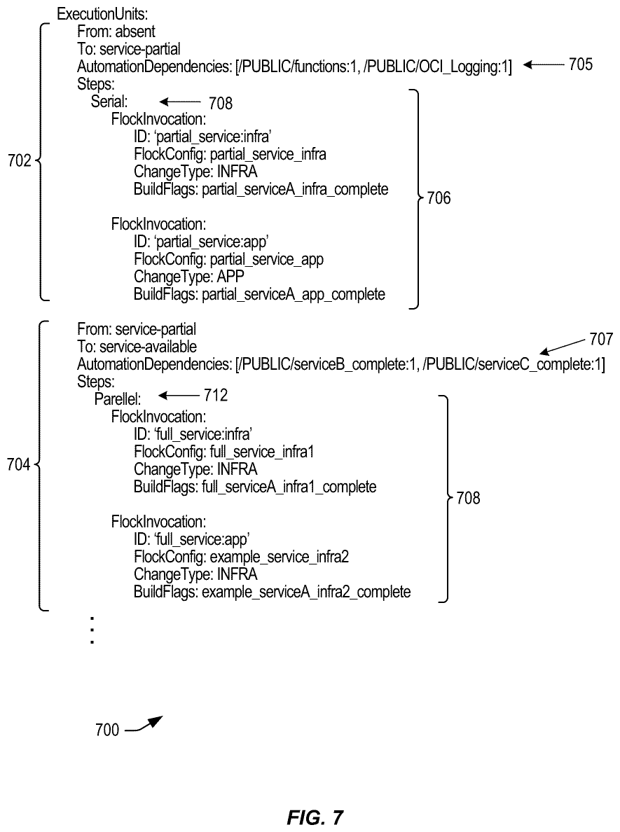

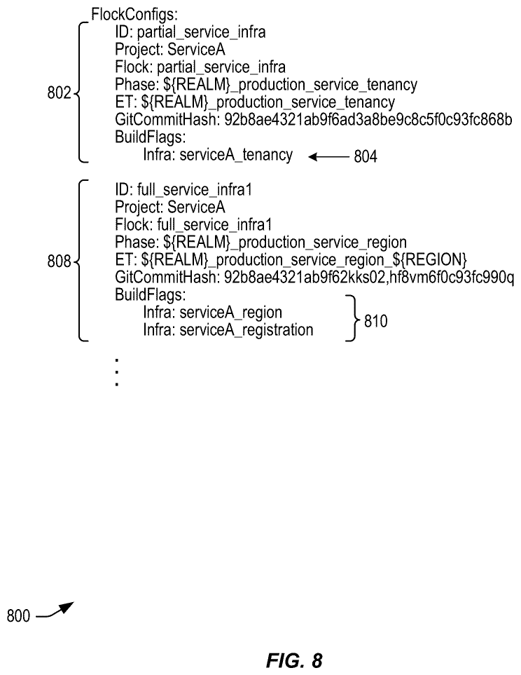

The service plan 502 may include any suitable combination of the build milestones entity 600 of FIG. 6, the execution unit entity 700 of FIG. 7, and the flock config entity 800 of FIG. 8. In some embodiments, the service plan 502 indicates a service build implementation at different levels of granularity. The highest level of granularity indicates the build milestones (e.g., build milestones 906-912, defined with a corresponding build milestone entity similar to build milestone entity 600). The service plan 502 may be used specify a service build to a sequence of build milestones that the service progresses through during its build. Each milestone may represent an interaction that occurs between a given service and other services (e.g., publishing a capability that unblocks other services from building, and/or consuming a new capability published by another service). These build milestones may be used to understand a high-level picture of how that service builds and the inter-service coordination required for that service without having to understand all the services' flocks and their service-internal coordination.

Build milestones 506-512 may individually be associated with a set of external capabilities on which transitioning to the build milestone depends. These capabilities may include the expected published capabilities that are relevant for external services (e.g., service 914, including the other services of the region build). As a non-limiting example, build milestone 906 may depend on skill state update 516 (corresponding to one or more skills) as defined in a corresponding execution unit transition specifying a transition to build milestone 506. Build milestones 506-512 may be associated with corresponding skill state updates that are required to start/continue the installation of another service. By way of example build milestone 508 may be associated with skill state update 518, corresponding to one or more skills that are expected to be installed prior to transitioning to build milestone 508. In some embodiments, build milestones may be used to generate a high-level sequencing diagram that may be used to identify progress in a region build.

Each build milestone may be associated with a corresponding execution unit. By way of example, build milestone 506 may be associated with execution unit 520 (corresponding to an instance of execution unit entity 700 of FIG. 7). Each execution unit, including execution unit 520, may include any suitable number of releases such as release 522, and an order by which these releases are to be executed. Each release may be expressed within the execution unit as an execution target checkpoint transition. The corresponding execution target checkpoint transition may indicate external and/or internal capabilities dependencies for the transition/release and may provide a mapping to a corresponding flock config identified in the service manifest 504. By way of example, release 522 may be ultimately mapped to a particular flock config using the service manifest item 524. The service manifest item 524 may be identified by an identifier provided in the execution target checkpoint referenced by the execution unit 520 and corresponding to the release 522.

Using the entities of the service plan, one or more acyclic graphs may be generated. As a non-limited example, a directed acyclic graph defining the service build may be generated. This DAG may be referred to as a “service DAG” and may include any suitable number of nodes representing a corresponding release and an order by which those releases are to be executed to build that service. The nodes themselves, or edges between nodes, may be associated with external and/or internal capability dependencies. In some embodiments, a graph, list, sequence diagram, or any suitable data structure may be generated for a service and/or for any suitable number of services of the region build using the build milestones corresponding to the service(s). This data structure may be referred to as a “milestone plan.” As yet another example, the Build Plan 338 of FIG. 3 may be generated using the service plan (e.g., as part of a SPAM set including service plans and manifests corresponding to one or more services). As described above in FIG. 3, the Build Plan 338 may be used (e.g., by the Region Orchestrator 310 of FIG. 3) to drive region build operations (e.g., to execute a deterministic order of infrastructure and application releases for the region/data center).

In some embodiments, the service manifest 504 may be utilized to specify the flock versions and artifact versions that will be used to create releases for the execution targets specified in the service plan 502. The service manifest 504 may be used to validate the service plan 502 based at least in part on identifying that each release identified in the service plan 502 is included within the service manifest 504. In some embodiments, each service manifest item (e.g., service manifest item 524) may be mapped to a version set item such that service manifests may be used to validate a version set used by CIOS 102 to perform a region build. As a non-limiting example, a SPAM set may be constructed all SPAMs corresponding to services that are to be bootstrapped within a region/data center. The manifests of the SPAM set may be used to validate a version set, should one be used, to ensure that all flock config files and artifacts referenced in the SPAM set are included in the version set to be used to build the region.

FIG. 6 is a block diagram depicting a build milestone entity 600 of a service plan and manifest, in accordance with at least one embodiment. Build milestones entity 600 may identify any suitable number of build milestones corresponding to a service build. As depicted in FIG. 6, build milestones entity 600 identifies four build milestones corresponding to code segments 602-608. Each build milestone may include any suitable number of unique identifiers (e.g., ID, Name, etc.) with which the build milestone may be uniquely identified. Build milestones may be individually associated with one or more skills that are to be installed as part of the executing the releases of the build milestone. These skills may be published (e.g., data transmitted to transition the skill to a state of “INSTALLED”) upon transitioning, or prior to transitioning to a given build milestone.

Code segment 602 identifies a build milestone entitled “absent,” a corresponding ID (e.g., “service_absent”), a corresponding description, and a list of skills corresponding to functionalities/skills that are to be published as being installed upon transitioning to this build milestone. The list of functionalities, in this instance, is empty, indicating that no skills are expected to be published prior to transitioning to the build milestone “absent.”

Code segment 604 identifies a build milestone entitled “service-partial,” a corresponding to ID (e.g., “service_partially_available”), a corresponding description, and a list of skills corresponding to functionalities/skills that are expected to be published upon transitioning to this build milestone (also referred to as “functionalities” or the skills on which this build milestone depends). The list of functionalities, in this instance, includes “/INTERNAL/serviceA_partial”, indicating that a skill “serviceA_partial” corresponding to a portion of service functionality is expected/required to be published (e.g., transitioned to a state of INSTALLED) upon transitioning to the build milestone “service_partially_available.” In some embodiments, “/INTERNAL/” specifies that the skill “serviceA_partial” is a skill on which the service being built (e.g., “service A”) internally depends. Internal skills may be considered those on which only the service corresponding to these build milestones, and no external services, depend.

Code segment 606 identifies a build milestone entitled “service-available,” a corresponding to ID (e.g., “service_fully_available”), a corresponding description, and a list of skills corresponding to functionalities/skills that are expected to be published (e.g., transitioned to a state of INSTALLED) prior to transitioning to this build milestone. The list of functionalities, in this instance, includes “/INTERNAL/serviceA_backend”, indicating that a skill “serviceA_backend” corresponding to a portion of service functionality is expected/required to be published (e.g., transitioned to a state of “INSTALLED”) upon transitioning to the build milestone “serviceA_fully_available.” In some embodiments, “/INTERNAL/” specifies that the skill “serviceA_backend” is a skill on which the service being built (e.g., “service A”) internally depends.

Code segment 608 identifies a build milestone entitled “complete,” a corresponding to ID (e.g., “service_complete”), a list of skills corresponding to functionalities/skills that are expected to be published prior to transitioning to this build milestone. The list of functionalities, in this instance, includes “/PUBLIC/serviceA_complete”, indicating that a skill “serviceA_complete” corresponding to a portion of service functionality is expected/required to be published (e.g., transitioned to a state of “INSTALLED”) upon transitioning to the build milestone “serviceA_complete.” In some embodiments, “/PUBLIC/” specifies that the skill “serviceA_complete” is a skill on which at least one other external service (a service other than service A of this example) depends.

In some embodiments, each build milestone specifies the functionalities/skills that are expected (and in some cases, required) to be published upon transitioning to the given build milestone. These functionalities/skills, as seen in FIG. 6, may be expressed as internal and/or public skills. The designator “INTERNAL” and “PUBLIC” depicted in FIG. 6 may correspond to respective namespaces. Any suitable functionality/skill may be associated with a corresponding namespace. Any suitable number of namespaces may be utilized. A set of build milestones (e.g., build milestones corresponding to code segments 602-608) may be used to indicate a high-level overview of a process for building a service and may be utilized/consumed by external consumers (e.g., other services that depend on the service to which the build milestones relate). Build milestones may be defined and utilized to express portions of functionality are available for the service. This may allow other service builds to proceed when the functionality on which the other service depends is available (expressed as expected installed skills), rather than waiting for the service in question to become fully available. Build milestones may be used for coordination between services. When building a service does not involve coordination with other services, the service plan for that service may include no build milestones or a number of default build milestones (e.g., “absent” and “complete”). In some embodiments, the build milestones defined in every service plan to be used for a region build may be used to generate a high-level graph and/or sequencing diagram. This may provide service teams a graph view of simplified complexity with which the region build process may be more easily understood and synthesized. As a non-limiting example, a graph/diagram generated using the build milestones for each corresponding service may include a reduced number of nodes (e.g., 3 per service, 4 per service, depending on the service's build milestone implementation) from the Build Plan 338 of FIG. 3 that may include dozens of nodes (representing capabilities) per service.

Returning to FIG. 4, the service plan represented by service plan data structure 406 may include an Execution Unit entity. As depicted, the service plan data structure 406 includes an “ExecutionUnit” attribute with a corresponding value that includes a set of execution units. Each execution unit may be used to describe how a service transitions from one build milestone to the next. An execution unit may describe a directed acyclic graph of releases that need to be performed. The definition of this graph centralizes the definition of how releases (e.g., flock/phase/changeType (e.g., Infra or App) interact. The order of execution units may be driven by the order of build milestones defined in a corresponding build milestones entity 600.

FIG. 7 depicts an example execution unit entity 700 of an example service plan, in accordance with at least one embodiment. Execution unit entity 700 may identify any suitable number of execution units (e.g., one for each transition between ordered pairs of build milestones identified by a corresponding build milestone entity such as build milestone entity 600 of FIG. 6). FIG. 7 depicts two such transitions (e.g., a transition between build milestones “absent” and “service-partial” and another transition between build milestones “service-partial” to “service-available”). Although names are depicted as being used and corresponding to FIG. 6, IDs may be similarly used. Another execution unit may be defined for a transition between build milestones “service-available” and “complete,” but is not depicted in FIG. 7 for brevity. As the build milestones are defined as having a sequential order, so too are the execution units due to their association to the ordered build milestones.

As depicted in FIG. 7, execution unit entity 700 includes execution unit 702 and execution unit 704. Execution unit 702 may correspond to the transition between build milestones “absent” and “service-partial.” Execution unit 704 may correspond to the transition between build milestones “service-partial” and “service-available.” Additional execution units may be included in execution unit entity 700 but not depicted in FIG. 7.

Each execution unit may include one or more automated dependencies. By way of example, execution unit 702 specifies dependencies on a set of public skills (e.g., skills that are installed by a separate service) as depicted at 705. These automated dependencies (also referred to as “external dependencies” may include one or more skills that should (or in some instances, must) be installed (e.g., in a state of “INSTALLED”) prior to executing a transition from one build milestone (e.g., the “absent” build milestone) to another (e.g., the “service-partial” build milestone). The set of automated dependencies may be the union of external skill requirements for all releases defined in the step section of the corresponding execution unit. As depicted in FIG. 7, the automated dependencies are indicated as including public skills corresponding to “/PUBLIC/functions” and “/PUBLIC/OCI_Logging.” The “PUBLIC” designation may correspond to a public namespace with which the two depicted skills are associated. Any suitable number of automated dependencies may be specified. Although public skills are depicted, it should be appreciated that any suitable combination of skills corresponding to any suitable number of namespaces (e.g., PUBLIC, INTERNAL, etc.) may be utilized. In some embodiments, an execution step may include no automated dependencies.

As another example, execution unit 704 specifies a set of public skills at 707. Although not depicted, in some embodiments, the automated dependencies at 707 may include a superset of all skills that are expected (and in some cases, requited) to be installed prior to a transition from one build milestone (e.g., the “service_partial” build milestone) to another (e.g., the “service-available” build milestone).

Each execution unit may include any suitable number of steps (or groups of steps) that, when executed, move the service from one build milestone to another. By way of example, execution unit 702 specifies step section 706 which includes two flock invocations (e.g., to releases corresponding to an infrastructure release and an application release). The ID, a name for the flock config to be utilized (specified by the attribute “FlockConfig”), a change type (e.g., INFRA, APP, etc.), and one or more c may be specified for each flock invocation of step section 706. In some embodiments, a step type may be used to indicate the order of execution of the flock invocation identified within section 706. In section 706, a serial step type is indicated at 708. A serial step type may be used to indicate that the nested flock invocations are to be performed serially in the order listed within section 706.

Other step types may be utilized. For example, a parallel step type may be used if flock invocations may be executed in parallel (e.g., substantially simultaneously, concurrently, and/or overlapping execution). A serial step type may be used if two flock invocations (e.g., with distinct names) have a direct dependency between one another (e.g., the corresponding releases of which are expected to be executed serially). Execution of a release may cause one or more skill states corresponding to one or more skills to be published.

All of the expected skill publications (indications that corresponding skills were installed) associated with a build milestone (e.g., the build milestone that is being transitioned to) may be published when all of the releases of a corresponding execution unit that caused the transition are complete. By way of example, the skill “/INTERNAL/serviceA_partial” may be published upon transitioning to build milestone “service-partial” as indicated in Code segment 604 of FIG. 6. This transition may be completed upon successful release execution corresponding to the two flock invocations of section 706.

As another example, execution unit 704 defines a transition from build milestone “service-partial” to build milestone “service-available.” As depicted, execution unit 704 includes step section 708 which includes multiple flock invocations (e.g., corresponding to two infrastructure releases) which may be executed concurrently as indicated by the designator “Parallel” depicted at 710. The execution of the flock invocations (e.g., releases) specified in section 708 may depend on skills “/PUBLIC/serviceB_complete” and ““PUBLIC/serviceC_complete) being published (e.g., being associated with a state of “INSTALLED”). Each flock invocation may be associated with one or more build flags which are to be posted upon successful execution of the release corresponding to a given flock invocation.

FIG. 8 depicts an example flock config entity 800 of an example service plan and manifest (SPAM), in accordance with at least one embodiment. The flock config entity 800 may be used to specify the particular flock configs corresponding to the releases expressed in the execution units entity 700 of FIG. 7. A given flock config section (e.g., section 802) of flock config entity 800 may indicate any suitable ID, project, flock (e.g., a flock name), phase, execution target (ET), a hash value (e.g., a gitCommitHash uniquely identifying a hash of the flock config, and one or more build flags to be posted upon successfully completing the release corresponding to a flock config corresponding to the section.

By way of example, section 802 may specify details corresponding to one flock config. For example, section 802 may specify a flock ID of “partial_service_infra,” a project “ServiceA,” a flock name “partial_service_infra,” a phase “${Realm} production_service_tenancy,” where “${Realm} is an injectable variable that is injected with current region data when recompiled in the manner described above in connection with FIG. 3. Section 802 may further specify an ET “${Realm} production_service_tenancy,” a Git commit hash of the flock config, and one or more build flags. As depicted in FIG. 8, flock config “partial_service_infra” is associated with one build flag “serviceA_tenancy” which is associated with an infrastructure type as depicted at 804.

Any suitable number of phases may be defined for each flock within its corresponding section. Similarly, any suitable number of execution targets may be defined for each phase. Each execution target may be associated with any suitable number of execution target (ET) checkpoints defined within a given SPAM. Infrastructure checkpoints (e.g., checkpoints related to an infrastructure change) may be grouped and provided within a given section, not depicted). Similarly, application checkpoints (e.g., checkpoints related to an application change) may be grouped and provided within application checkpoint section (not depicted). In some embodiments, the SPAM including flock config entity 800 may be validated to ensure that all references included in the SPAM reference valid components (e.g., components such as flock configs that are managed by CIOS 102 of FIG. 1).

As another example, section 806 may specify details corresponding to another flock config. For example, section 806 may specify a flock ID of “full_service_infra1,” a project “ServiceA,” a flock name “full_service_infra1,” a phase “${Realm} production_service_tenancy” where “${Realm}” is an injectable variable that is injected with current region data when recompiled in the manner described above in connection with FIG. 3. Section 806 may further specify an ET “${Realm} production_service_tenancy,” a Git commit hash of the flock config, and one or more build flags. As depicted in FIG. 8, flock config “full_service_infra1” is associated with two build flags (e.g., “serviceA_region” and “serviceA_registration”) which are associated with an infrastructure type as depicted at 810.

One of the challenges of previous build implementations is understanding what progress should happen each time a release is executed against a particular phase and change type of a flock, particularly when the phase has optional capability dependencies. For each release that the Region Orchestrator (e.g., Region Orchestrator 106 of FIG. 1) initiated in previous implementations, it was not apparent which optional capability dependencies were needed and which capabilities should be published through the release execution. The entities of FIG. 6-8 resolve this ambiguity by stating clear expectations of the capability dependencies and capability publications for each release of an execution target.

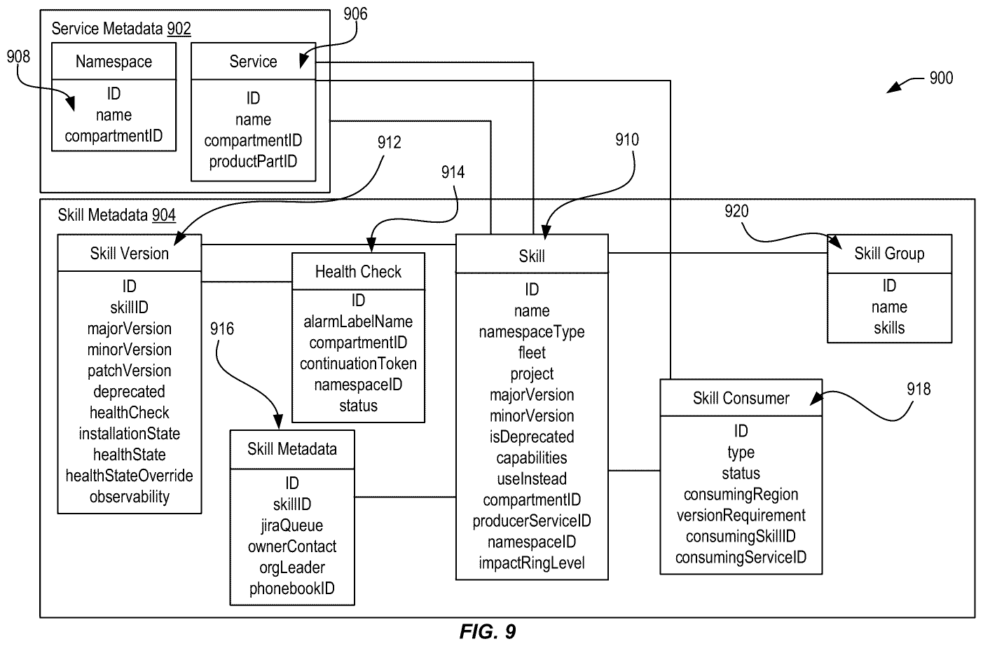

FIG. 9 is a block diagram depicting a data model 900 representing metadata related to a skill, in accordance with at least one embodiment. Each of the data structures depicted in FIG. 9 may include an ID (e.g., an identifier) that uniquely identifies the data structure. This ID may be used to refer to a particular instance of a particular data structure.

In some embodiments, service metadata 902 may include any suitable data corresponding to a service. Service metadata 902 may include any suitable attribute and corresponding value of a service, while skill metadata 904 may similarly include any suitable attribute and corresponding value of a skill. An association between service metadata 902 and skill metadata 904 may indicate a relationship between a service and a skill (e.g., that the service is expected to publish the skill during build or run time). As depicted in FIG. 9, service metadata 902 may be stored in multiple data structures (e.g., namespace data structure 908 and service data structure 906), although any suitable number or type of data structures may be utilized. The service metadata may include, but is not limited to, and suitable combination of ID, a service name (corresponding to a name of the service), a compartment ID (corresponding to an identifier for a compartment to which the service is to be deployed), a product part ID, a namespace ID (an identifier of a namespace associated with the service), a namespace name (a name associated with the namespace associated with the service), and/or a compartment ID corresponding to the namespace. In some embodiments, service metadata 902 may be curated (read from memory, uploaded to Puffin Central 118 of FIG. 1, or the like). In some embodiments, service metadata 902 may be obtained by Puffin Central 118 from another system or, generally, using a process that does not include user input of that information through any of the user interfaces provided by Puffin Central.

Skill metadata 904 may include any suitable number of data structures (e.g., data structures 910-420). In some embodiments, skill data structure 910 may include attributes and values corresponding to any suitable combination of a skill ID, a skill name, a skill fleet, a major version, an isDeprecated indicator, one or more capabilities (e.g., a set of capability identifiers), a useInstead indicator, a compartment ID, a producer ID, a namespace ID, and a recovery ring level. In some embodiments, the values stored for compartment ID, producer ID, and/or namespace ID in the skill data structure 910 may match the compartment ID, service name, or namespace name of service metadata 902, respectively. A match between one or more of the values of these attributes may be used as an association between skill metadata 904 and service metadata 902 (indicating that the corresponding service is expected to publish the skill at some point).

Skill version data structure 912 may be associated with skill data structure 910 based at least in part on matching values of skill ID of skill version data structure 912 and ID of skill data structure 910. Skill version data structure 912 may include attributes and values corresponding to any suitable combination of an ID (for a skill version), a skill ID (e.g., a unique identifier of the skill), a major version and/or a minor version that individually or collectively identify a particular implementation of the skill, a patch version (e.g., a version identifier that identifies a skill to be used to correct a previously erroneous skill version), a deprecated indicator (indicating whether the skill is deprecated or not), a health check attribute (that references one or more instances of alarm data of one or more instances of health check data structure 914), an installation state (indicating a state of installation such as declared, selected, installing, installed, embargoed, retired, uninstalling), a health state (e.g., indicating the health of the skill such as unknown, healthy, unhealthy, etc.), and an observability attribute. The observability attribute may be used to store any suitable data identifying operations or datapoints required to gather telemetry, alarm, and/or log data for the skill version. Skill version data structure 912 may be associated with health check data structure 914 which may be configured to maintain any suitable number of alarm labels that is/are associated with the skill. By way of example, the healthCheck attribute of skill version data structure 912 may reference any suitable number of health check data structures corresponding to one or more instances of health check data structure 914.

In some embodiments, the health check data structure 914 may include any suitable combination of an alarm identifier (alarm ID, indicating a unique identifier for the alarm), an alarm label name (a name of the alarm), a compartment identifier (compartment ID, indicating a compartment to which the alarm is scoped), a continuation token (a token with which alarm transition history may be obtained), namespace identifier (namespace ID, indicating a particular namespace to which the alarm is scoped), and a status value (indicating a health status corresponding to the alarm). Alarm data corresponding to multiple alarms may be maintained in the health check data structure 914. By way of example, alarm ID may include a list of multiple alarm IDs corresponding to a list of alarm label names stored within the alarm label name attribute. The compartment ID attribute may also be a list of compartment IDs corresponding to the alarms and labels of the alarm ID and alarm label name ID attributes of the health check data structure 914. In some embodiments, multiple sets of attributes alarmID, alarmLabelName, compartmentID, continuationToken, and status may be stored, with each set of attributes corresponding to a single alarm.

In some embodiments, health check data structure 914 may store data corresponding to one or more alarm service(s) (e.g., the alarm service(s) 344 of FIG. 3, the alarm service(s) 122 of FIG. 1). By way of example, the namespace identifier of health check data structure may store a namespace corresponding to a skill (e.g., corresponding to an instance of skill data structure 910). In some embodiments, an association between a skill and an alarm may be maintained based at least in part on storing the same namespace identifier within the namespace ID attribute of an instance of the health check data structure 914 and the namespace ID attribute of an instance of the skill data structure 910. In some embodiments, the status attribute may store a value indicating the health of a skill and/or a status of an alarm (e.g., an alarm identified by alarmID, an alarm identified by namespaceID, etc.). In embodiments, in which status from multiple alarm services are utilized, multiple status attributes may be employed to maintain the status of each corresponding alarm (e.g., one status for an alarmID, another for a namespaceID, etc.).

Skill data structure 910 may be associated with skill metadata data structure 916. Skill metadata data structure 916 may include attributes and values for any suitable combination of an ID (for an instance of the skill metadata data structure 916), a Jira queue, an owner contact, an org leader, and a phonebook ID. A phonebook ID may be an identifier corresponding to a separate system that is configured to store contact data. Skill metadata data structure 916 may be used to store any suitable contact data (e.g., name, email, address, phone number, etc.) for an entity (e.g., a service team member) that is associated with the skill and the service with which the skill is associated.

Skill data structure 910 may be associated with skill consumer data structure 918. Skill consumer data structure 918 may include attributes and values for any suitable combination of an ID (for the skill consumer), a type, a status, a consuming region, a version requirement, a consuming skill ID, a consuming service ID. Skill consumer data structure 918 may be configured to store any suitable information on services and/or skills which depend on the skill defined by skill metadata 904.

Skill data structure 910 may be associated with skill group data structure 920. Skill group data structure may include attributes and values for any suitable combination of an ID (for the skill group), a skill group name, and a set of one or more skill IDs associated with the skill group.

Each of the data structures 906-920 may be stored in one or more data stores and a data structure may be identified and obtained (e.g., via a lookup and/or query operation) based at least in part on a value stored in another data structure through the associations discussed above. By way of example, all skills associated with a service may be identified through a query of the data store(s) for all skill data structures that are associated with a producer ID matching the ID from service data structure 906 of service metadata 902.

Although a number and particular combination of data structures are presented in FIG. 9, any suitable number or type of attributes and/or values and/or data structures may be utilized. In some embodiments, data of any data structure depicted in FIG. 9 may be separated into multiple data structures or combined and stored in fewer data structures than those depicted in FIG. 9. The associations indicated between those data structures may be similar to those shown in FIG. 9, or the associations may differ. As a non-limiting example, the data depicted with data structures 910-920 may be similarly stored in more or fewer data structures. By way of example, the data depicted within data structures 910-920 may be provided in a single data structure in some embodiments.

Each data structure of FIG. 9 may be associated with other data structures of FIG. 9 based at least in part on referencing an identifier of one or more other data structures. By way of example, an instance of skill version data structure 912 may be associated with a particular instance of skill data structure 910 based at least in part on having a value for the skillID attribute of the skill version data structure 912 that matches the value of the ID attribute of the particular instance of the skill data structure 910. As another example, a skill consumer data structure 918 may be associated with a skill based on referencing the ID of the skill data structure 910 within its consumingSkillID attribute. As another example, an instance of skill group data structure 920 may be associated with one or more instances of the skill data structure 910 based on referencing the IDs of those skills with its skills attribute. As yet another example, skill version data structure 912 may reference one or more instances of health check data structure 914 based at least in part on references the IDs of those health check data structures within its healthCheck attribute. An instance of the skill data structure 910 may be associated with a particular service based at least in part on referencing the ID of the service data structure 906 corresponding to the service via its producerServiceID attribute.

Any suitable number of instances of skill metadata 904 (corresponding to individual skills) may be associated with a single instance of service metadata 902 and may be used to represent a process of deploying the service in which the order of deployment tasks is represented via the instances of skill metadata 904. Each skill corresponding to an instance of skill metadata 904 for a service may be tracked, updated, or otherwise analyzed to present information regarding the deployment process for the service, to drive deployment of the service, to validate a build plan or the Build Plan 338 of FIG. 3, or the like.

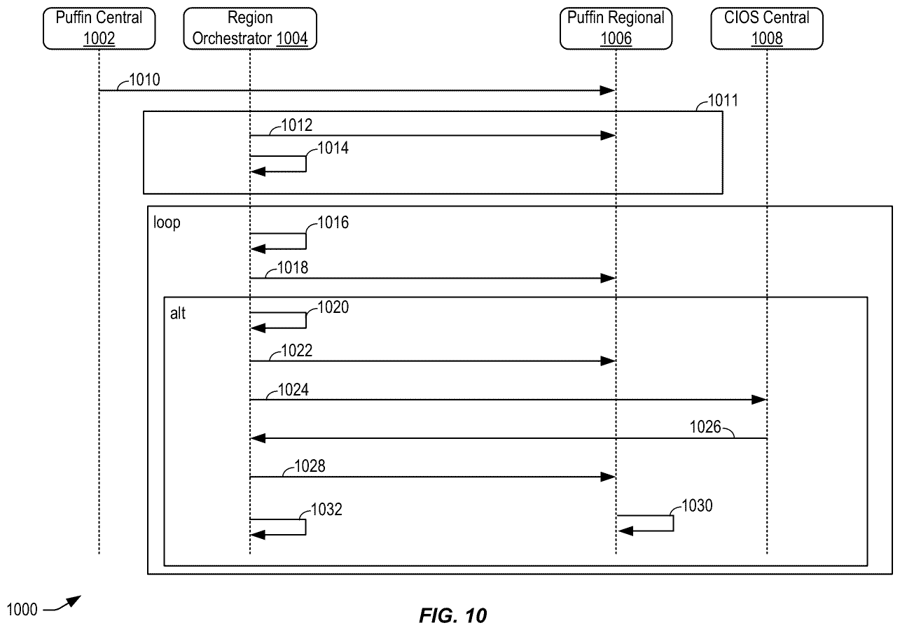

FIG. 10 is a flow diagram depicting an example method 1000 for managing skill states during a data center/region build, in accordance with at least one embodiment. The method 1000 may be performed with any suitable combination of Puffin Central 1002 (e.g., Puffin Central 118 of FIG. 1), Region Orchestrator 1004 (e.g., Region Orchestrator 106 of FIG. 1), Puffin Regional 1006 (e.g., Puffin Regional 120 of FIG. 1), and CIOS Central 1008 (e.g., CIOS Central 108 of FIG. 1). More or fewer operations may be included in method 1000 than the ones described in connection with FIG. 10. The operations of method 1000 may be performed in any suitable order.

Method 1000 may begin at 1010, where Puffin Regional 1006 may be seeded by Puffin Central 1002 with all pre-defined skills, versions, and consumers. In some embodiments, Puffin Central 1002 may utilize an application programming interface, function call, or another suitable method for communicating the metadata corresponding to each skill that has been previously defined (e.g., user-generated and/or system generated skills, the latter being referred to herein as “shadow skills”) to Puffin Regional 1006. In some embodiments, Puffin Central 1002 may send identifiers corresponding to each skill (and their skill version) with which the corresponding instance(s) of skills metadata may be retrieved by Puffin Regional 1006. In some embodiments, Puffin Central 1002 may be configured to identify and transmit skills metadata and/or identifiers (e.g., skill ID, major version, minor version, etc.) for skills which are to be utilized for building a region corresponding to Puffin Regional 1006. In some embodiments, the skill state for each of these skills may indicate that the skills are selected, but not yet installed. The state of a skill may be expressed with any suitable combination of the installationState and/or healthState attributes of a corresponding skill version data structure (e.g., the skill version data structure 912 of FIG. 9). By way of example, the “installationState” attribute may be set to a predefined value associated with the selected state.

Operations 1011 may include any suitable operations for building a SPAM set and ordered build plan. By way of example, at 1012, Region Orchestrator 106 may perform any suitable operations for identifying respective skill states for every skill, version, and consumer for the region. This may include identifying installation and/or health states of each skill (e.g., based at least in part on the installationState and healthState attributes of skill version data structure 912 of FIG. 9), version identifiers corresponding to each skill (e.g., based at least in part on major and/or minor version attributes of skill data structure 910 of FIG. 9), and/or identifiers of each consumer of the identified skills. Consumers of the identified skill may be identified based at least in part on determining all instances of skill consumer data structure 918 that indicate, via any suitable combination of consumingSkillID and/or consumingServiceID attributes, an ID of skill data structure 910 and/or service ID of service data structure 906 corresponding to an identified skill.

At 1014, a SPAM set and/or ordered execution plan may be generated. In some embodiments, building a target set may include any suitable combination of identifying and/or obtaining 1) a Service Plan and Manifest (SPAM) set (e.g., aggregate particular SPAMs, associated with specific version identifiers and corresponding to a set of services to be deployed in the region), 2) a set of artifacts (e.g., program code associated with specific version identifiers, to be utilized/executed for provisioning infrastructure and/or deploying software within the region), or the like. As described above in connection with FIG. 3, generating/building a build plan may include parsing the SPAMs and/or corresponding flock configs to determine dependencies between execution units, dependencies between services, dependencies between execution units of a single service, or the like. The Build Plan 338 of FIG. 3 (or another suitable ordered list indicating operations to be executed for the region build) may be considered an example of an ordered build plan generated by Region Orchestrator 1004 at 1014.

Once built, the ordered execution plan may be utilized by Region Orchestrator 1004 to execute a region build. By way of example, at 1016, the Region Orchestrator 1004 may identify, for a current step, all skills on which the current step depends. Puffin Regional 1006 may be configured to update skill state for any suitable skill state based on data received from Region Orchestrator 1004 and/or an alarm service (e.g., one of cloud services 2156 of FIG. 21), or any suitable combination of the above.

At 1018, Region Orchestrator 1004 may query Puffing Regional 1006 for a current state corresponding to each skill on which the current step depends. A skill may be identified based at least in part on any suitable combination of skill ID, major version identifier, and/or minor version identifier, and/or according to any suitable combination of attribute values that are configured to be unique across skills. At the start of region build (e.g., at a first step, a first node of the Build Plan 338, a first operation of an ordered list of operations, etc.), the current step may lack association to any upstream skill. If no dependencies are identified for the current step, the method 1000 may continue to 1020 without executing the operations at 1018.

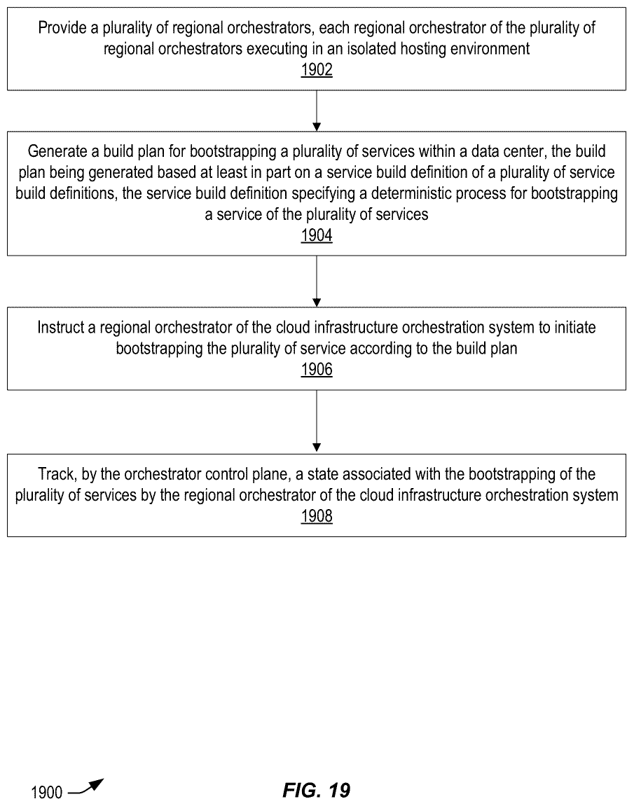

At 1020, in scenarios in which the Region Orchestrator 1004 is returned corresponding skill states for one or more upstream skills (e.g., skills on which the current step depends) that indicate one or more upstream skills are not in a particular state (e.g., “INSTALLED”) and/or substate (e.g., “HEALTHY”), the Region Orchestrator 1004 may execute operations to indicate a failure. In some embodiments, the current state of these skills may be viewed at a user interfaces (e.g., the user interface discussed in connection with FIG. 19, to enable root cause analysis to be performed (e.g., by the system or user). In some embodiments, a sub-state of “UNHEALTHY” of one or more of the upstream skills may cause Puffin Regional 1006 to trace or otherwise traverse the ordered execution plan (and/or Build Plan 338) upward (e.g., from the current step and upstream), to identify a highest upstream skill (first to occur in the ordered execution plan) that is associated with an “UNHEALTHY” state. In some embodiments, Region Orchestrator 1004 may be configured to wait and periodically resubmit its query according to a predefined frequency or schedule, waiting on an indication that the upstream skills are associated with an installation state of “INSTALLED,” and a sub-state of “HEALTHY.”

At 1022, at any suitable time, the Region Orchestrator 1004 may identify the upstream skills are installed and healthy based on the skill states obtained from Puffin Regional 1006. In response to identifying all upstream skills are installed and healthy, Region Orchestrator 1004 may transmit data for the skill(s) associated with the current step indicating the current state of those skill(s) is “INSTALLING.” Transmitting such data may cause Puffin Regional 1006 to update the installation state attribute of the skills version data structure 912 of FIG. 9 that is associated with that skill to indicate a skill state of “INSTALLING.”

At 1024, Region Orchestrator 1004 may execute operations to cause CIOS Central 1008 to initiate one or more releases. In some embodiments, CIOS Central 1008 may instruct an instance of CIOS Regional within the region (e.g., CIOS Regional 110 of FIG. 1, a CIOS Regional 110 deployed within the target region being built, etc.) to perform operations for a given release. Examples of the operations executed by CIOS Central 1008 and CIOS Regional 110 (e.g., CIOS Central 304 and CIOS Regional 314 of FIG. 3) are described in more detail with respect to FIG. 3 and are not repeated here, for brevity. At 1026, CIOS Central 1008 may transmit an indication that the release was successful or unsuccessful. If unsuccessful, Region Orchestrator 1004 may execute operations to instruct CIOS Central 1008 once again, to attempt the release again. This retry process may be executed any suitable number of times and according to any suitable predefined protocol.

At 1028, if the release was successful, Region Orchestrator 1004 may transmit data to Puffin Regional 1006 indicating that the skill(s) associated with the current step are now installed. Any suitable operations executed (e.g., by Region Orchestrator 1004) to update (e.g., via Puffin Regional 1006) a skill state to indicate that the skill was installed may be referred to as “publishing a skill.” In response to receiving this data, Puffin Region 1006 may update the skill(s)′ installation state to a value corresponding to the “INSTALLED” state.

At 1030, in some embodiments, Puffin Regional 1006 may be configured to commence operations for monitoring the installed skill(s)′ health state. In some embodiments, this may include monitoring for one or more alarms (indicated by the alarm labels of health check data structure 914 of FIG. 9. Puffin Regional 1006 may update a sub-state (e.g., the healthState attribute of the health check data structure 914) in accordance with its monitoring. For example, Puffin Regional 1006 may update the sub-state of a skill to indicate an “UNHEALTHY” state if, through its monitoring, it determines that an alarm has been triggered which is associated with a given skill. Puffin Region 1006 may be configured to update set or leave a sub-state of the skill as indicating “HEALTHY” when it determines that no alarm associated with the skill has been triggered (ever, or at least for a predefined threshold time period).

At 1032, Region Orchestrator 1004 may transition to the next step in the ordered execution plan (e.g., to a next node of the Build Plan 338). The operations described at 1016-1032 may be performed any suitable number of times, corresponding to each step in the ordered execution plan. When a last step has already been reached in the plan, the Region Orchestrator 1004 may conclude the region build at 1032.

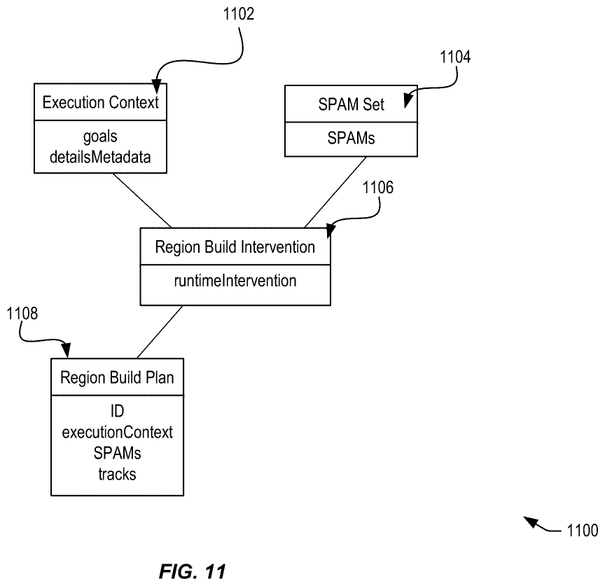

FIG. 11 is a block diagram depicting a data model 1100 representing various metadata related to a region build plan, in accordance with at least one embodiment. Data model 1100 may include data structures 1102-1108.

Execution context data structure 1102 may include any suitable attributes corresponding to execution context such as one or more goals and/or details metadata as depicted in FIG. 11. By way of example, execution context data structure 1102 may store (e.g., within detailsMetadata) environment type, execution overrides, state overrides, and data indicating planned concurrency. Environment type (e.g., REGION_BUILD) may define the type of build and one or more guardrails. Execution overrides (e.g., SpamX: HALT_ON_ERROR, SpamY: HALT_BEFORE_RELEASE) may be used to deviate from normal automated modes for sub-sections of the build process. State overrides (e.g., skillHealth[skillX]=HEALTHY) may be used to overcome untrustworthy data or to support optimistic efforts. Planned concurrency data may define planned concurrencies for the build plan which may be used to configure a planning module to map necessary actions into tracks. Expected values may include a maximum concurrency value (e.g., MAX, 1, 5, etc.) that identifies a degree of allowed concurrency. By way of example, a value of “MAX” may indicate that a maximum default amount of concurrency (e.g., 10 threads at a time) may be employed during the build, while a value of “1” may be used to indicate that build execution should be executed serially. Actual release concurrency may be governed by the runtime setting of a Region Orchestrator (e.g., Region Orchestrator 106 of FIG. 1) which may limit the number of concurrent releases globally and/or by SPAM.

SPAM set data structure 1104 may include any suitable number of identifiers (e.g., SpamX: 1.0.1, SpamY: 1.2.1, SpamZ: 2.1.1, etc.) identifying any suitable number of SPAMs. These identifiers may be any suitable ID or spamName referenced in any suitable number of SPAM identity data structures (e.g., data structure 402 of FIG. 4) and/or SPAM data structure 404 of FIG. 4. The SPAM set data structure 1104 may identify the set of SPAMs (and through association with specific identifiers) the specific versions of those SPAMs to be used for a region build.

Region build intervention data structure 1106 may include any suitable attributes and values corresponding to one or more runtime interventions. By way of example, the attribute runtimeIntervention may include a list of runtime interventions. An intervention may be pushed to a region plan executor at any time (e.g., via the Orchestrator Control Plane 107 of FIG. 1). These may be changes which modify execution of the current region build plan, or a new region build plan to replace the existing one. An intervention may pause execution of one or more (or all) tracks and/or to stop state changes from occurring while debugging is happening or while a new plan update is being authored. While execution is paused, no new actions will be taken, but ongoing external actions may continue to be monitored (e.g., releases may not be stopped, but the changes in state resulting from those releases may not be reflected (e.g., via one or more user interfaces, etc.) until after execution is un-paused.

One type of runtime intervention may include a “CONTINUE” intervention. A CONTINUE intervention may utilize a track reference (e.g., “TrackRef”), a track state (e.g., “TrackState”), and an expected current step reference (e.g., “ExpectedCurrentStepRef”) as input. A CONTINUE intervention may be utilized to continue the identified track and may be valid only when the target track is eligible for CONTINUE. In some embodiments, the track may be halted (in a stated of “HALT,” due to error or breakpoint), running (e.g., in a state of “RUN”), or waiting (e.g., in a state corresponding to “WAIT”) for any reason. A CONTINUE intervention for a waiting step (e.g., a step that is in a state of WAIT) may cause the current step to end and an advancement to the next step. A CONTINUE intervention for a running step (e.g., a step that is in a state of RUN), may cause the CONTINUE to wait for the step to complete, and then continue to the next step, even if the step would have failed due to an error. This permits an intervention to specify the next step even if a release is running.

Another example of a runtime intervention may include a “CONTINUE TO” intervention which may take as input a track reference (e.g., “TrackRef”), a track state (e.g., “TrackState”), an expected current step reference (e.g., “ExpectedCurrentStepRef”) and a next step reference (e.g., “NextStepRef”). A CONTINUE_TO intervention may be used to continue the identified track, setting the next turn to execute to the step identified by the next step reference rather than the immediate next step in the build plan.

Another example of a runtime intervention may include a “SET_BREAKPOINT” or a “CLEAR BREAKPOINT” intervention, each of which may take as input a list of step references. These runtime interventions may be used to set or clear breakpoints on steps. Breakpoints may be used to pause execution before a specified step (e.g., HALT_BREAKPOINT). In some embodiments, a validation error may result for an intervention if the step is unreachable from a current execution state (e.g., it has already run and it is too late to break before execution).

Another example of a runtime intervention may include a “TRACK HALT_ON_ERROR” or a “CLEAR_TRACK_HALT_ON_ERROR,” each of which may take as input a list of step references. These runtime interventions may be used to set of clear a track halt on error (e.g., within a RETRY). They be intended to be used to have the execution of the build halt when a release fails, when it would typically exhaust retries before halting without the intervention.

Another example of a runtime intervention may include a “SET_SKILL_OVERRIDE,” each of which may take as input an override scope (e.g., “OverrideSceop”), a skill reference (e.g., “SkillRef”), a skill version (e.g., “SkillVersion”), a skill install status (e.g., “SkillInstallStatus”), and a skill health status (e.g., “SkillHealthStatus”). In some embodiments, the skill reference, skill version, skill install status, and skill health status may be associated with one or more of the attributes of skill data model 900 of FIG. 9. These runtime interventions may be used to set of clear a track halt on error (e.g., within a RETRY). They be intended to be used to set skill health install or provide a health override to be scoped globally/for the build plan, to a SPAM, or to an execution unit. A CLEAR_SKILL_OVERRIDE intervention may take as input the same parameters and may be used to clear a specific skill install/health override.

Region build data structure 1108 may include any suitable attributes and values corresponding to a region build plan such as an identifier (e.g., “ID”) that uniquely identifies the region build plan, an execution context (e.g., data corresponding to the execution context data structure 1102), a set of SPAMs (e.g., data corresponding to the SPAM set data structure 1104), and a set of one or more tracks.

A region build data structure 1108 may store a region build plan which may be a detailed graph of execution. A region build plan may be represented as a set of tracks each with a sequence of steps. Each step may be an action the region orchestrator takes that affects the current execution state and possibly external systems. When a region build plan is provided to the region orchestrator it may have an initial track (when starting a new plan) or “intervention” (when updating an existing plan) which contains the steps needed to transition into the new plan.

Each track may be a linear sequence of steps. In some embodiments, one step is current within a track at a time. Tracks may be defined by execution units, by the needs of flow control, or as part of an intervention. For execution units, the steps of the workflow may correspond to the steps within the track. In some embodiments, a planner component of the system may flow control tracks based at least in part on the topological sort of the dependencies in order to invoke execution units when their preconditions will be met. Region build plan execution may begin with the initial track, which will start additional tracks based on how much concurrency is possible and permitted (e.g., based at least in part on the executionContext associated with the region build plan). A region build plan may be considered to be completed when all tracks have been executed. If a track is stuck (e.g. due to a release failing and exhausting retries), then the operator may be signaled (e.g., via a notification, an email, a user interface, or the like) and an intervention may be utilized to complete the plan. Depending on the execution context settings, other work that is not dependent on that release may continue.

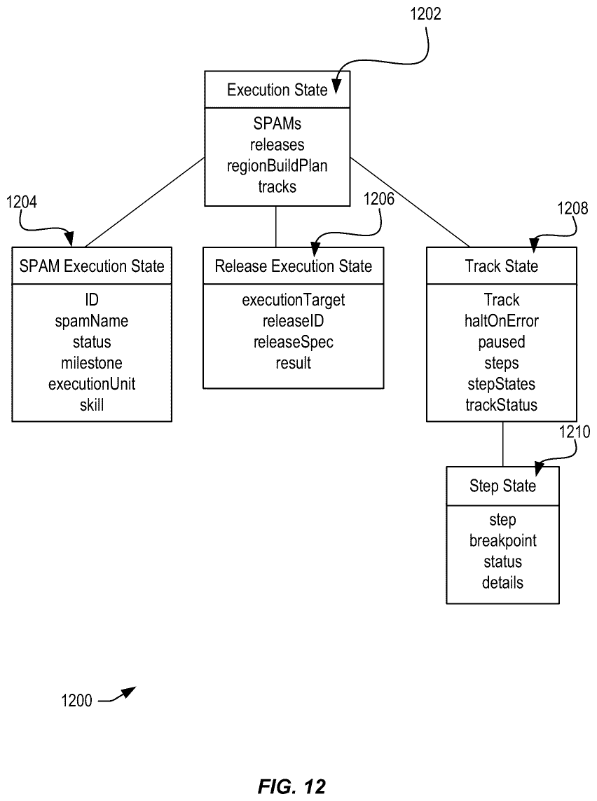

FIG. 12 is a block diagram depicting a data model 1200 representing various metadata related to maintaining an orchestration state corresponding to building a data center (e.g., a data center of a region, also referred to as a “region build”), in accordance with at least one embodiment.

Data model 1200 may include data structures 1202-1210 which individually maintain state of one or more components of a given execution (e.g., an instance of a region build). By way of example, execution state data structure 1202 may include a list of SPAMs, a list of releases, the region build plan (e.g., an instance of the region build plan identified as part of region build plan data structure 1108 of FIG. 11), and a set of tracks (e.g., the tracks corresponding to the region build plan).

For each SPAM of a region build, an instance of SPAM execution state data structure 1204 may be maintained to store the execution state of the SPAM. The execution state may include any suitable combination of ID and/or spamName (e.g., the ID and/or spamName corresponding to FIG. 4) and a status. In some embodiments, a currently milestone (e.g., “milestone”) and a current execution unit (e.g., “executionUnit”) may be maintained within SPAM execution state data structure 1204.

For each release of a region build, an execution state may be maintained in an instance of release execution state data structure 1206. In some embodiments, the release execution state data structure 1206 may include any suitable combination of an execution target (ET) (e.g., “executionTarget”) that identifies an execution target to which the release is expected to be applied, a release ID (e.g., “releaseID”) that uniquely identifies the release, a release specification (e.g., “releaseSpec”), and a result (e.g., “result”) which indicates the release is pending, successful, has failed, or the like.

For each track of a region build plan, the track state may be maintained in an instance of track state data structure 1208. The track state data structure may include any suitable combination of an identifier for the track (e.g., a value corresponding to attribute “Track”), a halt on error setting (e.g., “haltOnError”), a paused setting (e.g., “paused”) which may indicate whether the track is paused, a set of steps (e.g., “steps”), a step state (e.g., “stepStates”) indicating a corresponding status for each of the set of steps, and a track status (e.g., “trackStatus”) that indicates an overall status of the track. In some embodiments, the step states attribute may include any suitable number of instances of the step state data structure 1210 or identifiers individually corresponding to an instance of the step state data structure 1210. Example track statuses may include, but are not limited to, “future” (e.g., not yet started), “run” (e.g., currently running), “halt_error” (e.g., halted due to terminal error such as a guard assertion failed or a release failed, and/or is out of retries), “wait_retry” (e.g., step is waiting between attempts where a prior attempt has failed), “wait_skill” (e.g., waiting for a skill to be installed or to become healthy), “wait_concurrency” (e.g., waiting due to a concurrency limit of the execution context discussed above), “wait_join” (e.g., waiting on a join after a fork step), “complete” (e.g., ran to completion), or the like.

For each step of a track, a step state may be maintained in an instance of step state data structure 1210. The step state data structure 1210 may include any suitable combination of a step identifier (e.g., “step,” that corresponds to one of the steps identified in track state data structure 1208), a breakpoint (e.g., “breakpoint”), a status, and any suitable metadata corresponding to the step (e.g., “details”). A “step” may represent an atomic unit of execution along the path of execution—this may be executing a release (within a retry clause), guarding based on skill installation state and health (to wait to start a release or other action until dependencies are healthy), starting or waiting for other tracks to complete, or the like. Each step may be identified by a step ID (e.g., “step”) and is how the current execution status of the tracks may be ascertained/known.

An example step type may include an EXECUTION_UNIT_START step type which may take as input a SPAM identifier and an execution unit identifier corresponding to a transition between two build milestones. A step corresponding to an EXECUTION_UNIT_START step type may be used to indicate the beginning of an execution unit within a SPAM.

An example step type may include an EXECUTION_UNIT_END step type which may take as input a SPAM identifier and an execution unit identifier corresponding to a transition between two build milestones. A step corresponding to an EXECUTION_UNIT_END step type may be used to indicate the end of an execution unit within a SPAM.

An example step type may include a RELEASE step type which may take as input a release which may include a SPAM, an ET alias, a release type, a checkpoint identifier, a change type, and one or more artifacts to be used for the release. A step corresponding to a RELEASE step type may be used to execute a release attempt. In some embodiments, the RELEASE step may fail if the release fails.

An example step type may include a SKILLS_UPDATE step type which may take as input an execution unit identifier and a skill version identifier and a value to which the state of the skill may be updated (e.g., “INSTALLING,” “INSTALLED,” “UNINSTALLING,” “SELECTED,” “RETIRED,” etc.). A step corresponding to a SKILLS_UPDATE step type may be emitted to set a skill version state (e.g., the skill version state discussed above in connection with FIG. 4).

An example step type may include a SKILLS_SELECT step type which may take as input a set of selected skills. A step corresponding to a SKILLS_SELECT step type may be used to update all Skills for the region to SELECT the correct skills (and UNSELECT the rest that are unresolved). In some embodiments, a SKILLS_SELECT step may be used to inform Puffin which skills are expected to be installed (SELECTED) and which of the skills known to Puffin will not be installed (UNSELECTED).

An example step type may include a GUARD step type which may take as input a list of skill guard specifications, a skill guard identifier, a guard type, and an install state. A GUARD step may be used to specify preconditions for another step. If execution has been paused during a guard, all GUARDS will be rechecked before continuing to execution the step.

An example step type may include a SERIAL step type which may be used to specify a series of steps that will be run in series/sequence.

An example step type may include a FORK step type which may be used to specify a series of tracks to be started.

An example step type may include a JOIN step type which may be used to specify a set of tracks to complete before continuing.

An example step type may include a RETRY step type which may be used to specify a retry policy. By way of example, a RETRY step may take as input a retry or backoff policy. A RETRY step may be used to run a step, if it fails, the retry step will be re-attempted according to a the retry policy/backoff policy. If the number of retries run out as defined by the policy, the step may be halted.

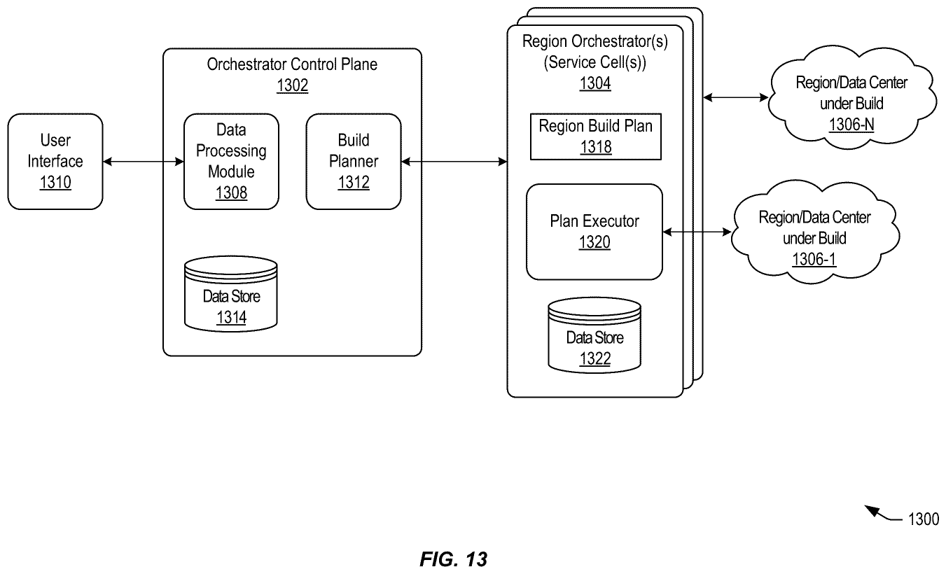

FIG. 13 is a block diagram depicting an example computer architecture 1300 including components that are configured to build a data center in an automated fashion, in accordance with at least one embodiment. Architecture 1300 may include Orchestrator Control Plane 1302 (an example of the Orchestrator Control Plane 107 of FIG. 1) and Region Orchestrator(s) 1304 (each, an example of the Region Orchestrator 106 of FIG. 1). Each of the region orchestrator(s) 1304 may individually operate in a corresponding service cell (e.g., an isolated computing environment isolated from other service cells). In some embodiments, each region orchestrator of a service cell may be configured to execute a region/data center build of a corresponding region (e.g., region/data center build 1306-1, region/data center build 1306-N, etc.).

Orchestrator Control Plane 1302 may include data processing module 1306. Data processing module 1308 may be configured to receive and transmit data from/to user interface 1310. User interface 1310 may be an example of the user interfaces 1400-1900 discussed in further detail in connection with FIGS. 14-19. Data processing module 1306 may be configured to receive any suitable user input provided via user interface 1310 and/or provide any suitable data to be presented via user interface 1310.

In some embodiments, perhaps in response to receiving user input (e.g., user input indicating a region build start request including a SPAM set and/or a set of identified services to be built as part of a region build), the functionality of the build planner 1312 (a component of the orchestrator control plane 1302) may be invoked. In some embodiments, the build planner 1312 may be configured to generate a region build plan (e.g., a set of tracks, each track including a set of steps as discussed in connection with region build plan data structure 1108 of FIG. 11) based at least in part on the SPAM set identified. In some embodiments, build planner 1312 may retrieve any suitable number of SPAMs from data store 1314 (an example of the SPAM store 312 of FIG. 3) with which the region build plan may be generated. Generating the region build plan may include parsing any suitable number of SPAMs of the SPAM set and generating an ordered list of execution tracks and corresponding steps based at least in part on the build milestones, execution units, and flock configs identified within each SPAM as well as internal and/or external skill dependencies specified within the SPAMs. Internal skill dependencies may refer to skills on which a given service publishes/updates and internally depends, while external skill dependencies refer to skills that are published/updated by other services, but on which a given service depends.

Region build plan 1316 may be an example of a region build plan generated by build planner 1312. In some embodiments, Orchestrator Control Plane 1302 may be configured to transmit region build plan 1318 to a Region Orchestrator (e.g., one of Region Orchestrator(s) 1302, corresponding to a service cell associated with a region to be built using the region build plan).

In some embodiments, each Region Orchestrator (e.g., Region Orchestrator(s) 1304) may include a plan executor 1320. Region build plan 1318 may be received by plan executor 1320 and stored in data store 1322 for subsequent use. Plan executor 1320 may be a computing component that is configured with program code to execute the steps of a region build plan (e.g., region build plan 1318). By way of example, plan executor 1320 may transmit instructions for performing any suitable number of releases to an instance of CIOS Central (e.g., CIOS Central 108 of FIG. 1, not depicted here in FIG. 13) to effectuate any suitable number of infrastructure and/or application releases according to the tracks/steps of the region build plan 1318.

FIG. 14 is a schematic of an example user interface 1400 for viewing region details, in accordance with at least one embodiment. User interface 1400 may be an example of a user interface managed by the Orchestrator Control Plane 107 of FIGS. 1 and/or 1302 of FIG. 13.

User interface 1400 may present any suitable data corresponding to any suitable number of regions within area 1402. In some embodiments, the area 1402 may be limited to presenting a default number of entries, each entry corresponding to a given region. Menu option 1404 may be utilized to modify the number of entries presented via area 1402. When the number of region entries exceeds the number of entries to be presented (as identified by option 1404), navigation options 1406 and/or 1408 may be provided to page forward (e.g., via the next option) or backward (e.g., via the previous option) through pages of entries.

In some embodiments, the entries presented via area 1402 may be filtered based on filter option 1410. By way of example, filter option 1410 may be a drop-down menu or another suitable selectable option with which a region type may be specified. In the example provided in FIG. 14, a region type may be selected (e.g., DRCC) and a search option 1412 may be subsequently selected. This combination of inputs may result in the entries with area 1402 to be updated to include only entries that correspond to the region type selected (in this example, “DRCC”).

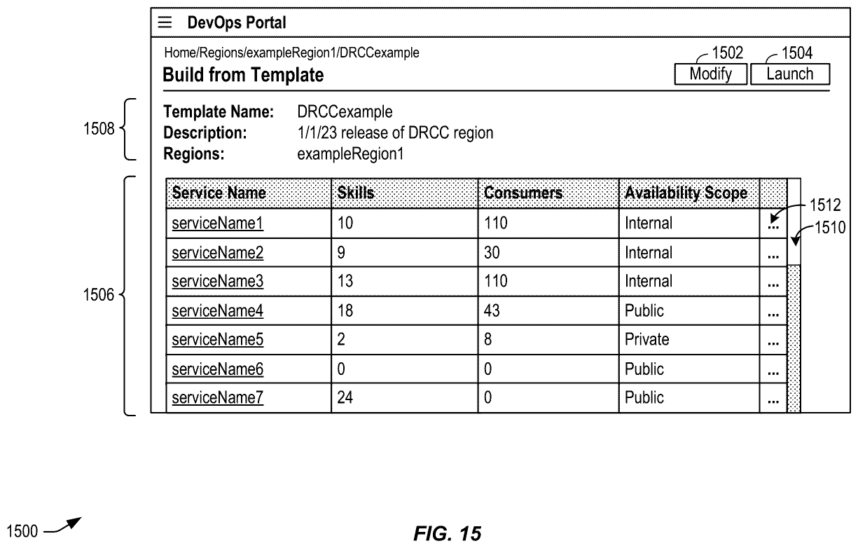

User interface 1400 may include option 1414 which, when selected, may produce a popup window or another suitable selection mechanism for choosing option 1416 or option 1418. Selecting option 1416 may cause navigation to user interface 1500 of FIG. 15. Selecting option 1418 may cause navigation to a user interface with which a build template may be modified. Modifying a build template may similarly present service names and corresponding information as depicted in FIG. 15, but with options provided with which those entries may be modified. In some embodiments, selecting option 1418 may be the equivalent of selecting option 1416 and subsequently option 1502 of FIG. 15.

FIG. 15 is a schematic of an example user interface 1500 corresponding to building a data center from a template, in accordance with at least one embodiment. User interface 1500 may be an example of a user interface managed by the Orchestrator Control Plane 107 of FIGS. 1 and/or 1302 of FIG. 13.

User interface 1500 may include area 1510 which may list any suitable number of entries corresponding to any suitable number of services that are to be built according to the template specified within area 1508. A template may be predefined (e.g., via a file or other configuration file) and may specify any suitable number services by service name. Each template may be associated with any suitable metadata such as a template name, a description, and one or more regions as depicted within area 1508. Each service specified by a template may individually be associated with any suitable metadata such as the number of skills to be published by the service, a number of consumers of the skills published by the service, and an availability scope, to name a few and as depicted with area 1506. The area 1506 may be scrollable using interface element 1510 (e.g., a scroll bar).

In some embodiments, selecting option 1502 may enable the entries of area 1506 to be modifiable. To modify an entry, option 1512 may be selected. Upon selecting option 1512 a popup menu or another suitable interface element may be presented with which user input may be entered in order to remove any suitable service from the entities associated with a template. Although not depicted, selection of option 1502 may cause an option to add a service to the template. Adding a service may be accomplished in a variety of ways such as providing a popup window or drop-down menu with which a service may be selected. An additional option to add the selected service may be provided in any suitable portion of the user interface 1500.

At any suitable time, option 1504 may be selected to launch a region build. Launching a region build may cause the set of service listed as entities within area 1506 to be transmitted to the Orchestrator Control Plane 107 and/or 1302 of FIGS. 1 and 13, respectively. The Orchestrator Control Plane may be configured to identify a SPAM set corresponding to the template and/or to retrieve SPAMs corresponding to the services identified within area 1506 when the option 1504 was selected. Operations for generating a region build plan may be executed in the manner discussed in the above figures to generation a deterministic region build plan for building each of the services identified within area 1506 (e.g., each of the services identified by and/or associated with the template selected when the option 1504 was selected).

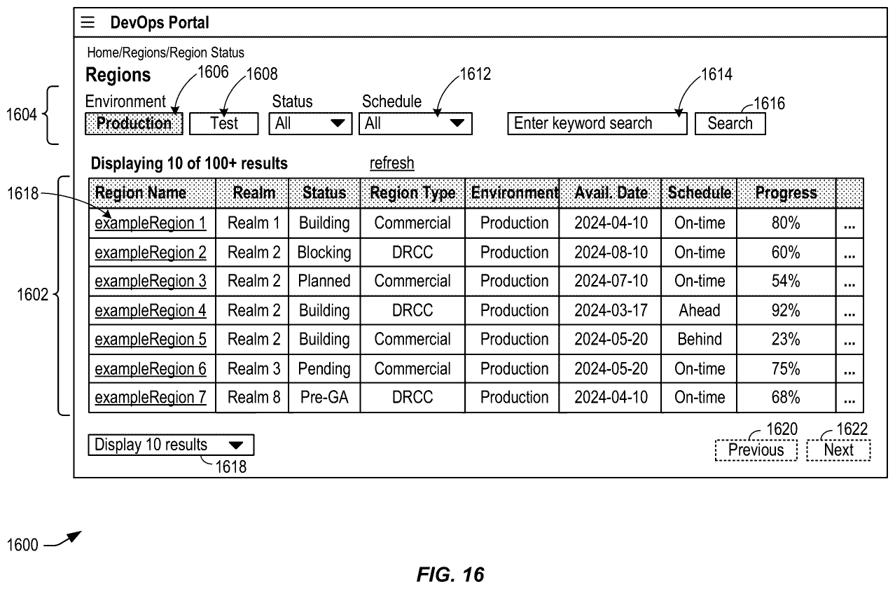

FIG. 16 is a schematic of an example user interface configured to present build status corresponding to one or more regions, in accordance with at least one embodiment. User interface 1600 may be an example of a user interface managed by the Orchestrator Control Plane 107 of FIGS. 1 and/or 1302 of FIG. 13.

User interface 1600 may be configured to present any suitable data corresponding to metadata that may include a progress or a state of one or more region builds (e.g., data center builds). In some embodiments, such metadata may be presented within area 1602 as depicted in FIG. 16. The metadata corresponding to a progress/state of a region build may include, but is not limited to, a region name, a realm identifier, a status (e.g., Building, Blocking, Planned, Pending, Pre-General-Availability (GA), or the like), a region type (e.g., Commercial, Dedicated Region at Customer Cloud (DRCC), etc.), an environment (e.g., production, test, etc.), a start date, an availability date, a schedule status (e.g., on-time, ahead, behind, etc.), and a progress indicator (e.g., a percentage indicating an amount of the build that has been successfully completed).

User interface 1600 may initially present metadata corresponding to all known region builds within area 1602. User interface 1600 may include one or more filter options within area 1604. By way of example, area 1604 may include filter options 1606-1614. Filter options 106 and 1608 may be used to filter the entries within area 1602 based on environment. When option 1606 is selected (as depicted in FIG. 16), the entries within area 1602 may be filtered to include entries that correspond to a production environment. When option 1608 is selected (as depicted in FIG. 16), the entries within area 1602 may be filtered to include entries that correspond to a test environment.

Filtering based on status may be performed using filter option 1610. Upon selecting filter option 1610 a drop-down box, popup window, or other suitable interface element may be presented within which a set of statuses may be selected. Upon selecting one or more statuses (or all, as depicted), the entries presented within area 1602 may be updated to include entries that match the selections made via filter option 1610.

Filtering based on scheduling may be performed using filter option 1612. Upon selecting filter option 1610 a drop-down box, popup window, or other suitable interface element may be presented within which a set of scheduling statuses may be selected. Upon selecting one or more scheduling statuses (“on-time,” “behind,” “ahead,” or “all,” as depicted), the entries presented within area 1602 may be updated to include entries that match the selections made via filter option 1612.

At any suitable time, user input may be provided via filter option 1614. Upon provided such input and selecting button 1616, the entries presented within area 1602 may be filtered to include only entries that match the user input provided via filter option 1614.

In some embodiments, filtering may be based on a combination of the selections and/or user input provided via the filter options of area 1604.

User interface 1600 may present any suitable data corresponding to any suitable number of regions within area 1602. In some embodiments, the area 1602 may be limited to presenting a default number of entries, each entry corresponding to a given region. Menu option 1618 may be utilized to modify the number of entries presented via area 1602. When the number of region entries exceeds the number of entries to be presented (as identified by option 1618), navigation options 1620 and/or 1622 may be provided to page forward (e.g., via the next option corresponding to navigation option 1622) or backward (e.g., via the previous option corresponding to navigation option 1620) through pages of entries.

In some embodiments, selecting a region (e.g., via selection of option 1618) may cause navigation to user interface 1700 described below.

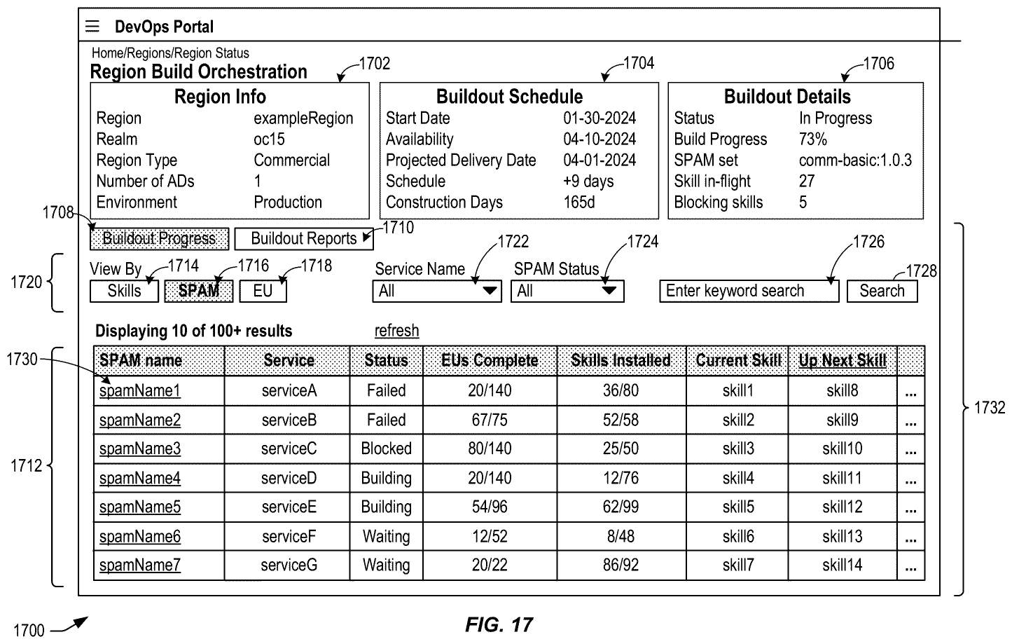

FIG. 17 is a schematic of an example user interface 1700 configured to present region build details corresponding to a single region, in accordance with at least one embodiment. User interface 1700 may be an example of a user interface managed by the Orchestrator Control Plane 107 of FIGS. 1 and/or 1302 of FIG. 13.

User interface 1700 may be configured to present any suitable data related to a region build. By way of example, area 1702 may present any suitable region build data such as a region name, a realm name, a region type, a number of availability domains, and an environment. Area 1704 may present any suitable data related to a buildout schedule such as a start date, an available date, a projected delivery date, a schedule assessment value (e.g., indicating a number of days ahead or behind schedule), and a total number of expected construction days. Area 1706 may be configured to present any suitable data related to status of a buildout such as a status value (e.g., “in progress”), a build progress (indicating a percentage of the build which has been successfully completed), a SPAM set used to generate the region build plan with which the region is being built, a number of skills in-flight/in-progress, and a number of blocking skills (e.g., skills which are blocking other skills from being published).

In some embodiments, options 1708 and 1710 may be available to select either buildout progress (e.g., via option 1708) or buildout reports (e.g., via option 1710). The selection of option 1708 or option 1710 may cause area 1712 to be updated to present corresponding data.

Options 1714-1718 provide a number of options to view data associated with a region build from the perspective of skills, SPAMs, or EUs, respectively. A selection of options 1714-1718 may cause area 1712 to be updated to present corresponding data. FIG. 17 depicts a selection of options 1708 and 1716.

Area 1720 may include additional filter options such as filter option 1722, filter option 1724, and filter option 1726. Filter option 1722 may be used to filter the data presented within area 1712 by service name. Filter option 1724 may be used to filter the data presented within area 1712 based at least in part on SPAM status. Filter option 1726 may be used to provide one or more keywords that, upon selecting button 1728, may be used to filter the data presented within area 1712 based at least in part on data that, at least in part, matches the input provided via filter option 1726.

As depicted, area 1712 includes any suitable number of entries, each entry corresponding to a given SPAM according to the selection of option 1716. In some embodiments, area 1712 may include any suitable data corresponding to SPAM execution state data structure 1204 of FIG. 12. For example, data corresponding to each entry may include a SPAM name, a service name, a SPAM status (e.g., failed, blocked, building, waiting, etc.), a number of EUs completed versus a total number of EUs expected to be completed during the service build corresponding to the given SPAM, a number of skills installed versus a total number of skills expected to be installed during the service build corresponding to the given SPAM, a current skill name, a next up skill name, or the like. Any suitable data depicted in area 1712, or described in connection to FIG. 17, may be stored in SPAM execution state data structure 1204. Although not depicted, area 1712 may present a current EU name and a next up EU name (e.g., an EU expected to be executed next in the sequence of predefined EUs).

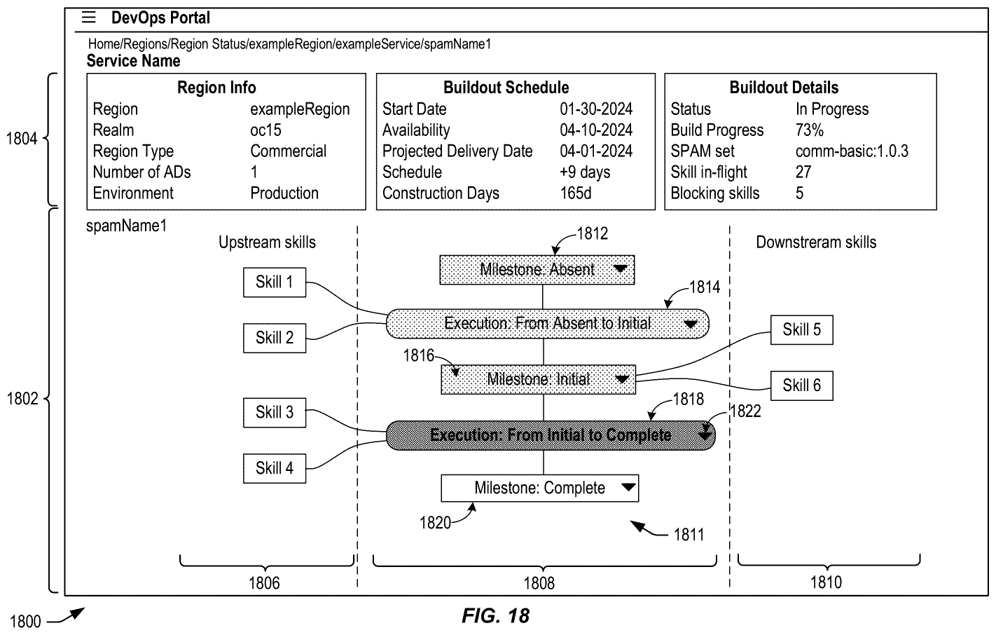

In some embodiments, selecting an option (e.g., option 1730) via user interface 1700 may cause navigation to user interface 1800 discussed below. In some embodiments, selecting option 1730 may cause area 1732 to be replaced with the data corresponding to area 1802 of FIG. 18.

FIG. 18 is a schematic of an example user interface 1800 configured to present details related to execution of a service build, in accordance with at least one embodiment. User interface 1900 may be an example of a user interface managed by the Orchestrator Control Plane 107 of FIGS. 1 and/or 1302 of FIG. 13.

In some embodiments, area 1802 may be an updated version of area 1732 after option 1730 has been selected. The data of area 1804 may substantially correspond to the data presented in areas 1702-1706 of FIG. 7.

Area 1802 may present any suitable data that is associated with the selected SPAM (e.g., spamName1). Area 1802 may present upstream skills data within area 1806, a directed acyclic graph within area 1808, and downstream skills data within area 1810. Upstream skills data presented within area 1806 may correspond to any suitable skills on which one or more execution units (e.g., each corresponding to an instance of execution unit entity 700 of FIG. 7) depend.

Area 1806 may include any suitable number of interface elements (e.g., interface element 1807) which may be selected. Once selected, additional metadata associated with that skill may be presented (e.g., in a popup window overlaid atop user interface 1800, via a separate user interface, or the like).

Area 1808 may include a directed acyclic graph 811 generated from the SPAM which includes any suitable number of nodes corresponding to build milestones (e.g., instances of the build milestone entity 600 of FIG. 6) or execution units (e.g., the execution unit entity 700 of FIG. 7). As depicted, area 1808 includes node 1812-1820, where nodes 1812, 1816, and 1820 correspond to build milestones absent, initial, and complete, respectively, and nodes 1814 and 1818 correspond to EUs that transition between two build milestones. By way of example, node 1814 corresponds to an EU that defines a transition between build milestone absent and build milestone initial. Node 1818 may correspond to an EU that defines a transition between build milestone initial and build milestone complete. Each of the nodes 1812-1820 may be expanded via selection of a corresponding option (e.g., option 1822) to view additional metadata associated with the node. The nodes 1812-1820 may individually be colored or shaded to indicate a status. By way of example, nodes 1812-1816 may be colored to indicate successful execution of the milestone and/or the execution unit. Node 1818 may be colored to indicate that at least one release associated with the execution unit has failed (or otherwise halted). In some embodiments, option 1822 may be expanded to view details related to each release corresponding to the execution unit represented by node 1818. In some embodiments, each release may be presented with a corresponding status or metadata to indicate a status of the release. In some embodiments, release status may include any suitable data corresponding to release execution state data structure 1206 of FIG. 12.

In some embodiments, if option 1822 is selected, the node 1818 may be expanded to present any suitable number of steps, some of which may correspond to a respective release. In some embodiments, these steps may be similarly colored where the color represents a step status (e.g., successful, pending, failed). While directed acyclic graph 1811 provides the user a representation of a service build from a high level of granularity, but options to selectively view finer granularity data through expanding the nodes. In this manner, a user may quickly and easily ascertain a source of failure, by execution unit and, if desired, down to the exact step/release.

Area 1810 may be configured to present any suitable data corresponding to downstream skills. Downstream skills refer to skills that depend on the skills published through executing the releases associated with an execution unit and/or through transitioning to a particular build milestone. As depicted, skills 5 and 6 depend on the skills associated with build milestone initial. Said another way, skills 5 and 6 depend on the particular skills published when transition to build milestone initial is complete.

FIG. 19 is a flow diagram depicting an example method 1900 for tracking regional orchestrator operations associated with performing a region build, according to at least one embodiment. The method 1900 may be performed by any suitable combination of the Orchestrator Control Plane 107 of FIG. 1 and/or the Regional Orchestrator 106 of FIG. 1. More or fewer operations may be included in the method 1900 and these operations may be performed in any suitable order.

The method 1900 may begin at 1902, where a plurality of regional orchestrators are provided. In some embodiments, each regional orchestrator (e.g., region orchestrator 106 of FIG. 1, a region orchestrator of region orchestrator(s) 1304) of the plurality of regional orchestrators execute in an isolated hosting environment (e.g., one of service cell(s) 109 of FIG. 1).

At 1904, a build plan (e.g., region build plan 338 of FIG. 3, region build plan 1318 of FIG. 3) for bootstrapping a plurality of services within a data center may be generated (e.g., by the orchestrator control plane 107 of FIG. 1 of the cloud infrastructure orchestration system such as CIOS 102 of FIG. 1). In some embodiments, the build plan may be generated based at least in part on a service build definition (e.g., service build definition 400 of FIG. 4). of a plurality of service build definitions. The service build definition may specify (e.g., via build milestones, execution units, and flock configs similar to build milestone entity 600 of FIG. 6, execution unit entity 700 of FIG. 7, and flock config entity 800 of FIG. 8), a deterministic process for bootstrapping a service of the plurality of services.

At 1906, a regional orchestrator (e.g., region orchestrator 106 of FIG. 1, a region orchestrator of region orchestrator(s) 1304) of the cloud infrastructure orchestration system (e.g., CIOS 102 of FIG. 1) may be instructed (e.g., by the orchestrator control plane 107 of FIG. 1, the orchestrator control plane 1302 of FIG. 13, etc.) to initiate bootstrapping of the plurality of service according to the build plan.

At 1908, a state (e.g., SPAM execution state corresponding to SPAM execution state data structure 1204 of FIG. 12, release execution state corresponding to release execution state data structure 1206 of FIG. 12, track state corresponding to track state data structure 1208 of FIG. 12, step state corresponding to step state data structure 1210 of FIG. 12, etc.) associated with the bootstrapping of the plurality of services by the regional orchestrator of the cloud infrastructure orchestration system may be tracked (e.g., by the orchestrator control plane 107, the orchestrator control plane 1302, etc.). Any suitable data corresponding to the tracked state may be presented via one or more user interface (e.g., the user interfaces 1600-1800 of FIGS. 16-18).

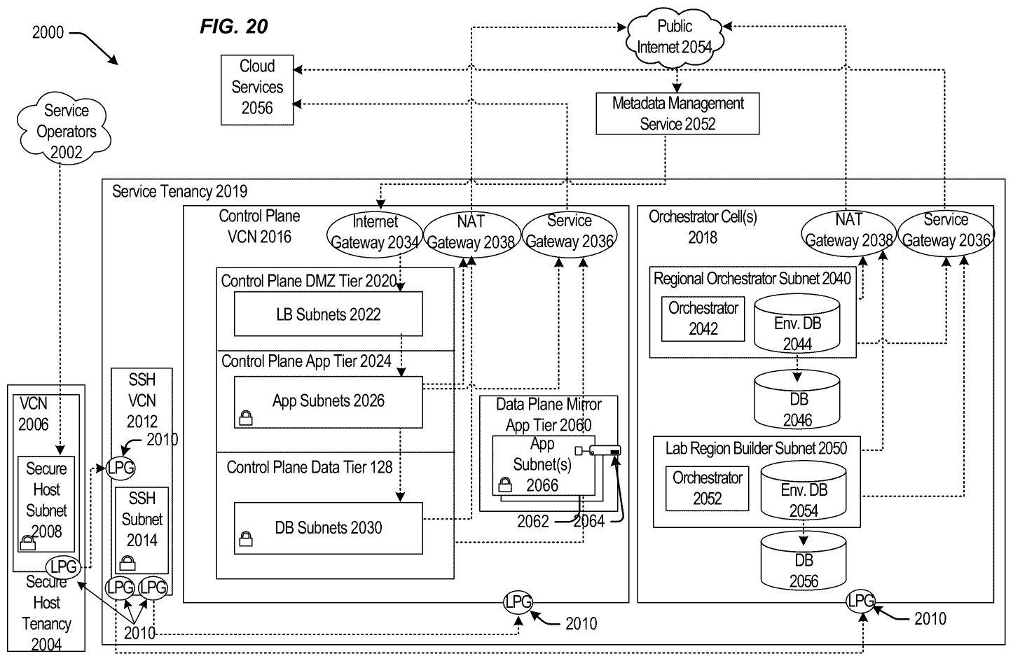

FIG. 20 is a block diagram illustrating an example IaaS architecture for region build orchestration service, according to at least one embodiment. Service operators 2002 can be communicatively coupled to a secure host tenancy 2004 that can include a virtual cloud network (VCN) 2006 and a secure host subnet 2008. In some examples, the service operators 2002 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 2006 and/or the Internet.

The VCN 2006 can include a local peering gateway (LPG) 2010 that can be communicatively coupled to a secure shell (SSH) VCN 2012 via an LPG 2010 contained in the SSH VCN 2012. The SSH VCN 2012 can include an SSH subnet 2014, and the SSH VCN 2012 can be communicatively coupled to a control plane VCN 2016 via the LPG 2010 contained in the control plane VCN 2016. Also, the SSH VCN 2012 can be communicatively coupled to a data plane VCN 2018 via an LPG 2010. The control plane VCN 2016 and the data plane VCN 2018 can be contained in a service tenancy 2019 that can be owned and/or operated by the IaaS provider.

The control plane VCN 2016 can include a control plane demilitarized zone (DMZ) tier 2020 that acts as a perimeter network (e.g., portions of a corporate network between the corporate intranet and external networks). The DMZ-based servers may have restricted responsibilities and help keep breaches contained. Additionally, the DMZ tier 2020 can include one or more load balancer (LB) subnet(s) 2022, a control plane app tier 2024 that can include app subnet(s) 2026, a control plane data tier 2028 that can include database (DB) subnet(s) 2030 (e.g., frontend DB subnet(s) and/or backend DB subnet(s)). The Orchestrator Control Plane 107 of FIG. 1 may operate as part of app subnet(s) 2026. The LB subnet(s) 2022 contained in the control plane DMZ tier 2020 can be communicatively coupled to the app subnet(s) 2026 contained in the control plane app tier 2024 and an Internet gateway 2034 that can be contained in the control plane VCN 2016, and the app subnet(s) 2026 can be communicatively coupled to the DB subnet(s) 2030 contained in the control plane data tier 2028 and a service gateway 2036 and a network address translation (NAT) gateway 2038. The control plane VCN 2016 can include the service gateway 2036 and the NAT gateway 2038.

Multiple orchestrator cells (e.g., orchestrator cell(s) 2018, each an example of a service cell that isolated from each other) can include regional orchestrator subnet 2040 and lab region build subnet 2050 that can be communicatively coupled to the NAT gateway 2038 and the service gateway 2036.

The Internet gateway 2034 of the control plane VCN 2016 can be communicatively coupled to a metadata management service 2052 that can be communicatively coupled to public Internet 2054. Public Internet 2054 can be communicatively coupled to the NAT gateway 2038 of the control plane VCN 2016 and of the NAT gateway 2038 of an orchestrator cell. The service gateway 2036 of the control plane VCN 2016 and the service gateway 2036 can be communicatively coupled to cloud services 2056.

In some examples, the service gateway 2036 of the control plane VCN 2016 or the service gateway 2036 can make application programming interface (API) calls to cloud services 2056 without going through public Internet 2054. The API calls to cloud services 2056 from the service gateway 2036 can be one-way: the service gateway 2036 can make API calls to cloud services 2056, and cloud services 2056 can send requested data to the service gateway 2036. But, cloud services 2056 may not initiate API calls to the service gateway 2036.

In some examples, the secure host tenancy 2004 can be directly connected to the service tenancy 2019, which may be otherwise isolated. The secure host subnet 2008 can communicate with the SSH subnet 2014 through an LPG 2010 that may enable two-way communication over an otherwise isolated system. Connecting the secure host subnet 2008 to the SSH subnet 2014 may give the secure host subnet 2008 access to other entities within the service tenancy 2019.

The control plane VCN 2016 may allow users of the service tenancy 2019 to set up or otherwise provision desired resources. Desired resources provisioned in the control plane VCN 2016 may be deployed or otherwise used in the regions build using orchestrator 2042 of regional orchestrator subnet 2040. In some examples, the control plane VCN 2016 can be isolated from the orchestrator cell(s) 2018. The orchestrators 2042 and 2052 may individually be an example of the regional orchestrator 106 of FIG. 1. Lab region build subnet 2050 may be an isolated environment in which SPAMs may be tested. Each orchestrator (e.g., orchestrator 2042 and/or 2052) may access a scheme via an environment database (e.g., env. DB 2044 and 2054, respectively). DB 2046 may be a single database viewable by all orchestrators across all orchestration cells. Similarly, D B 2056 may be viewable by env. DB 2054. Databases 2046 and 2056 may be configured to store a current-state-of-the-world view (progress against a goal) for each region build planned, performed, or in the process of being performed by an orchestrator (e.g., orchestrator 2040 and orchestrator 2050, respectively). Env. DB 2044 and 2054 may be configured to store a current-state-of-the-world view including any suitable data corresponding to a particular region build (e.g., a region build that is associated with a single region).

In some examples, users of the system, or customers, can make requests, for example create, read, update, or delete (CRUD) operations, through public Internet 2054 that can communicate the requests to the metadata management service 2052. The metadata management service 2052 can communicate the request to the control plane VCN 2016 through the Internet gateway 2034. The request can be received by the LB subnet(s) 2022 contained in the control plane DMZ tier 2020. The LB subnet(s) 2022 may determine that the request is valid, and in response to this determination, the LB subnet(s) 2022 can transmit the request to app subnet(s) 2026 contained in the control plane app tier 2024. If the request is validated and requires a call to public Internet 2054, the call to public Internet 2054 may be transmitted to the NAT gateway 2038 that can make the call to public Internet 2054. Metadata that may be desired to be stored by the request can be stored in the DB subnet(s) 2030.

In some examples, the data plane mirror app tier 2060 can facilitate direct communication between the control plane VCN 2016 and the orchestrator cell(s) 2018. For example, changes, updates, or other suitable modifications to configuration may be desired to be applied to the resources contained in the data plane VCN managed by the orchestrator 2042. Via a VNIC 2062, the control plane VCN 2016 can directly communicate with, and can thereby execute the changes, updates, or other suitable modifications to configuration to, resources contained in the data plane VCN managed by orchestrator 2042.

In some embodiments, the control plane VCN 2016 and the data plane VCN managed by orchestrator 2042 can be contained in the service tenancy 2019. In this case, the user, or the customer, of the system may not own or operate either the control plane VCN 2016 or the data plane VCN. Instead, the IaaS provider may own or operate the control plane VCN 2016 and the data plane VCN, both of which may be contained in the service tenancy 2019. This embodiment can enable isolation of networks that may prevent users or customers from interacting with other users', or other customers', resources. Also, this embodiment may allow users or customers of the system to store databases privately without needing to rely on public Internet 2054, which may not have a desired level of threat prevention, for storage.

In other embodiments, the LB subnet(s) 2022 contained in the control plane VCN 2016 can be configured to receive a signal from the service gateway 2036. In this embodiment, the control plane VCN 2016 and the data plane VCN managed by the orchestrator 2042 may be configured to be called by a customer of the IaaS provider without calling public Internet 2054. Customers of the IaaS provider may desire this embodiment since database(s) that the customers use may be controlled by the IaaS provider and may be stored on the service tenancy 2019, which may be isolated from public Internet 2054.

### Example Cloud Service Infrastructure Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 21 is a block diagram 2100 illustrating an example pattern of an IaaS architecture, according to at least one embodiment. Service operators 2102 can be communicatively coupled to a secure host tenancy 2104 that can include a virtual cloud network (VCN) 2106 and a secure host subnet 2108. In some examples, the service operators 2102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 2106 and/or the Internet.

The VCN 2106 can include a local peering gateway (LPG) 2110 that can be communicatively coupled to a secure shell (SSH) VCN 2112 via an LPG 2110 contained in the SSH VCN 2112. The SSH VCN 2112 can include an SSH subnet 2114, and the SSH VCN 2112 can be communicatively coupled to a control plane VCN 2116 via the LPG 2110 contained in the control plane VCN 2116. Also, the SSH VCN 2112 can be communicatively coupled to a data plane VCN 2118 via an LPG 2110. The control plane VCN 2116 and the data plane VCN 2118 can be contained in a service tenancy 2119 that can be owned and/or operated by the IaaS provider.

The control plane VCN 2116 can include a control plane demilitarized zone (DMZ) tier 2120 that acts as a perimeter network (e.g., portions of a corporate network between the corporate intranet and external networks). The DMZ-based servers may have restricted responsibilities and help keep breaches contained. Additionally, the DMZ tier 2120 can include one or more load balancer (LB) subnet(s) 2122, a control plane app tier 2124 that can include app subnet(s) 2126, a control plane data tier 2128 that can include database (DB) subnet(s) 2130 (e.g., frontend DB subnet(s) and/or backend DB subnet(s)). The LB subnet(s) 2122 contained in the control plane DMZ tier 2120 can be communicatively coupled to the app subnet(s) 2126 contained in the control plane app tier 2124 and an Internet gateway 2134 that can be contained in the control plane VCN 2116, and the app subnet(s) 2126 can be communicatively coupled to the DB subnet(s) 2130 contained in the control plane data tier 2128 and a service gateway 2136 and a network address translation (NAT) gateway 2138. The control plane VCN 2116 can include the service gateway 2136 and the NAT gateway 2138.

The control plane VCN 2116 can include a data plane mirror app tier 2140 that can include app subnet(s) 2126. The app subnet(s) 2126 contained in the data plane mirror app tier 2140 can include a virtual network interface controller (VNIC) 2142 that can execute a compute instance 2144. The compute instance 2144 can communicatively couple the app subnet(s) 2126 of the data plane mirror app tier 2140 to app subnet(s) 2126 that can be contained in a data plane app tier 2146.

The data plane VCN 2118 can include the data plane app tier 2146, a data plane DMZ tier 2148, and a data plane data tier 2150. The data plane DMZ tier 2148 can include LB subnet(s) 2122 that can be communicatively coupled to the app subnet(s) 2126 of the data plane app tier 2146 and the Internet gateway 2134 of the data plane VCN 2118. The app subnet(s) 2126 can be communicatively coupled to the service gateway 2136 of the data plane VCN 2118 and the NAT gateway 2138 of the data plane VCN 2118. The data plane data tier 2150 can also include the DB subnet(s) 2130 that can be communicatively coupled to the app subnet(s) 2126 of the data plane app tier 2146.

The Internet gateway 2134 of the control plane VCN 2116 and of the data plane VCN 2118 can be communicatively coupled to a metadata management service 2152 that can be communicatively coupled to public Internet 2154. Public Internet 2154 can be communicatively coupled to the NAT gateway 2138 of the control plane VCN 2116 and of the data plane VCN 2118. The service gateway 2136 of the control plane VCN 2116 and of the data plane VCN 2118 can be communicatively coupled to cloud services 2156.

In some examples, the service gateway 2136 of the control plane VCN 2116 or of the data plane VCN 2118 can make application programming interface (API) calls to cloud services 2156 without going through public Internet 2154. The API calls to cloud services 2156 from the service gateway 2136 can be one-way: the service gateway 2136 can make API calls to cloud services 2156, and cloud services 2156 can send requested data to the service gateway 2136. But, cloud services 2156 may not initiate API calls to the service gateway 2136.

In some examples, the secure host tenancy 2104 can be directly connected to the service tenancy 2119, which may be otherwise isolated. The secure host subnet 2108 can communicate with the SSH subnet 2114 through an LPG 2110 that may enable two-way communication over an otherwise isolated system. Connecting the secure host subnet 2108 to the SSH subnet 2114 may give the secure host subnet 2108 access to other entities within the service tenancy 2119.

The control plane VCN 2116 may allow users of the service tenancy 2119 to set up or otherwise provision desired resources. Desired resources provisioned in the control plane VCN 2116 may be deployed or otherwise used in the data plane VCN 2118. In some examples, the control plane VCN 2116 can be isolated from the data plane VCN 2118, and the data plane mirror app tier 2140 of the control plane VCN 2116 can communicate with the data plane app tier 2146 of the data plane VCN 2118 via VNICs 2142 that can be contained in the data plane mirror app tier 2140 and the data plane app tier 2146.

In some examples, users of the system, or customers, can make requests, for example create, read, update, or delete (CRUD) operations, through public Internet 2154 that can communicate the requests to the metadata management service 2152. The metadata management service 2152 can communicate the request to the control plane VCN 2116 through the Internet gateway 2134. The request can be received by the LB subnet(s) 2122 contained in the control plane DMZ tier 2120. The LB subnet(s) 2122 may determine that the request is valid, and in response to this determination, the LB subnet(s) 2122 can transmit the request to app subnet(s) 2126 contained in the control plane app tier 2124. If the request is validated and requires a call to public Internet 2154, the call to public Internet 2154 may be transmitted to the NAT gateway 2138 that can make the call to public Internet 2154. Metadata that may be desired to be stored by the request can be stored in the DB subnet(s) 2130.

In some examples, the data plane mirror app tier 2140 can facilitate direct communication between the control plane VCN 2116 and the data plane VCN 2118. For example, changes, updates, or other suitable modifications to configuration may be desired to be applied to the resources contained in the data plane VCN 2118. Via a VNIC 2142, the control plane VCN 2116 can directly communicate with, and can thereby execute the changes, updates, or other suitable modifications to configuration to, resources contained in the data plane VCN 2118.

In some embodiments, the control plane VCN 2116 and the data plane VCN 2118 can be contained in the service tenancy 2119. In this case, the user, or the customer, of the system may not own or operate either the control plane VCN 2116 or the data plane VCN 2118. Instead, the IaaS provider may own or operate the control plane VCN 2116 and the data plane VCN 2118, both of which may be contained in the service tenancy 2119. This embodiment can enable isolation of networks that may prevent users or customers from interacting with other users', or other customers', resources. Also, this embodiment may allow users or customers of the system to store databases privately without needing to rely on public Internet 2154, which may not have a desired level of threat prevention, for storage.

In other embodiments, the LB subnet(s) 2122 contained in the control plane VCN 2116 can be configured to receive a signal from the service gateway 2136. In this embodiment, the control plane VCN 2116 and the data plane VCN 2118 may be configured to be called by a customer of the IaaS provider without calling public Internet 2154. Customers of the IaaS provider may desire this embodiment since database(s) that the customers use may be controlled by the IaaS provider and may be stored on the service tenancy 2119, which may be isolated from public Internet 2154.

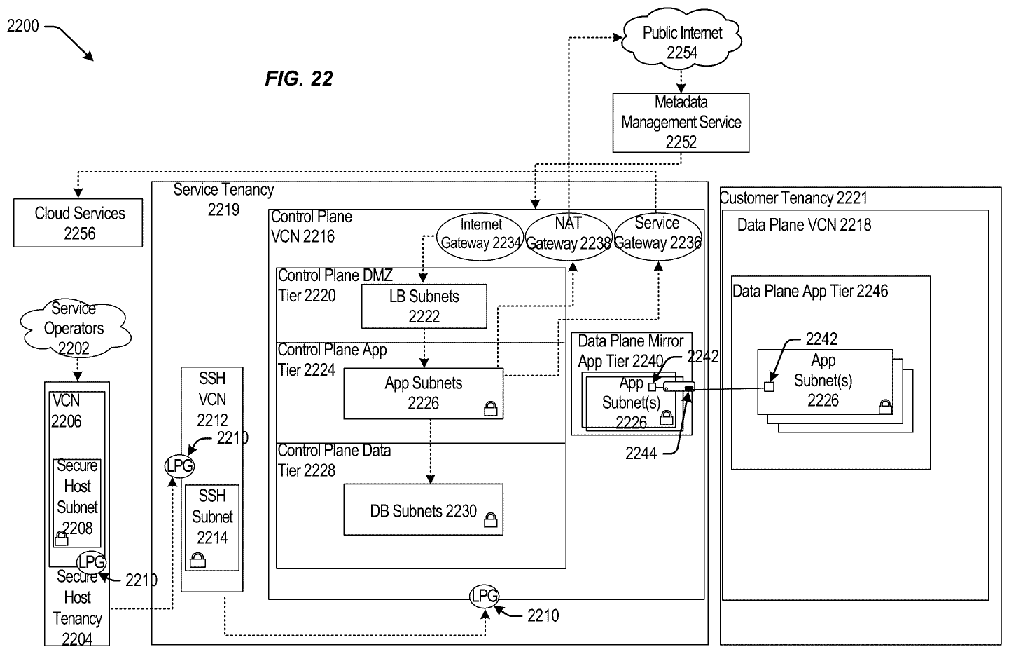

FIG. 22 is a block diagram 2200 illustrating another example pattern of an IaaS architecture, according to at least one embodiment. Service operators 2202 (e.g., service operators 2102 of FIG. 21) can be communicatively coupled to a secure host tenancy 2204 (e.g., the secure host tenancy 2104 of FIG. 21) that can include a virtual cloud network (VCN) 2206 (e.g., the VCN 2106 of FIG. 21) and a secure host subnet 2208 (e.g., the secure host subnet 2108 of FIG. 21). The VCN 2206 can include a local peering gateway (LPG) 2210 (e.g., the LPG 2110 of FIG. 21) that can be communicatively coupled to a secure shell (SSH) VCN 2212 (e.g., the SSH VCN 2112 of FIG. 21) via an LPG 2110 contained in the SSH VCN 2212. The SSH VCN 2212 can include an SSH subnet 2214 (e.g., the SSH subnet 2114 of FIG. 21), and the SSH VCN 2212 can be communicatively coupled to a control plane VCN 2216 (e.g., the control plane VCN 2116 of FIG. 21) via an LPG 2210 contained in the control plane VCN 2216. The control plane VCN 2216 can be contained in a service tenancy 2219 (e.g., the service tenancy 2119 of FIG. 21), and the data plane VCN 2218 (e.g., the data plane VCN 2118 of FIG. 21) can be contained in a customer tenancy 2221 that may be owned or operated by users, or customers, of the system.

The control plane VCN 2216 can include a control plane DMZ tier 2220 (e.g., the control plane DMZ tier 2120 of FIG. 21) that can include LB subnet(s) 2222 (e.g., LB subnet(s) 2122 of FIG. 21), a control plane app tier 2224 (e.g., the control plane app tier 2124 of FIG. 21) that can include app subnet(s) 2226 (e.g., app subnet(s) 2126 of FIG. 21), a control plane data tier 2228 (e.g., the control plane data tier 2128 of FIG. 21) that can include database (DB) subnet(s) 2230 (e.g., similar to DB subnet(s) 2130 of FIG. 21). The LB subnet(s) 2222 contained in the control plane DMZ tier 2220 can be communicatively coupled to the app subnet(s) 2226 contained in the control plane app tier 2224 and an Internet gateway 2234 (e.g., the Internet gateway 2134 of FIG. 21) that can be contained in the control plane VCN 2216, and the app subnet(s) 2226 can be communicatively coupled to the DB subnet(s) 2230 contained in the control plane data tier 2228 and a service gateway 2236 (e.g., the service gateway 2136 of FIG. 21) and a network address translation (NAT) gateway 2238 (e.g., the NAT gateway 2138 of FIG. 21). The control plane VCN 2216 can include the service gateway 2236 and the NAT gateway 2238.

The control plane VCN 2216 can include a data plane mirror app tier 2240 (e.g., the data plane mirror app tier 2140 of FIG. 21) that can include app subnet(s) 2226. The app subnet(s) 2226 contained in the data plane mirror app tier 2240 can include a virtual network interface controller (VNIC) 2242 (e.g., the VNIC of 2142) that can execute a compute instance 2244 (e.g., similar to the compute instance 2144 of FIG. 21). The compute instance 2244 can facilitate communication between the app subnet(s) 2226 of the data plane mirror app tier 2240 and the app subnet(s) 2226 that can be contained in a data plane app tier 2246 (e.g., the data plane app tier 2146 of FIG. 21) via the VNIC 2242 contained in the data plane mirror app tier 2240 and the VNIC 2242 contained in the data plane app tier 2246.

The Internet gateway 2234 contained in the control plane VCN 2216 can be communicatively coupled to a metadata management service 2252 (e.g., the metadata management service 2152 of FIG. 21) that can be communicatively coupled to public Internet 2254 (e.g., public Internet 2154 of FIG. 21). Public Internet 2254 can be communicatively coupled to the NAT gateway 2238 contained in the control plane VCN 2216. The service gateway 2236 contained in the control plane VCN 2216 can be communicatively coupled to cloud services 2256 (e.g., cloud services 2156 of FIG. 21).

In some examples, the data plane VCN 2218 can be contained in the customer tenancy 2221. In this case, the IaaS provider may provide the control plane VCN 2216 for each customer, and the IaaS provider may, for each customer, set up a unique compute instance 2244 that is contained in the service tenancy 2219. Each compute instance 2244 may allow communication between the control plane VCN 2216, contained in the service tenancy 2219, and the data plane VCN 2218 that is contained in the customer tenancy 2221. The compute instance 2244 may allow resources, that are provisioned in the control plane VCN 2216 that is contained in the service tenancy 2219, to be deployed or otherwise used in the data plane VCN 2218 that is contained in the customer tenancy 2221.

In other examples, the customer of the IaaS provider may have databases that live in the customer tenancy 2221. In this example, the control plane VCN 2216 can include the data plane mirror app tier 2240 that can include app subnet(s) 2226. The data plane mirror app tier 2240 can reside in the data plane VCN 2218, but the data plane mirror app tier 2240 may not live in the data plane VCN 2218. That is, the data plane mirror app tier 2240 may have access to the customer tenancy 2221, but the data plane mirror app tier 2240 may not exist in the data plane VCN 2218 or be owned or operated by the customer of the IaaS provider. The data plane mirror app tier 2240 may be configured to make calls to the data plane VCN 2218 but may not be configured to make calls to any entity contained in the control plane VCN 2216. The customer may desire to deploy or otherwise use resources in the data plane VCN 2218 that are provisioned in the control plane VCN 2216, and the data plane mirror app tier 2240 can facilitate the desired deployment, or other usage of resources, of the customer.

In some embodiments, the customer of the IaaS provider can apply filters to the data plane VCN 2218. In this embodiment, the customer can determine what the data plane VCN 2218 can access, and the customer may restrict access to public Internet 2254 from the data plane VCN 2218. The IaaS provider may not be able to apply filters or otherwise control access of the data plane VCN 2218 to any outside networks or databases. Applying filters and controls by the customer onto the data plane VCN 2218, contained in the customer tenancy 2221, can help isolate the data plane VCN 2218 from other customers and from public Internet 2254.

In some embodiments, cloud services 2256 can be called by the service gateway 2236 to access services that may not exist on public Internet 2254, on the control plane VCN 2216, or on the data plane VCN 2218. The connection between cloud services 2256 and the control plane VCN 2216 or the data plane VCN 2218 may not be live or continuous. Cloud services 2256 may exist on a different network owned or operated by the IaaS provider. Cloud services 2256 may be configured to receive calls from the service gateway 2236 and may be configured to not receive calls from public Internet 2254. Some cloud services 2256 may be isolated from other cloud services 2256, and the control plane VCN 2216 may be isolated from cloud services 2256 that may not be in the same region as the control plane VCN 2216. For example, the control plane VCN 2216 may be located in “Region 1,” and cloud service “Deployment 21,” may be located in Region 1 and in “Region 2.” If a call to Deployment 21 is made by the service gateway 2236 contained in the control plane VCN 2216 located in Region 1, the call may be transmitted to Deployment 21 in Region 1. In this example, the control plane VCN 2216, or Deployment 21 in Region 1, may not be communicatively coupled to, or otherwise in communication with, Deployment 21 in Region 2.

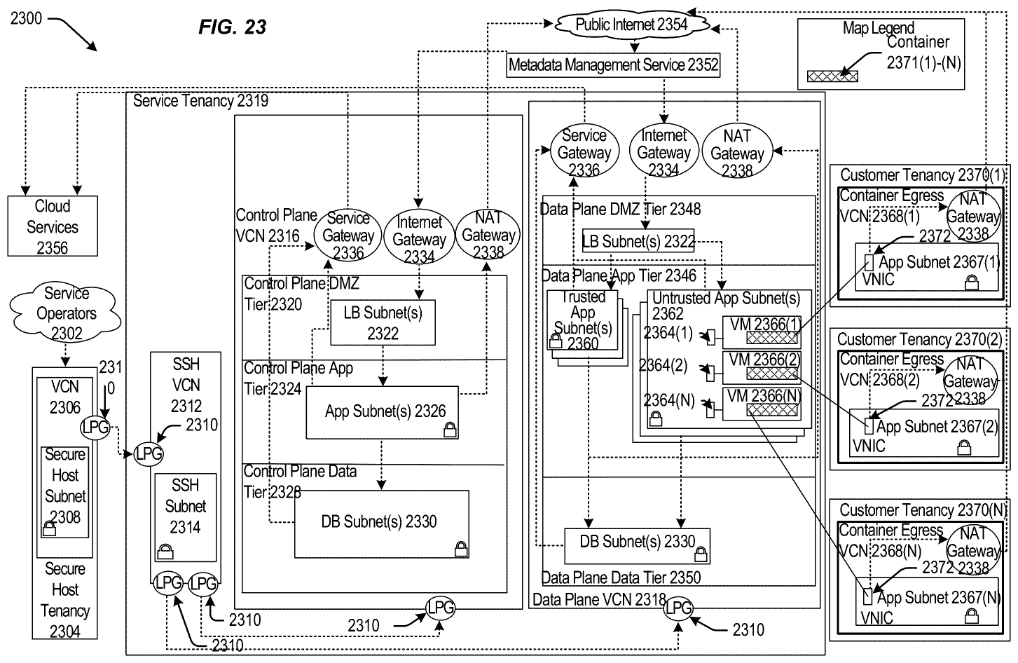

FIG. 23 is a block diagram 2300 illustrating another example pattern of an IaaS architecture, according to at least one embodiment. Service operators 2302 (e.g., service operators 2102 of FIG. 21) can be communicatively coupled to a secure host tenancy 2304 (e.g., the secure host tenancy 2104 of FIG. 21) that can include a virtual cloud network (VCN) 2306 (e.g., the VCN 2106 of FIG. 21) and a secure host subnet 2308 (e.g., the secure host subnet 2108 of FIG. 21). The VCN 2306 can include an LPG 2310 (e.g., the LPG 2110 of FIG. 21) that can be communicatively coupled to an SSH VCN 2312 (e.g., the SSH VCN 2112 of FIG. 21) via an LPG 2310 contained in the SSH VCN 2312. The SSH VCN 2312 can include an SSH subnet 2314 (e.g., the SSH subnet 2114 of FIG. 21), and the SSH VCN 2312 can be communicatively coupled to a control plane VCN 2316 (e.g., the control plane VCN 2116 of FIG. 21) via an LPG 2310 contained in the control plane VCN 2316 and to a data plane VCN 2318 (e.g., the data plane 2118 of FIG. 21) via an LPG 2310 contained in the data plane VCN 2318. The control plane VCN 2316 and the data plane VCN 2318 can be contained in a service tenancy 2319 (e.g., the service tenancy 2119 of FIG. 21).

The control plane VCN 2316 can include a control plane DMZ tier 2320 (e.g., the control plane DMZ tier 2120 of FIG. 21) that can include load balancer (LB) subnet(s) 2322 (e.g., LB subnet(s) 2122 of FIG. 21), a control plane app tier 2324 (e.g., the control plane app tier 2124 of FIG. 21) that can include app subnet(s) 2326 (e.g., similar to app subnet(s) 2126 of FIG. 21), a control plane data tier 2328 (e.g., the control plane data tier 2128 of FIG. 21) that can include DB subnet(s) 2330. The LB subnet(s) 2322 contained in the control plane DMZ tier 2320 can be communicatively coupled to the app subnet(s) 2326 contained in the control plane app tier 2324 and to an Internet gateway 2334 (e.g., the Internet gateway 2134 of FIG. 21) that can be contained in the control plane VCN 2316, and the app subnet(s) 2326 can be communicatively coupled to the DB subnet(s) 2330 contained in the control plane data tier 2328 and to a service gateway 2336 (e.g., the service gateway of FIG. 21) and a network address translation (NAT) gateway 2338 (e.g., the NAT gateway 2138 of FIG. 21). The control plane VCN 2316 can include the service gateway 2336 and the NAT gateway 2338.

The data plane VCN 2318 can include a data plane app tier 2346 (e.g., the data plane app tier 2146 of FIG. 21), a data plane DMZ tier 2348 (e.g., the data plane DMZ tier 2148 of FIG. 21), and a data plane data tier 2350 (e.g., the data plane data tier 2150 of FIG. 21). The data plane DMZ tier 2348 can include LB subnet(s) 2322 that can be communicatively coupled to trusted app subnet(s) 2360 and untrusted app subnet(s) 2362 of the data plane app tier 2346 and the Internet gateway 2334 contained in the data plane VCN 2318. The trusted app subnet(s) 2360 can be communicatively coupled to the service gateway 2336 contained in the data plane VCN 2318, the NAT gateway 2338 contained in the data plane VCN 2318, and DB subnet(s) 2330 contained in the data plane data tier 2350. The untrusted app subnet(s) 2362 can be communicatively coupled to the service gateway 2336 contained in the data plane VCN 2318 and DB subnet(s) 2330 contained in the data plane data tier 2350. The data plane data tier 2350 can include DB subnet(s) 2330 that can be communicatively coupled to the service gateway 2336 contained in the data plane VCN 2318.

The untrusted app subnet(s) 2362 can include one or more primary VNICs 2364(1)-(N) that can be communicatively coupled to tenant virtual machines (VMs) 2366(1)-(N). Each tenant VM 2366(1)-(N) can be communicatively coupled to a respective app subnet 2367(1)-(N) that can be contained in respective container egress VCNs 2368(1)-(N) that can be contained in respective customer tenancies 2370(1)-(N). Respective secondary VNICs 2372(1)-(N) can facilitate communication between the untrusted app subnet(s) 2362 contained in the data plane VCN 2318 and the app subnet contained in the container egress VCNs 2368(1)-(N). Each container egress VCNs 2368(1)-(N) can include a NAT gateway 2338 that can be communicatively coupled to public Internet 2354 (e.g., public Internet 2154 of FIG. 21).

The Internet gateway 2334 contained in the control plane VCN 2316 and contained in the data plane VCN 2318 can be communicatively coupled to a metadata management service 2352 (e.g., the metadata management system 2152 of FIG. 21) that can be communicatively coupled to public Internet 2354. Public Internet 2354 can be communicatively coupled to the NAT gateway 2338 contained in the control plane VCN 2316 and contained in the data plane VCN 2318. The service gateway 2336 contained in the control plane VCN 2316 and contained in the data plane VCN 2318 can be communicatively coupled to cloud services 2356.

In some embodiments, the data plane VCN 2318 can be integrated with customer tenancies 2370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 2346. Code to run the function may be executed in the VMs 2366(1)-(N), and the code may not be configured to run anywhere else on the data plane VCN 2318. Each VM 2366(1)-(N) may be connected to one customer tenancy 2370. Respective containers 2371(1)-(N) contained in the VMs 2366(1)-(N) may be configured to run the code. In this case, there can be a dual isolation (e.g., the containers 2371(1)-(N) running code, where the containers 2371(1)-(N) may be contained in at least the VM 2366(1)-(N) that are contained in the untrusted app subnet(s) 2362), which may help prevent incorrect or otherwise undesirable code from damaging the network of the IaaS provider or from damaging a network of a different customer. The containers 2371(1)-(N) may be communicatively coupled to the customer tenancy 2370 and may be configured to transmit or receive data from the customer tenancy 2370. The containers 2371(1)-(N) may not be configured to transmit or receive data from any other entity in the data plane VCN 2318. Upon completion of running the code, the IaaS provider may kill or otherwise dispose of the containers 2371(1)-(N).

In some embodiments, the trusted app subnet(s) 2360 may run code that may be owned or operated by the IaaS provider. In this embodiment, the trusted app subnet(s) 2360 may be communicatively coupled to the DB subnet(s) 2330 and be configured to execute CRUD operations in the DB subnet(s) 2330. The untrusted app subnet(s) 2362 may be communicatively coupled to the DB subnet(s) 2330, but in this embodiment, the untrusted app subnet(s) may be configured to execute read operations in the DB subnet(s) 2330. The containers 2371(1)-(N) that can be contained in the VM 2366(1)-(N) of each customer and that may run code from the customer may not be communicatively coupled with the DB subnet(s) 2330.

In other embodiments, the control plane VCN 2316 and the data plane VCN 2318 may not be directly communicatively coupled. In this embodiment, there may be no direct communication between the control plane VCN 2316 and the data plane VCN 2318. However, communication can occur indirectly through at least one method. An LPG 2310 may be established by the IaaS provider that can facilitate communication between the control plane VCN 2316 and the data plane VCN 2318. In another example, the control plane VCN 2316 or the data plane VCN 2318 can make a call to cloud services 2356 via the service gateway 2336. For example, a call to cloud services 2356 from the control plane VCN 2316 can include a request for a service that can communicate with the data plane VCN 2318.

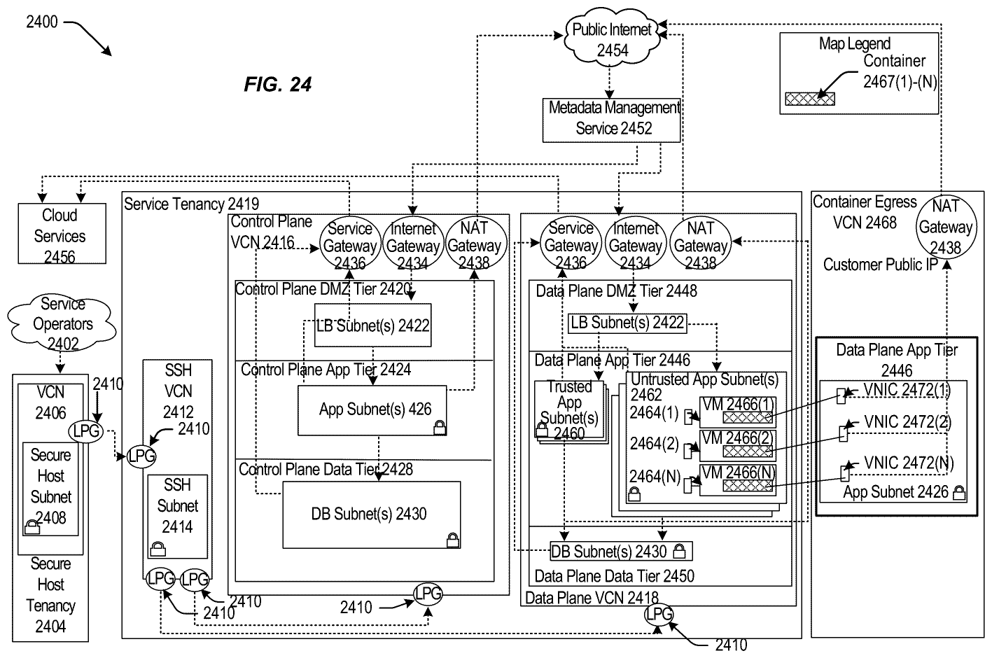

FIG. 24 is a block diagram 2400 illustrating another example pattern of an IaaS architecture, according to at least one embodiment. Service operators 2402 (e.g., service operators 2102 of FIG. 21) can be communicatively coupled to a secure host tenancy 2404 (e.g., the secure host tenancy 2104 of FIG. 21) that can include a virtual cloud network (VCN) 2406 (e.g., the VCN 2106 of FIG. 21) and a secure host subnet 2408 (e.g., the secure host subnet 2108 of FIG. 21). The VCN 2406 can include an LPG 2410 (e.g., the LPG 2110 of FIG. 21) that can be communicatively coupled to an SSH VCN 2412 (e.g., the SSH VCN 2112 of FIG. 21) via an LPG 2410 contained in the SSH VCN 2412. The SSH VCN 2412 can include an SSH subnet 2414 (e.g., the SSH subnet 2114 of FIG. 21), and the SSH VCN 2412 can be communicatively coupled to a control plane VCN 2416 (e.g., the control plane VCN 2116 of FIG. 21) via an LPG 2410 contained in the control plane VCN 2416 and to a data plane VCN 2418 (e.g., the data plane 2118 of FIG. 21) via an LPG 2410 contained in the data plane VCN 2418. The control plane VCN 2416 and the data plane VCN 2418 can be contained in a service tenancy 2419 (e.g., the service tenancy 2119 of FIG. 21).

The control plane VCN 2416 can include a control plane DMZ tier 2420 (e.g., the control plane DMZ tier 2120 of FIG. 21) that can include LB subnet(s) 2422 (e.g., LB subnet(s) 2122 of FIG. 21), a control plane app tier 2424 (e.g., the control plane app tier 2124 of FIG. 21) that can include app subnet(s) 2426 (e.g., app subnet(s) 2126 of FIG. 21), a control plane data tier 2428 (e.g., the control plane data tier 2128 of FIG. 21) that can include DB subnet(s) 2430 (e.g., DB subnet(s) 2330 of FIG. 23). The LB subnet(s) 2422 contained in the control plane DMZ tier 2420 can be communicatively coupled to the app subnet(s) 2426 contained in the control plane app tier 2424 and to an Internet gateway 2434 (e.g., the Internet gateway 2134 of FIG. 21) that can be contained in the control plane VCN 2416, and the app subnet(s) 2426 can be communicatively coupled to the DB subnet(s) 2430 contained in the control plane data tier 2428 and to a service gateway 2436 (e.g., the service gateway of FIG. 21) and a network address translation (NAT) gateway 2438 (e.g., the NAT gateway 2138 of FIG. 21). The control plane VCN 2416 can include the service gateway 2436 and the NAT gateway 2438.

The data plane VCN 2418 can include a data plane app tier 2446 (e.g., the data plane app tier 2146 of FIG. 21), a data plane DMZ tier 2448 (e.g., the data plane DMZ tier 2148 of FIG. 21), and a data plane data tier 2450 (e.g., the data plane data tier 2150 of FIG. 21). The data plane DMZ tier 2448 can include LB subnet(s) 2422 that can be communicatively coupled to trusted app subnet(s) 2460 (e.g., trusted app subnet(s) 2360 of FIG. 23) and untrusted app subnet(s) 2462 (e.g., untrusted app subnet(s) 2362 of FIG. 23) of the data plane app tier 2446 and the Internet gateway 2434 contained in the data plane VCN 2418. The trusted app subnet(s) 2460 can be communicatively coupled to the service gateway 2436 contained in the data plane VCN 2418, the NAT gateway 2438 contained in the data plane VCN 2418, and DB subnet(s) 2430 contained in the data plane data tier 2450. The untrusted app subnet(s) 2462 can be communicatively coupled to the service gateway 2436 contained in the data plane VCN 2418 and DB subnet(s) 2430 contained in the data plane data tier 2450. The data plane data tier 2450 can include DB subnet(s) 2430 that can be communicatively coupled to the service gateway 2436 contained in the data plane VCN 2418.

The untrusted app subnet(s) 2462 can include primary VNICs 2464(1)-(N) that can be communicatively coupled to tenant virtual machines (VMs) 2466(1)-(N) residing within the untrusted app subnet(s) 2462. Each tenant VM 2466(1)-(N) can run code in a respective container 2467(1)-(N), and be communicatively coupled to an app subnet 2426 that can be contained in a data plane app tier 2446 that can be contained in a container egress VCN 2468. Respective secondary VNICs 2472(1)-(N) can facilitate communication between the untrusted app subnet(s) 2462 contained in the data plane VCN 2418 and the app subnet contained in the container egress VCN 2468. The container egress VCN can include a NAT gateway 2438 that can be communicatively coupled to public Internet 2454 (e.g., public Internet 2154 of FIG. 21).

The Internet gateway 2434 contained in the control plane VCN 2416 and contained in the data plane VCN 2418 can be communicatively coupled to a metadata management service 2452 (e.g., the metadata management system 2152 of FIG. 21) that can be communicatively coupled to public Internet 2454. Public Internet 2454 can be communicatively coupled to the NAT gateway 2438 contained in the control plane VCN 2416 and contained in the data plane VCN 2418. The service gateway 2436 contained in the control plane VCN 2416 and contained in the data plane VCN 2418 can be communicatively coupled to cloud services 2456.

In some examples, the pattern illustrated by the architecture of block diagram 2400 of FIG. 24 may be considered an exception to the pattern illustrated by the architecture of block diagram 2300 of FIG. 23 and may be desirable for a customer of the IaaS provider if the IaaS provider cannot directly communicate with the customer (e.g., a disconnected region). The respective containers 2467(1)-(N) that are contained in the VMs 2466(1)-(N) for each customer can be accessed in real-time by the customer. The containers 2467(1)-(N) may be configured to make calls to respective secondary VNICs 2472(1)-(N) contained in app subnet(s) 2426 of the data plane app tier 2446 that can be contained in the container egress VCN 2468. The secondary VNICs 2472(1)-(N) can transmit the calls to the NAT gateway 2438 that may transmit the calls to public Internet 2454. In this example, the containers 2467(1)-(N) that can be accessed in real-time by the customer can be isolated from the control plane VCN 2416 and can be isolated from other entities contained in the data plane VCN 2418. The containers 2467(1)-(N) may also be isolated from resources from other customers.

In other examples, the customer can use the containers 2467(1)-(N) to call cloud services 2456. In this example, the customer may run code in the containers 2467(1)-(N) that requests a service from cloud services 2456. The containers 2467(1)-(N) can transmit this request to the secondary VNICs 2472(1)-(N) that can transmit the request to the NAT gateway that can transmit the request to public Internet 2454. Public Internet 2454 can transmit the request to LB subnet(s) 2422 contained in the control plane VCN 2416 via the Internet gateway 2434. In response to determining the request is valid, the LB subnet(s) can transmit the request to app subnet(s) 2426 that can transmit the request to cloud services 2456 via the service gateway 2436.

It should be appreciated that IaaS architectures 2100, 2200, 2300, 2400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

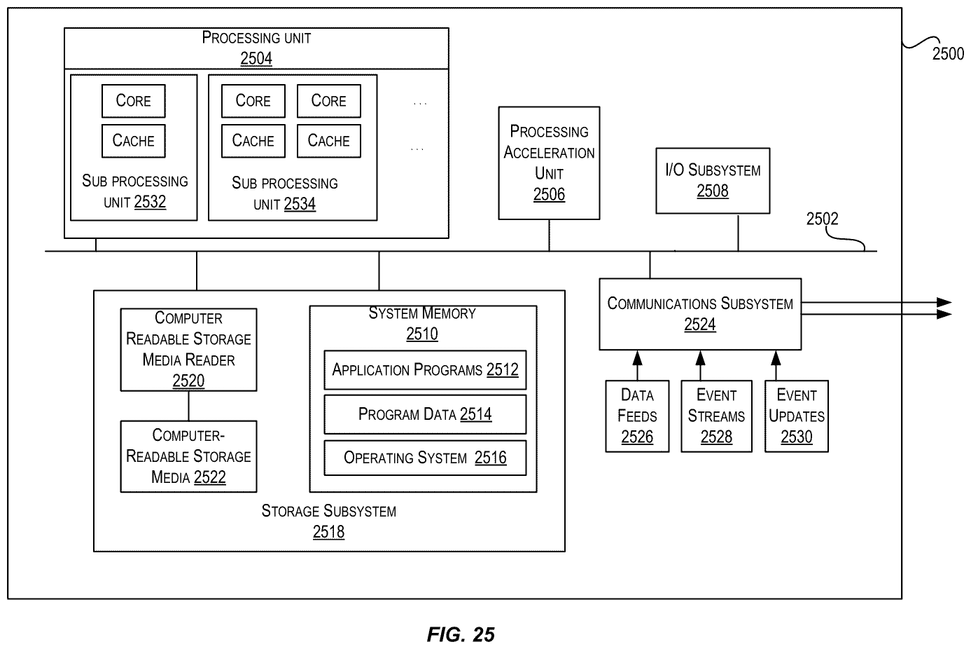

FIG. 25 illustrates an example computer system 2500, in which various embodiments may be implemented. The system 2500 may be used to implement any of the computer systems described above. As shown in the figure, computer system 2500 includes a processing unit 2504 that communicates with a number of peripheral subsystems via a bus subsystem 2502. These peripheral subsystems may include a processing acceleration unit 2506, an I/O subsystem 2508, a storage subsystem 2518 and a communications subsystem 2524. Storage subsystem 2518 includes tangible computer-readable storage media 2522 and a system memory 2510.

Bus subsystem 2502 provides a mechanism for letting the various components and subsystems of computer system 2500 communicate with each other as intended. Although bus subsystem 2502 is shown schematically as a single bus, alternative embodiments of the bus subsystem may utilize multiple buses. Bus subsystem 2502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2504, which can be implemented as one or more integrated circuits (e.g., a conventional microprocessor or microcontroller), controls the operation of computer system 2500. One or more processors may be included in processing unit 2504. These processors may include single core or multicore processors. In certain embodiments, processing unit 2504 may be implemented as one or more independent processing units 2532 and/or 2534 with single or multicore processors included in each processing unit. In other embodiments, processing unit 2504 may also be implemented as a quad-core processing unit formed by integrating two dual-core processors into a single chip.

In various embodiments, processing unit 2504 can execute a variety of programs in response to program code and can maintain multiple concurrently executing programs or processes. At any given time, some or all of the program code to be executed can be resident in processor(s) 2504 and/or in storage subsystem 2518. Through suitable programming, processor(s) 2504 can provide various functionalities described above. Computer system 2500 may additionally include a processing acceleration unit 2506, which can include a digital signal processor (DSP), a special-purpose processor, and/or the like.

I/O subsystem 2508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2500 may comprise a storage subsystem 2518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2504 provide the functionality described above. Storage subsystem 2518 may also provide a repository for storing data used in accordance with the present disclosure.

As depicted in the example in FIG. 25, storage subsystem 2518 can include various components including a system memory 2510, computer-readable storage media 2522, and a computer readable storage media reader 2520. System memory 2510 may store program instructions that are loadable and executable by processing unit 2504. System memory 2510 may also store data that is used during the execution of the instructions and/or data that is generated during the execution of the program instructions. Various different kinds of programs may be loaded into system memory 2510 including but not limited to client applications, Web browsers, mid-tier applications, relational database management systems (RDBMS), virtual machines, containers, etc.

System memory 2510 may also store an operating system 2516. Examples of operating system 2516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2500 executes one or more virtual machines, the virtual machines along with their guest operating systems (GOSs) may be loaded into system memory 2510 and executed by one or more processors or cores of processing unit 2504.

System memory 2510 can come in different configurations depending upon the type of computer system 2500. For example, system memory 2510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2510 may include a basic input/output system (BIOS) containing basic routines that help to transfer information between elements within computer system 2500, such as during start-up.

Computer-readable storage media 2522 may represent remote, local, fixed, and/or removable storage devices plus storage media for temporarily and/or more permanently containing, storing, computer-readable information for use by computer system 2500 including instructions executable by processing unit 2504 of computer system 2500.

Computer-readable storage media 2522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2522 may include, but is not limited to, Zip® drives, flash memory cards, universal serial bus (USB) flash drives, secure digital (SD) cards, DVD disks, digital video tape, and the like. Computer-readable storage media 2522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2500.

Machine-readable instructions executable by one or more processors or cores of processing unit 2504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2524 provides an interface to other computer systems and networks. Communications subsystem 2524 serves as an interface for receiving data from and transmitting data to other systems from computer system 2500. For example, communications subsystem 2524 may enable computer system 2500 to connect to one or more devices via the Internet. In some embodiments communications subsystem 2524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2524 can provide wired network connectivity (e.g., Ethernet) in addition to or instead of a wireless interface.

In some embodiments, communications subsystem 2524 may also receive input communication in the form of structured and/or unstructured data feeds 2526, event streams 2528, event updates 2530, and the like on behalf of one or more users who may use computer system 2500.

By way of example, communications subsystem 2524 may be configured to receive data feeds 2526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2524 may also be configured to receive data in the form of continuous data streams, which may include event streams 2528 of real-time events and/or event updates 2530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2524 may also be configured to output the structured and/or unstructured data feeds 2526, event streams 2528, event updates 2530, and the like to one or more databases that may be in communication with one or more streaming data source computers coupled to computer system 2500.

Computer system 2500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
providing, by a cloud infrastructure orchestration system of a cloud-computing environment, a plurality of regional orchestrators, each regional orchestrator of the plurality of regional orchestrators executing in an isolated hosting environment;
generating, by an orchestrator control plane of the cloud infrastructure orchestration system, a build plan for bootstrapping a plurality of services within a data center, the build plan being generated based at least in part on a service build definition of a plurality of service build definitions, the service build definition specifying a deterministic process for bootstrapping a service of the plurality of services;
instructing, by the orchestrator control plane, a regional orchestrator of the cloud infrastructure orchestration system to initiate bootstrapping the plurality of service according to the build plan; and
tracking, by the orchestrator control plane, a state associated with the bootstrapping of the plurality of services by the regional orchestrator of the cloud infrastructure orchestration system.

2. The computer-implemented method of claim 1, wherein the isolated hosting environment is a service cell of a plurality of service cells.

3. The computer-implemented method of claim 1, wherein the build plan is generated based at least in part on parsing a service build definition, the service build definition comprising a service plan and manifest, the service plan identifying one or more build milestones and an execution unit corresponding to a transition between two build milestones, the manifest specifying one or more artifacts to be utilized while building a service corresponding to the service build definition.

4. The computer-implemented method of claim 3, wherein each execution unit is associated with one or more infrastructure releases or application releases.

5. The computer-implemented method of claim 1, further comprising presenting, by the orchestration control plane, one or more user interfaces presenting the state associated with bootstrapping the plurality of services by the regional orchestrator of the cloud infrastructure orchestration system.

6. The computer-implemented method of claim 1, wherein at least one of the one or more user interfaces presents a directed acyclic graph generated based at least in part on the service plan definition, and wherein each node of the directed acyclic graph corresponds to a build milestone or to an execution unit associated with building the service.

7. The computer-implemented method of claim 1, further comprising
receiving, from one of the one or more user interfaces, data indicating an intervention has been initiated; and
instructing the regional orchestrator to modify execution of the build plan based at least in part on the intervention being initiated.

8. A cloud infrastructure orchestration system, comprising:
one or more processors; and
one or more memories storing computer-executable instructions that, when executed by the one or more processors, cause the one or more processors to:
provide a plurality of regional orchestrators, each regional orchestrator of the plurality of regional orchestrators executing in an isolated hosting environment;
generate, by an orchestrator control plane of the cloud infrastructure orchestration system, a build plan for bootstrapping a plurality of services within a data center, the build plan being generated based at least in part on a service build definition of a plurality of service build definitions, the service build definition specifying a deterministic process for bootstrapping a service of the plurality of services;
instruct, by the orchestrator control plane, a regional orchestrator of the cloud infrastructure orchestration system to initiate bootstrapping the plurality of service according to the build plan; and
track, by the orchestrator control plane, a state associated with the bootstrapping of the plurality of services by the regional orchestrator of the cloud infrastructure orchestration system.

9. The cloud infrastructure orchestration system of claim 8, wherein the isolated hosting environment is a service cell of a plurality of service cells.

10. The cloud infrastructure orchestration system of claim 8, wherein the build plan is generated based at least in part on parsing a service build definition, the service build definition comprising a service plan and manifest, the service plan identifying one or more build milestones and an execution unit corresponding to a transition between two build milestones, the manifest specifying one or more artifacts to be utilized while building a service corresponding to the service build definition.

11. The cloud infrastructure orchestration system of claim 10, wherein each execution unit is associated with one or more infrastructure releases or application releases.

12. The cloud infrastructure orchestration system of claim 8, wherein executing the computer-executable instructions further causes the one or more processors to present, by the orchestration control plane, one or more user interfaces presenting the state associated with bootstrapping the plurality of services by the regional orchestrator of the cloud infrastructure orchestration system.

13. The cloud infrastructure orchestration system of claim 8, wherein at least one of the one or more user interfaces presents a directed acyclic graph generated based at least in part on the service plan definition, and wherein each node of the directed acyclic graph corresponds to a build milestone or to an execution unit associated with building the service.

14. The cloud infrastructure orchestration system of claim 8, wherein executing the computer-executable instructions further causes the one or more processors to:
receive, from one of the one or more user interfaces, data indicating an intervention has been initiated; and
instruct the regional orchestrator to modify execution of the build plan based at least in part on the intervention being initiated.

15. A non-transitory computer-readable medium storing computer-executable instructions that, when executed by one or more processors of a cloud infrastructure orchestration system, cause the one or more processors of the cloud infrastructure orchestration system to at least:
provide a plurality of regional orchestrators, each regional orchestrator of the plurality of regional orchestrators executing in an isolated hosting environment;
generate, by an orchestrator control plane of the cloud infrastructure orchestration system, a build plan for bootstrapping a plurality of services within a data center, the build plan being generated based at least in part on a service build definition of a plurality of service build 9 definitions, the service build definition specifying a deterministic process for bootstrapping a service of the plurality of services;
instruct, by the orchestrator control plane, a regional orchestrator of the cloud infrastructure orchestration system to initiate bootstrapping the plurality of service according to the build plan; and
track, by the orchestrator control plane, a state associated with the bootstrapping of the plurality of services by the regional orchestrator of the cloud infrastructure orchestration system.

16. The non-transitory computer-readable medium of claim 15, wherein the isolated hosting environment is a service cell of a plurality of service cells.

17. The non-transitory computer-readable medium of claim 15, wherein the build plan is generated based at least in part on parsing a service build definition, the service build definition comprising a service plan and manifest, the service plan identifying one or more build milestones and an execution unit corresponding to a transition between two build milestones, the manifest specifying one or more artifacts to be utilized while building a service corresponding to the service build definition.

18. The non-transitory computer-readable medium of claim 17, wherein each execution unit is associated with one or more infrastructure releases or application releases.

19. The non-transitory computer-readable medium of claim 15, wherein executing the computer-executable instructions further causes the one or more processors to present, by the orchestration control plane, one or more user interfaces presenting the state associated with bootstrapping the plurality of services by the regional orchestrator of the cloud infrastructure orchestration system.

20. The non-transitory computer-readable medium of claim 15, wherein at least one of the one or more user interfaces presents a directed acyclic graph generated based at least in part on the service plan definition, and wherein each node of the directed acyclic graph corresponds to a build milestone or to an execution unit associated with building the service.
